(19) United States
(12) Patent Application Publication
(10) Pub. No.: US 2008/0133124 A1
(43) Pub. Date: Jun. 5, 2008

(54) Location Codes for Destination Routing

(76) Inventor: Shahriar Sarkeshik, Northridge, CA (US)

Correspondence Address: THE ECLIPSE GROUP, 10605 BALBOA BLVD., SUITE 300, GRANADA HILLS, CA, 91344, US

(21) Appl. No.: 11/572,207

(22) PCT Filed: Jul. 16, 2005
(86) PCT No.: PCT/US05/25241

§ 371 Date: Nov. 13, 2007

Related U.S. Application Data
(60) Provisional application No. 60/588,585, filed on Jul. 17, 2004.
(60) Provisional application No. 60/622,511, filed on Oct. 26, 2004.
(60) Provisional application No. 60/699,789, filed on Jul. 15, 2005.
(60) Provisional application No. 60/699,044, filed on Jul. 13, 2005.

(51) Int. Cl. G01C 21/34; G01S 5/00

(52) U.S. Cl. 701/201; 701/213

(57) ABSTRACT

The invention provides for a method to identify particular geographic locations by means other than the postal address for use in navigation system and navigation, routing and mapping programs. The method may be the assignment of a series of numbers, symbols or characters, or a combination thereof, to a particular entity, location or address within a defined parameter. The invention further provides for a system for generating routing information that has the ability to receive a location code and provide routing information associated with the location code. Such a system may be employed in hardware, software or in a combination of both hardware and software.

### CROSS-REFERENCE TO RELATED APPLICATIONS

This application claims priority to U.S. Provisional application Ser. No. ______, filed Jul. 15, 2005, titled Navigation System Interface System; U.S. Provisional application Ser. No. ______, filed on Jul. 13, 2005, titled Location Codes for Destination Routing; U.S. Provisional Application Ser. No. 60/622,511 filed on Oct. 26, 2004, titled Location Codes for Destination Routing; U.S. Provisional Application Ser. No. 60/588,585, filed on Jul. 17, 2004, titled Method and System For Using Location Codes For Destination Routing. All of the above cited references are incorporated, by reference, in their entirety into this application.

### BACKGROUND

Electronic mapping and routing systems have gained substantial growth during the past decade. In-car satellite navigation systems are becoming more affordable and have become standard equipment in many automobiles. Additionally, Internet mapping services, such as Mapquest®, assist millions of users to get driving directions. More recently cell phones having the capability of obtaining location information through satellite positioning systems are promising to give customers turn by turn driving instructions at very affordable prices.

In-car navigation systems, cell telephones, personal digital assistants and other devices typically determine location through communication, either directly or indirectly, with a satellite navigation system comprised of a network of satellites orbiting above the earth; however, other techniques such as terrestrial triangulation, RF, infrared or similar methods of transmitting information may be used to communicate location information to a mapping or routing device or system. For purposes of this application, any device that utilizes or can interface with a mechanism for receiving transmitted information to identify or calculate its current location shall be considered as having a Global Positioning System (“GPS”). Further, any piece of hardware, software, or combination thereof that can, as at least one of its functions, provide mapping, routing, and/or location information, whether or not it includes GPS or has the ability via a wireless or wired network to access a device having GPS, shall be considered a “navigation system.”

FIG. 1 depicts a block diagram that illustrates the general components of a navigation system. As illustrated by block 102, the system is controlled by a main/routing program. The system further includes an input interface 104 that allows the user to input via external input device(s) 106. Optionally, some navigation systems may be equipped with a speech recognition interface 108 that allows the user to interact with the system via voice. The system may include a GPS 110 to provide the current coordinates to the main/routing program 102 for use as the starting position. Usually, the GPS 110 is a standard component in navigation systems for automobiles and may also be present in cell phones or other handheld devices, but is typically not found in mapping software programs that determine driving direction based on the user input of originating and destination locations, such as MapQuest®, which is accessible via the Internet. Thus, when a GPS 110 is present, for example in an automotive navigation system, inputting the starting address is not required. For mapping software programs, where no GPS 110 is included in the system, the user may input the starting address, which may be stored in memory for subsequent use, to provide the desired routing information.

Most commonly, starting addresses and designation addresses, when provided by the user, are provided through a memory look-up, or through physical input of the starting addresses and destination addresses. The starting addresses and destination addresses are input into the navigation system in the form of a street address, typically representative of a number followed by the street name. The city and state where the street address is to be located is also typically required to be entered by the user to restrict the field of search and to distinguish between similar street addresses located in different cities and/or states.

The main routing program then uses the input information, including the starting address, obtained through the GPS or through user input, and the destination address to obtain routing information from the starting address to the designation address. Using the obtained address information, the main/routing program 102 interfaces with the map/database interface 112 with a database 114 to obtain the desired routing information. This database 114 may be maintained local to the navigation system or may be obtained through an interface/network 116, such as a wireless network.

Once the routing information is obtain, the main/routing program 102 can output the routing information through a graphics interface 118 on a display 120, such as an on-screen display of a map and/or turn-by-turn text instructions. The output could also be in the form of turn-by-turn vocal instructions provided through a speech synthesizer interface 122. Map and other navigation instructions may also be provided to the user on paper via the printer interface 124. Thus, routing information can be conveyed in a number of ways and should be taken to mean any information capable of assisting a user locate one or more particular geographic location, including mapping information, text directions, voice directions, turn-by-turn routing instructions, coordinate information, location information or otherwise.

Typically, the on-screen map display shows a map that may include either or both the starting location and destination location and how to get from the starting location to the destination location. The vocal instruction may provide advance instructions on when and where to turn, and typically accompany map and/or text instructions. The turn-by-turn instructions typically provide a detailed textual and or graphical listing of how to get from the starting address to the destination address. The navigation system may further include user controls to allow the user to control the system and the output of the routing instructions.

One of the main difficulties with operation of a navigation system is inputting source and destination addresses, especially given the limited user interface capabilities of devices such as in-car satellite navigation systems and cell phones. As discussed above, to input street address information both the address number and street name are required. Thus, with automotive and cell phone navigation system, typically two different input screens or fields are required—one screen or field for the address number and a second screen or field for the street address. If the user input of the street address is not complete, for example, if input of the address does not include a road, lane, circle, avenue, directional or other designation, a look-up table is often then provided to the user from which to select the street name if variations of the input address exist within the system. Once the street address is complete, the system may also provide a second look-up table for the use to select in which city the address is located if the address can be found in more than one city within the geographic boundaries utilized by the system, such as a state. Because this task can be rather complex, some of the new in-car navigation systems do not allow users to input an address when the car is in motion. This is due to safety and other issues concerning complexity of the task. A need therefore exists to simplify the task of inputting addresses.

Another difficulty with the current navigations systems is that they do not easily provide for navigation to locations that do not have a traditional street address, like ATM's and postal deposit boxes independent of conducting a point of interest search through a look-up table or by asking the system to identify a specific category of interest points. Currently, conducting point of interest searches can be cumbersome and involve making selections from a series of look-up tables. Further, most systems do not provide for a means to further narrow the display of general points of interest to identify or exclude a class within the general category of displayed points of interests. Yet another difficulty with current systems is that they do not typically provide a distinction between unit numbers, suite numbers, floors, or other sub designations associated with particular street addresses.

In summary, a need exists to provide for a method of inputting designation that simplifies the task of inputting address information that can provide routing information to locations that do not have traditional street address and that can further provide navigation to sub-designations of a single street address.

### SUMMARY

The invention provides for an alternative method to identify particular geographic locations by means other than a street address for use in navigation systems. In one example of one implementation, the alternative identification method may be the assignment of a series of numbers, letters, symbols or characters, or a combination thereof, to a particular entity, location or address within a defined parameter. This alternative series of numbers, letters, symbols or characters, or combination thereof, may be referred to as a “location code.” The invention further provides for a system for generating routing information that has the ability to receive a location code and provide routing information associated with the location code. Such a system may be employed in hardware, software or in a combination of both hardware and software.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 shows a block diagram of the components and operation of one example prior art navigation system.

FIG. 2 shows a block diagram of the components and operation of an example of one implementation of a location code capable navigation system in accordance with the invention.

FIG. 2a depicts a block diagram that illustrates the general components of one example of one implementation of how a conventional navigation system may be enhanced to utilize location codes by adding a location code program.

FIG. 2b depicts a block diagram that illustrates the general components of one example of one implementation of how a conventional navigation system may be enhanced to utilize location codes by interfacing to a location code system/program.

FIG. 3 illustrates how the NANPA has currently divided California into distinct geographic regions and the particular area codes that have been assigned to each region.

FIG. 4a illustrates an example of one implementation of an input screen that demonstrates the use of a security code to obtain location information associated with a particular location code.

FIG. 4b illustrates an example of one implementation of an input screen that may be provided to prevent a user to modify or add data associated with a location code unless a Personal Identification Code (PIC) is entered.

FIG. 4c illustrates an example of one implementation of an input screen that may allow a user to change the address or security code associated with a particular location code or may allow a user to modify addresses and/or add address associated with a particular location code.

FIG. 4d illustrates an example of one implementation of an input screen that may allow a user to input and modify metadata associated with a particular location code or group location code.

FIG. 5 illustrates an example of one implementation how metadata associated with a location code that relates to residential property being offered for sale may be displayed to a user in connection with the operation of a navigation system.

FIG. 6a illustrates an example of one implementation how metadata associated with a location code that relates to commercial property may be displayed to a user in connection with the operation of a navigation system.

FIG. 6b illustrates another example of one implementation of how metadata, illustrated in the form of a website for commercial property, such as a department store website, may be associated with a location code.

FIG. 7 illustrates one example of one implementation of a navigation system that is capable of utilizing location codes to generate routing information and capable of operating as a stand-alone system or acting as a client and interfacing with a server over a network.

FIG. 8 illustrates one example of one implementation of a server capable of interfacing with a client over a network to provide a navigation system capable of utilizing location codes to generate routing information.

FIG. 9 shows a flow diagram that illustrates one example of one implementation of how a navigation system may identify a location code with particular geographic location using a cross-reference database.

FIG. 10 illustrates an example of one implementation of an input screen that may be used in connection with a navigation system to allow a user to either enter a desired street address and obtain its location code or enter a location code and obtain its street address.

FIG. 11 shows a flow diagram that illustrates one example of one implementation of how location codes may be translated into street addresses or coordinates using a cross-reference database via client/server navigation system.

FIG. 12 shows a flow diagram that illustrates one example of one implementation of how a navigation system may identify a location code with particular geographic location using an algorithm.

FIG. 13 shows a flow diagram that illustrates one example of one implementation of how location codes may be translated into street addresses or coordinates using algorithms via client/server navigation system.

FIG. 14 shows a flow diagram that illustrates one example of one implementation of how GPS coordinates may be translated into location codes as well as their corresponding geographic identifier using algorithms.

FIG. 15 illustrates one example of one implementation of the application of one sample algorithm that can be applied by the system to identify a location code corresponding to the GPS coordinates.

FIG. 16 shows a flow diagram that illustrates one example of one implementation of the application of a reverse location lookup program to translate a GPS coordinate into a location code or street address using a client/server application.

FIG. 17 shows a flow diagram that illustrates one example of one implementation for finding nearest location for a group of locations associated with a single location code.

FIG. 18 shows an example of one implementation of an output screen that may be presented in response to the entry of a group location code.

FIG. 18a shows an example of one implementation of an output screen that allows the users to change the criteria upon which the gas stations in the group are displayed and/or highlighted for the user.

FIG. 18b shows an example of one implementation of an output screen that highlights a particular gas station in a group of identified gas stations that match selected criteria.

FIG. 18c shows another example of an implementation of an output screen that may be presented in response to the entry of a group location code.

FIG. 19 shows a flow diagram that illustrates one example of one implementation for finding nearest location for a group of locations associated with a single location code using a client/server application.

FIG. 20 shows a flow diagram that illustrates one example of one implementation for identifying location codes having suite designations with geographic location using cross-reference database.

FIG. 21 shows a flow diagram that illustrates one example of one implementation for identifying location codes having suite designations with geographic location using cross-reference database.

FIG. 22 shows a flow diagram that illustrates one example of one implementation for calculating routing information based upon entry of location codes or addresses for originating and destination locations.

FIG. 23 illustrates an example of one implementation of an input screen providing for the input of either address or location code for both origination and destination locations.

FIG. 24 illustrates an example of one implementation of an output screen that may be provided in accordance with this example that displays both a map and turn-by-turn instructions calculated based upon the information provided by the user regarding origination and destination locations.

FIG. 25 shows a flow diagram that illustrates one example of one implementation for calculating routing information based upon entry of either address or location code for originating and destination locations using a client/server application.

FIG. 26 shows a flow diagram that illustrates one example of one implementation for calculating routing information based upon entry of location codes for destination locations.

FIG. 27a shows a flow diagram that illustrates one example of one implementation of how a client may calculate routing information based upon entry of location codes for destination locations using a client/server application.

FIG. 27b shows a flow diagram that illustrates one example of one implementation of how a server may calculate routing information based upon entry of location codes for destination locations in a client/server application.

FIG. 28 illustrates an example of one implementation of a screen that may be used to select the method for inputting destination location.

FIG. 29 illustrate an example of one implementation of a screen for inputting location code information.

FIG. 30 illustrates an example of one implementation of a screen displaying the address that the system determined to correspond with the location code.

FIG. 31 illustrates an example of one implementation of a screen displaying routing information derived from the initial input of a location code for the destination.

FIG. 32 illustrates an example of one implementation of a user input on a cellular telephone.

FIG. 33a illustrates an example of one implementation input screen that may be displayed on a cell phone for use with navigation applications.

FIG. 33b illustrates an example of one implementation of the screen displaying presenting the address corresponding to the location code input by the user for verification.

FIG. 33c illustrates an example of one implementation of a cell phone display showing routing information requested by the user, which may display routing information in the form of either a map or turn-by-turn instruction.

FIG. 34a illustrates an example of one implementation of a screen display from the entry of a group location code.

FIG. 34b illustrates an example of one implementation of a screen display showing the locations related to the group location code of FIG. 34a that are nearest the user.

FIG. 34c illustrates an example of one implementation of a screen display showing a web site that the phone display for a desired location associated with a group location code.

FIG. 34d illustrates an example of one implementation of a screen display showing routing information for a selected location.

FIG. 35a illustrates an example of one implementation of a screen display that may allow a user to determine there current position.

FIG. 35b illustrates an example of one implementation of a screen display showing a list of potential locations.

FIG. 35c illustrates an example of one implementation of a screen display that will allow the user to edit the returned information.

FIG. 35d illustrates an example of one implementation of a screen display that may allow a user to input the unit number of a multi-unit structure.

FIG. 35e illustrates an example of one implementation of a screen display returning the desired location information to a user.

FIG. 36a illustrates an example of one implementation of an input screen in a navigation system that may allow a user to choose a particular method of transportation to be used in calculating routing information and that illustrates the selection of public transportation as the method of transportation.

FIG. 36b illustrates an example of one implementation of a screen display that may be provided to the user to provide user with routing information using a selected means of transportation.

FIG. 36c illustrates an example of one implementation of a screen that may be displayed to provide the user with more detailed instruction regarding a particular displayed direction in a given set of routing instructions.

FIG. 37a shows one example of one illustration of a screen display from the entry of a location code associated with an event in, for a example, a cell phone navigation system.

FIG. 37b shows one example of one illustration of particulars of an event associated with the entered location code.

FIG. 37c shows one example of one illustration of options that a navigation system may provide to a user for processing of the associated event data.

FIG. 37d shows one example of one illustration of the acquisition of weather data related to event data associated with a location code.

FIG. 37e shows one example of one illustration of routing information generated from a location code associated with an event.

FIG. 38 illustrates a flow diagram that illustrates one example of one implementation of what may happen in a navigation system when a location code is entered that does not match any known geographic identifier or when an address is entered for which no location code corresponds.

FIG. 39 shows a flow diagram that illustrates one example of an implementation of how group location codes may be created in a navigation system using security codes and private identification code.

FIG. 40 is a block diagram of one example of an implementation of the navigation system capable of receiving a location code and providing routing information using the location code.

FIG. 41 is a flow diagram of one example of one implementation of a method for generating routing information based upon the receipt of a location code.

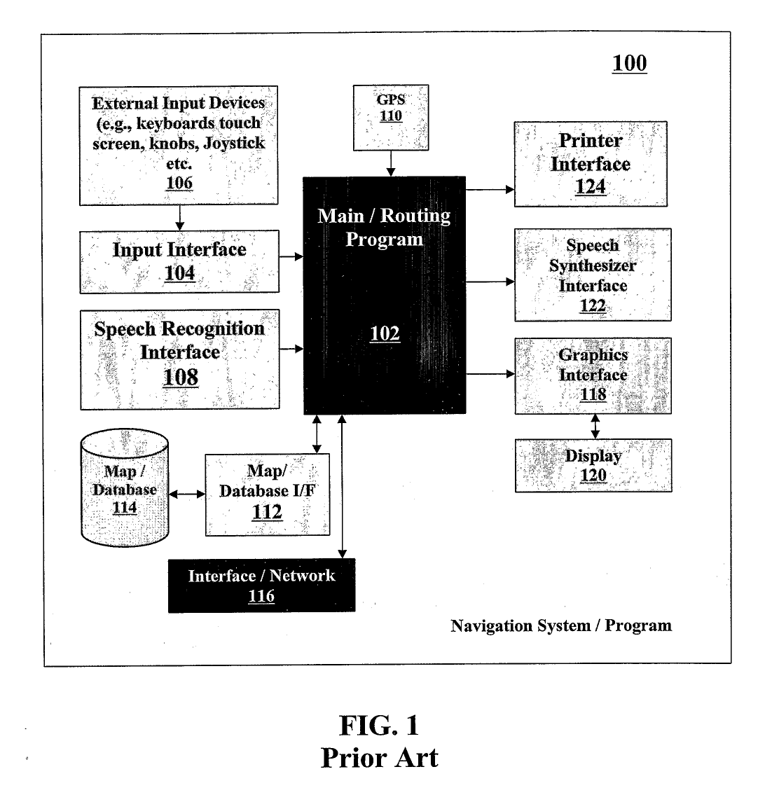

### DETAILED DESCRIPTION

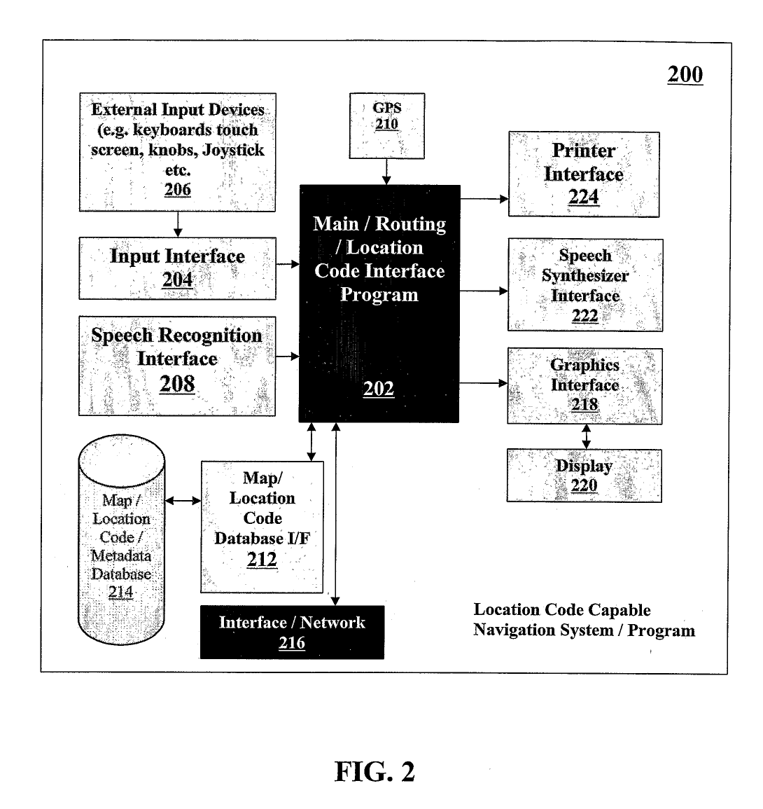

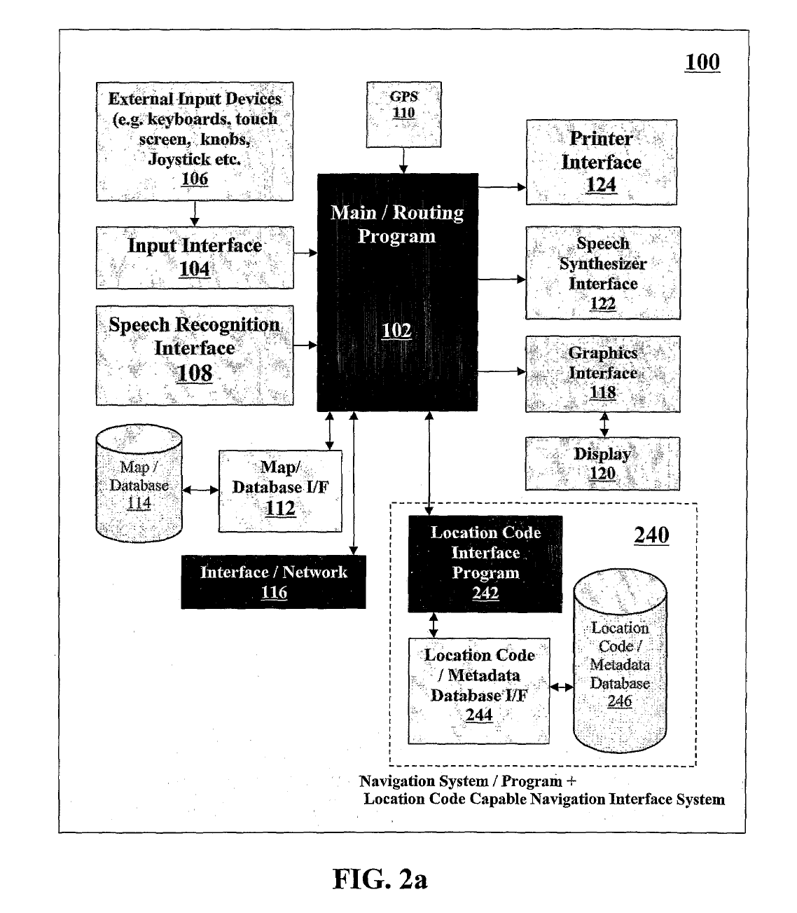

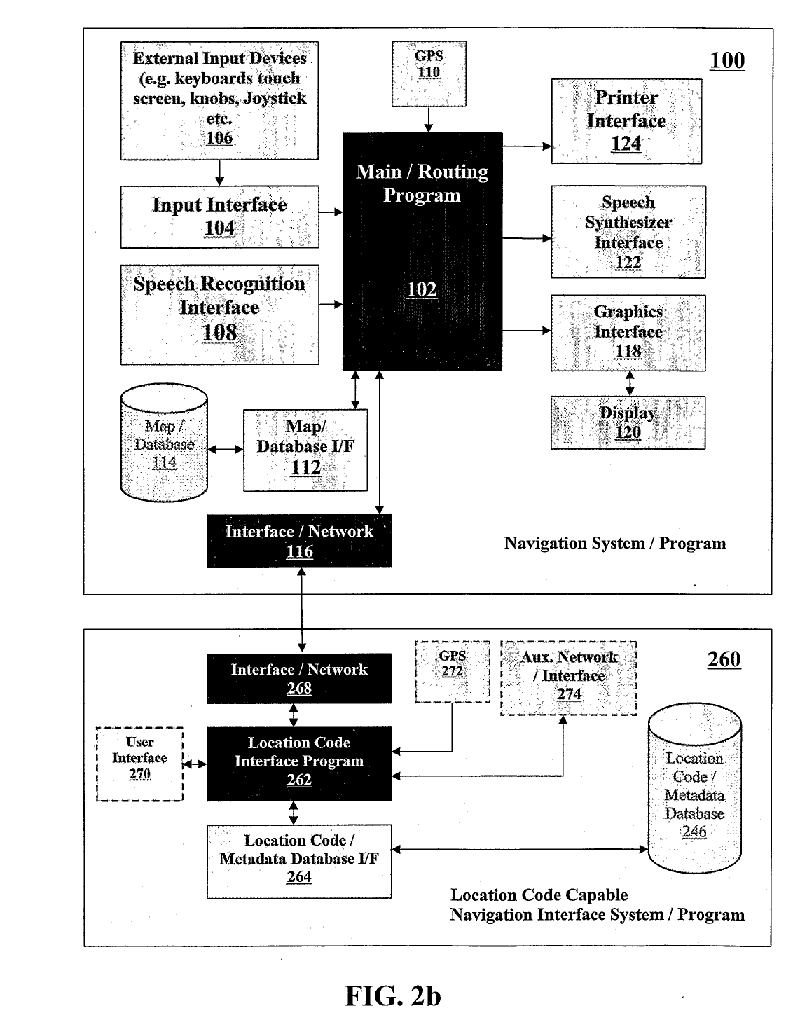

FIG. 2 depicts a block diagram 200 that illustrates the general components of one example of one implementation of a location code capable navigation system. As illustrated by block 202, the system is controlled by a main/routing/location code interface program. The system further includes an input interface 204 that, for example, may allow a user to input a starting geographic location, if required, and/or destination geographic location. The system may include or utilize a GPS or equivalent 210 to provide the current coordinates of a device to the main routing program 202 for use as the starting position. As previously discussed, any device that includes a mechanism for receiving transmitted information to determine its current location shall be referred to having a Global Positioning System (“GPS”) 210. A navigation system shall mean any piece of hardware, software, or combination thereof that provides mapping, routing, and/or location information, regardless of whether it includes GPS, operates in a standalone or networked mode, is comprised of a stand-alone system or is comprised of multi-systems or components capable of interfacing with one another.

A GPS 210 is a standard component in navigation systems for automobiles and may also be present in cell phones and other devices, but is typically not used in mapping software programs, such as MapQuest®, that require the input of both the starting geographic location and destination geographic location to generate routing information. For mapping software programs, where no GPS 210 is included in the system, the user may input the starting address, which may be stored in memory for subsequent use, to provide the desired routing information. When a GPS 210 is present, for example in an automotive navigation system, the staring address is generally not required, but may optionally be provided. Optionally, the system may include a speech recognition system/interface 208 to enable the user to provide input information to the navigation system via voice. Additionally, other external input devices 206, including, but not limited to, keyboards, touch screens, knobs, joysticks, buttons and etc., may be used to input information into the system 200.

In one implementation of the invention, a unique series of numbers, letters, symbols or characters, or a combination thereof, is assigned to each entity, location or address within a defined parameter that is formulated such that the use of the series in connection with a navigation system has advantages over the use of street addresses to obtain routing information. For purposes of this application, this alternative series of numbers, letters, symbols or characters, or combination thereof, may be referred to as a “location code.” As used in this application, the term “character(s)” shall be taken to mean a character(s), number(s), letter(s) or symbol(s). For example, when a location code is referenced as a series of characters, it should be taken to mean a series of number(s), letter(s), symbol(s), character(s), and/or any combination thereof. Rather than inputting a street address for a given location into a navigation system or program, a location code may be used for the starting address, destination address, intermediate location or any other address entry required by the system.

By assigning location codes, the need to search through databases of street listings to insure that a user is selecting the proper street name may be eliminated. In one example of one implementation, a location code may be designed such that it is always a number (or number+symbols such as *, #) with fixed number of digits. This will simplify the data entry via a numeric pad. Although not necessary, it is possible to assign a location code that is related to a given street address or another geographic identifier. Further, the length of the location code may be limited by parameters placed on the program accepting the code, such that the same code may be used for a location confined within different parameters. Thus, location codes could include country, state, county, city or other geographical zone identifiers in which the location code is to be applied. Other such parameters may be used to limit the length of the code and to allow for duplicate use of codes in different geographic locations. Further, different location codes may be given to different entities having the same address, parcel number, lot number, extended zip codes, coordinates etc, such that more than one location code may be assigned to a given street address to identify different entities located at the same address.

By using location codes, in one example of one implementation the entry by a user may be simplified through the assignment of a location code that minimizes the number of different characters in the address and thus eliminates the need to switch between a numeric and alphabetic keypad, for example by using an identifier comprised almost entirely of numeric values. Or, in the case where both numeric and alphabetic keypads are readily available, a location code may be used, rather than a street address, to assist with avoiding errors resulting from incorrect spelling, similar street names, unrecognized streets, incomplete street names, foreign names and characters or missing street identifiers.

In implementation of the location code, each location code may be randomly assigned to a location, may include geographic identifiers associated with the specific geographic location for which the location code relates or correlated identifiers, which may include characters that can be associated with, or that are encoded to correspond to, predetermined geographic identifiers, such a phone number, or each location code may be comprised of a combination of any of the foregoing. For example, the location code could be generated entirely or at least partially from (i) a series of numbers that are randomly assigned to the location, (ii) a series of numbers that include all or portions of a geographic identifier, including, but not limited to a zip code, street address, or similarly previously assigned property identifiers; or (iii) correlated identifiers comprised of a series of characters that correspond indirectly to, or that can be easily associated with, previously assigned geographic identifiers, such as street address, or street name, property parcel number, coordinates or other like identifiers.

Due to the known problems with current generation of routing information based generally upon the input of street addresses as destination locations, when generating a location code, it may be desirable to avoid generating location codes that would not elevate at least some of the problems created through the use of street addresses. For example, it may be desirable to construct locations codes from series of characters that provide one or more of the following attributes: (i) easy to input into a navigation system; (ii) easy to assign location codes to represent geographic locations; (iii) easy to remember; (iv) easy to convey, (v) provides information about the location to which it has been assigned to represent; (vi) allows for the maintenance of privacy; (vii) can be associated with a stable database for purpose of obtaining information related to the location code; (viii) universal and robust. For purposes of this application, the term assignment may mean assignment, generation or association.

The starting geographic location and/or destination geographic location may be provided to the navigation system by the user, through a memory look-up, or through physical input of the starting addresses and destination geographic location in the form of the location code. Depending upon the structure of the location code, it may not be necessary to restrict the field of search to a specified county, state, county, city or zone to distinguish between similar street addresses located in different cities within a state. The location code may be constructed to include zoning information, such as country, state, county or city information. In alternative implementations, the location code may not include zoning information and/or citing information and therefore the navigation system may still require the further specification of the zone or area in which the geographic location of the location code is associated.

The main/routing/location code interface program 202 then uses the input information, including the starting geographic location, obtained through GPS 210 or through user input of the starting location code, and the designation, through user input of the destination geographic location code to obtain routing information from the starting geographic location to the designation geographic location. While the interface program 202 may be designed to exclusively use input information in the form of a location code to generate routing information, the system may also be designed to use other data, in addition to location codes, such as geographical identifiers such as street addresses or coordinates to generate routing information. As used in connection with a navigation system or software mapping program, a map/location code/metadata database I/F 212 is able to access the location code/metadata database 214 and provide the appropriate data to the main/routing/location code interface program 202. For example, the data could be the street address associated with the location code or associated metadata that can be formatted appropriately and communicated to the user by the main/routing/location code interface program 202. For example, the location code may be converted to the street address or coordinate locations used by the main/routing/location code interface program 202 to perform its program functions by cross-referencing a database 214 resident locally or that is network accessible by the program or application through either a interface/network 216, such as a wired or a wireless network or any other type of interface.

Once the routing information is obtained, the main/routing program/location code interface 202 can output the routing information through a graphics interface 218 that may, for example, use a display 220 to provide an on-screen display of a map and/or turn-by-turn text instructions etc. The on-screen map display may shows a map that may include either or both the starting location and destination location and how to get from the starting location to the destination location. Additionally, a speech synthesizer interface 222 may provide vocal instruction that alter the user in advance as to where to turn. Such vocal turn-by-turn instructions may be provided alone, or in conjunction with detailed textual and or graphical displays or listings of how to get from the starting address to the destination address. The navigation system may further include user controls to allow the user to control the system and the output of the routing instructions. Further, some systems 200 may include a printer interface 224 for sending routing information to a printer.

FIG. 2a illustrates one example of one implementation of how a conventional navigation system 100 may be enhanced to work with location codes by integrating a location code capable navigation interface system 240. In this example, the location code interface program 242 of the location code capable navigation interface system 240 may run partially or completely on the same platform as the navigation system 100. The location code interface program 242 may interface with main/routing program 102. Through this interface, command and data may be exchanged between the two programs 242 and 102 and also may provide access to many of the on-board modules such as the GPS 110, interface/network 116, input interface 104, graphics interface 118, speech recognition interface 108, speech synthesizer interface 122, printer interface 124 and other available modules. Main/routing program 102 and location code interface program 242 may have any type of relationship including but not limited to master/slave, slave/master or peer-to-peer. The location code interface program 242 through location code/metadata database I/F 244 is able to access the location code/metadata database 246 and provide the appropriate data to the user and/or the main/routing program 102. For example, the data could be the street address associated with the location code that after presentation to the user can be formatted appropriately and communicated to the main/routing program 102. Many commercially available navigation programs have software development kits (SDK) that enable third party developers to interface with their programs. Such SDKs can be used for development of the navigation interface program 242; however, availability and use of SDKs are not a requirement. The location code interface program 242 may also provide additional functionality beyond the capabilities of the main/routing program 102. These functionalities may include any known or future developed navigation system function, which may include, but not be limited to, enhanced user interaction, interfacing with other programs used by the navigation system or the device upon which the navigation system operates, including, but not limited to, contact management or scheduling programs.

Through the interface between the navigation system 100 and the navigation interface system 240, the navigation system 100 may also provide access to the external input devices 106, the display 120 and the map/database I/F 112 and the map database 114. Accordingly, the location code capable interface system 240 may request input through the display 120, receive input through the external input devices 106 and process the received data using the map/database I/F 112 and the map database 144 of the navigation system 100.

While FIG. 2a illustrates the components of the navigation system 100 and the location code capable navigation interface system 240 separately, both systems can share like components rather than each utilize separate components. For example, both systems 240 and 100 can reside together in the same memory or in separate memory and can use a single processor or a multiple processors. Accordingly, the location code capable navigation interface system 240 may take the form of a software module, a hardware component or a combination thereof that may perform the functions or processes described herein. With respect to software, the location code capable navigation interface system 240 may be all or part of a program that may be composed of one or more systems or programs that are independently developed and linked together when the program is executed and may be contained, entirely or in part, in the navigation system 100. Thus, the location code capable navigation interface system 240 may take the form of an upgrade to the main/routing program 102 of the navigation system 100 or be included as part of a new version of the main/routing program 102 of the navigation system 100. With respect to hardware, the location code capable navigation interface system 240 may be any self-contained hardware component or a hardware component that comprises two or more hardware or software components. A navigation system and a navigation interface system may run on the same hardware platform.

FIG. 2b illustrates one example of one implementation of how a conventional navigation system 100 may be enhanced to work with location codes by interfacing it to a location code capable navigation interface system 260. In this example, the location code interface interface program 262 of the location code capable navigation interface system 260 may run partially or completely on a separate platform than the one used for the navigation system 100 and interface to it via interface/network 268, such as a wired or wireless interface/network connection. The location code program 262 through location code/metadata database I/F 264 is capable of accessing the location code/metadata database 246. The location code program 262 through interface/network 268 connection in addition to exchanging data and commands may be able to access different modules of the navigation system/program 100 including GPS 110, interface/network 116, input interface 104, graphics interface 118, speech recognition interface 108, speech synthesizer interface 122, printer interface 124 and other available modules. Alternatively, or in conjunction with the above capability, the location code capable navigation interface system 260 may include a separate user interface 270, GPS 272 and auxiliary networking/interface 274. Auxiliary network/interface 274 may be any type of network or interface. The navigation system 100 and location code capable navigation interface system 260 may have any type of relationship including but not limited to master/slave, slave/master or peer-to-peer. The location code interface program 262 through location code/metadata database I/F 264 may access the location code/metadata database 246 and provide the appropriate data to the user and/or the main/routing program 102. For example, the data could be the street address associated with the location code that after presentation to the user can be formatted appropriately and communicated to the main/routing program 102 through interface/network 116. The location code program 262 may also provide functionalities beyond the capabilities of the main/routing program 102.

Similar to the location code capable navigation interface system 240 illustrated in FIG. 2a, through the interface/network 268 and 116 between the location code capable navigation interface system 260 and the navigation system 100, respectively, the navigation system 100 may also provide the location code capable navigation interface system 260 with access to the external input devices 106, the display 120 and the map/database I/F 112 and the map database 114. Accordingly, the location code capable navigation interface system 260 may request input through the display 120, receive input through the external input devices 106 and process the received data using the map/database I/F 112 and the map database 144 of the navigation system 100. In this manner, the interface system and the navigation system may operate together in a seamless manner to the user.

Although the location code capable navigation interface system 260 may have a dedicated processor, the location code capable navigation interface system 260 may be configured to utilize all or part of the processing capabilities of the navigation system 100. Although the location code capable navigation interface system 260 is designed primarily for the purpose of providing additional functionality to the navigation systems 100, nothing prevents the configuration of the navigation system 100 from being modified to utilize components of the location code capable navigation interface system 260. Although not shown, in this example, a part of the location code interface program 262 may run on the navigation system 100 platform.

Although FIGS. 2a and 2b illustrate two examples of a navigation system that is location code enable through interfacing with a location code capable navigation interface system. Those skilled in the art will recognize that the navigation system 100 and the location code capable navigation interface system may include all of the illustrated components, or may be designed to exclude certain of the illustrated components, include additional components, may combines two or more illustrated components into one component and/or may replace a component with a different type of component.

### I. Generation of Location Codes

As mentioned previously, each location code is comprised of a series of characters that may be randomly assigned to a location, may include geographic identifiers associated with the specific geographic location for which the location code relates or correlated identifiers, which may include characters that can be associated with, or that are encoded to correspond to, predetermined geographic identifiers, such a phone number, or each location code may be comprised of a combination of any of the foregoing. The series of characters may include a series of numbers, letters, symbols, or a combination of any of the foregoing, including, but not limited to, an alphanumeric, numeric and/or symbolic character set, assigned from any of the methods described below.

A. Random Generation

In one example of one implementation, location codes may be comprised entirely or at least partially of a series of characters that are randomly assigned to specific geographic locations, such random assignment may include deriving the series of characters from a method independent of any currently used method for identifying a particular location. For purposes of this application, a random assignment or generation of a series of characters shall mean that the series has no apparent or obvious relationship to any geographic identifier for a specified location, such as conventional street address, zip code, telephone number, or the like. Rather, the series of characters assigned to be used as the location code for a particular geographic location is comprised of characters that cannot, through currently used methodologies, be directly associated to a geographic location identifier. However, once generated, location codes can be cross-referenced with their corresponding geographic identifier using, for example, a look-up database capable of cross-referencing the location code to its corresponding geographic location. The database may be capable of translating a location code to known identifiers, if required, to alternatively identify the desired geographic location for routing purposes. In other words, one will not be able to easily identify any geographic identifiers within the series or be able to easily relate the characters with existing geographic identifiers without using a cross-reference database or without understanding the methodology behind the derivation of the location code. Alternatively, a location code can be translated in the geographic location(s) to which it is intended to represent by using an algorithm or other methodology. One example of one implementation is to employ a methodology that sorts the addresses in a given geographical zone in a certain manner, including, but not limited to, sorting the addresses alphabetically based upon city, street and block, and assign location codes to the sorted addresses based upon an algorithm.

However, after extended use of a particular methodology for generating location code, the public may come to understand and recognize the new methodology used to generate location codes. At such a time, it may be possible for the public to correlate all or part of the location code with a specific geographic area or a particular location. For example, if a new independent method is developed for deriving location codes that uses the numeral 25 in part of the location code to designate locations in California, after some period in time and through continued use, it may come to be recognized that location codes having the numeral 25 in a particular part of the code represent a location in California.

Accordingly, such random assignment of a series of character may be a totally random, perhaps a computer generated assignment of numbers, or may be derived from a system independent of those systems currently used to identify particular geographic locations. A known method for assigning the series of characters using different geographic designations may be utilized to generate location codes or an entirely new system may be developed for assigning numbers to locations based upon new identifiable parameters or other methods. For example, location codes may be derived by assigning character identifiers to particular zones or areas, for example, the world, a country, a state, a city, or etc. In this regarding, each zone may be given a different character or series of characters that for example may be used as the prefixes for, or as a part of, location codes in that zone.

In summary, in this implementation, it is suggest that a location code may be derived entirely or at least partially from a series of characters (e.g. numbers, letters and/or symbols) that do not have any apparent or obvious association with a particular geographic location absent an understanding of the origin of the series of characters.

B. Geographic Identifiers

In one example of one implementation, location codes may also be comprised entirely or at least partially of all or part of geographic identifiers, which shall mean any identifier assigned to represent or be associated with all or part of a particular geographic region, location, or entity, including any identifiable division of such region, location or entity, including, but not limited to, any division of a distinct piece of real property or structure divisible by ownership, occupancy, class or association. Currently, many different types of geographic identifiers exist for many different purposes. For example, many countries, states, counties, cities and districts use unique identifiers to represent different geographic regions as well as distinct piece of real property divisible by ownership and/or occupancy. Examples of such identifiers include, but are not limited to, conventional street addresses, zip codes, postal code, parcel numbers, property tax identification numbers, or other similar identifiers. Different countries, states, counties, cities and other geographically separate or geographically separate governing areas may use different types of identifiers, but many have geographic identifiers, all or portions of which may be used to derive at least part or all of a location code.

In the United States, different geographic identifiers have been derived for use by different governing bodies for different purposes. For example, the United States Postal Services uses, what is commonly referred to as a “mailing address”, i.e., street address, city, state and zip, to identify specific geographic locations for the delivery of mail. For purposes of this application, a street address may be limited to the street name and associated number designation and does not necessarily to include the city, state and associated zip, although a street address may include the city, state and/or zip. City, state and county taxing agencies assign identification numbers to each piece of property for the purposes of assessing the payment of taxes. For purposes of recording ownership of a particular piece of land, lot and parcel numbers are typically assigned, within each county, to identify the different pieces of property within that taxable region. Further, the U.S. Department of Commerce has developed geographic identifiers, i.e. Geocodes, for the collection of census information and the North American Numbering Plan Administration (NANPA) assigns area codes to specified regions across North America for the use as part of telephone numbers assigned within each region. FIG. 3 illustrates how the NANPA has currently divided California into distinct geographic regions and the particular area codes that have been assigned to each region.

In summary, in one example of one implementation, location codes may be derived entirely or at least partially from all or part of geographic identifiers. Examples of how several of the most well known of these geographic identifiers, such as street address, zip code, property identification numbers, latitude/longitude coordinates and/or latitude/longitude/elevation coordinates may be utilized as part of a location code are described below. As discussed above, there are many other geographic identifiers from which all or part of a location code may be derived. Upon examination of this application, those skilled in the art will recognize that geographic identifiers, other than those discussed below, may be used to generation of all or part of a location code.

1. Conventional Street Address

Currently, commercially available navigation systems utilize the entire conventional street addresses, including city and state, to generate routing and/or mapping information for a particular location. A conventional street address is comprised of what is commonly referred to as a house number and a street name, which in some navigation systems require two separate entries—one entry for the house number and one entry for the street name. Typically, a user is required to define a particular geographic zone in which the navigation system is to operate, e.g., a particular state and/or city within the United States, to help confine the search for a particular address within a specified area and distinguish the desired location from other locations bearing similar street addresses.

Once the user enters a house number and street names, a look-up table is typically generated to allow for the user to select the exact name of the street. Oftentimes, in a particular area, there are many different variations of a particular street name. For example, the following lists represents a sample list, which is not inclusive, of different streets that may exist in a given geographic area or zone that all use the same root street name: Maple Street, Maple Avenue, Maple Court, Maple Blvd., E. Maple, S. Maple, W. Maple, N. Maple. For this reason, the street name is often times not entered correctly, or the program does not allow the user to enter the exact street name, and the navigation system cannot distinguish the desired street name from other similar street names. Therefore, a look-up table is present for the user to select the exact street name from those which the system has found to be similar.

Further, in some areas, several locations may share the same street address. For that reason, another look-up table may be presented to the user to further narrow the geographic area in which the desired location resides, e.g., a city look-up table may be provided. As explained above, the process of entering a conventional street address in a navigation system can be tedious, cumbersome and possibly dangerous when used in a vehicle navigation system while the vehicle is in motion.

Despite the described problems with utilize street address in a navigation system, street address are the most recognizable designation for a particular location. Therefore, location codes may be generated that uses at least a portion of the conventional street address. For example, the house number, which is easy to enter into a navigation system, could be used in at least part of the series of characters comprising the location code. The remaining portion of the location code could be comprised of characters derived from any of the various methods describe in this application.

2. Zip Code

Another series of characters that may be used as part or all of the location code is the number designation, known in the United States, as a zip code, which functions to assist the U.S. post office to direct mail to a specified geographic location. Similar numbering systems are present in other countries, besides the United States, and may be similarly used as all or part of a location code.

In the United States, when asked to provide a zip code for a particular address, most individuals provide the five digit zip code for the location or, in some instances, provide the a nine digit zip code for the location, which is commonly referred to as ZIP+4. Most are not aware that each individual postal address has a nineteen digit zip code associated with it that uniquely identifies the exact location of that mailing address.

The unique nineteen digit zip code can be segregated into 5 different segments. As detailed below, each segment contains numbers that signify different information about the location of the postal address to which the zip code relates.

1. Digits 1-5. The first five (5) digits in the zip code represent a post office service area or last line name, which is used to specific a particular physical geographic area.

2. Digits 6-7. The next two (2) digits, which together with the first five (5) digits comprise the first seven (7) digit of a zip code, identify a geographic sector within a post office service area.

3. Digits 8-9. The next two (2) digits, which complete the nine (9) digit zip code, typically identify one side of a street within a single one hundred-address range block. The nine (9) digit zip code is typically referred to as ZIP+4.

4. Digits 10-11. The next two (2) digits, which together with the previous nine (9) digits, comprise an eleven (11) digit zip code, or ZIP+6, uniquely identify a delivery point code, which uniquely identify the conventional street address associated with the geographic location, but does not identify any particular unit or suit located at the particular conventional street address.

5. Digits 12-19. The next eight (8) digits, which complete a nineteen (19) digit zip code, uniquely identify every individual address to which the U.S. Post Office delivers, including post office boxes, rural addresses, mobile homes, unit numbers, suite numbers, apartment numbers or other such sub-designation within buildings or located at a single conventional street address.

In one example implementation, location codes could comprise the nineteen digit zip code for a geographic location. Alternative, all or a portion of the nineteen digit zip code for particular location may be used as all or part of the series of characters representative of the location code. Where only a portion of a location code is comprised of all or a portion a property's zip code, the remaining portion of the location code could be comprised of characters derived from any of the various methods describe in this application that would make the location code easier to enter into the navigation system than a conventional street address.

3. Property Identification Numbers

In many countries, like the United States, special character designations are assigned to each individual piece of real property for purposes of recording ownership, assessing taxes and performing other government related functions. For purposes of this application, all such character designations shall be referred to as “property identification numbers.” Each piece of property may have one or more property identification number assigned to it, depending upon the intended use for the number. One common property identification number is the number assigned to each piece of property that is used by taxing authorities to levy property taxes in the United States. These property identification numbers are referred to by some taxing authorizes as a parcel number or tax assessor's ID number and typically include at least ten digits, where four of the digits represent the map book number, three of the digits represent the page number in the map book and the other three digit represent the parcel number assigned to the property. Additional numbers may be included as part of the property identification number used for tax purposes, which may include, for example, numbers representative of individual suites in a multi-unit structure.

Like other property identifiers, all or portion of a property identification number may be used as all or part of a location code. In the United States, property identification numbers are typically assigned by county, such that a particular piece of property located in one county may have the same property identification number as a different piece of property located in another county. If property identification numbers are used as location codes, the county in which the property resides must also be provided to the system to determine location information. This can be implemented by restricting the system such that it only utilizes information within a certain geographic zone or by asking the user to select or input the county in which the desired designation is located.

Alternatively, additional characters may be used in conjunction with a property identification number that specify or represent the particular zone in which the property is located. Using property identification numbers and additional characters representative of zone, nationwide, or global location codes may be generated. Alternatively, if national parcel numbers are or become available for a particular country, then all or a portion of the national parcel numbers may be used as all or a portion of a location code for a particular identifier.

Further, where only a portion of a location code is comprised of all or a portion of a property identification number, the remaining portion of the location code could be comprised of characters derived from any of the various methods describe in this application that would make the location code easier to enter into the navigation system than a conventional street address.

4. Latitude Longitude Coordinates

In addition to property identification numbers, there are many different types of universal and national coordinate systems in use to identify particular geographic locations. One popular coordinate system of which is the global coordinate system that represents position in terms degrees, followed by minutes and then seconds for both latitude and longitude, e.g., N61° 11′ 0.924″ W130° 30′1.660″.

Accordingly, all or part of a location code may be generated using all or a portion of the coordinate designations for a particular location. Coordinate designations of any coordinate system may be used in the generation of location codes, whether the coordinate system is currently in use or developed in the future. While location codes may be generated entirely from coordinate designations, location codes may also be derived such that only a portion of the location code is representative of all or part of a coordinate designation. In this case, the remaining portion of the location could be comprised of characters derived from any of the various methods describe in this application that would make the location code easier to enter into the navigation system than a conventional street address.

C. Correlated Identifiers

In another example of one implementation, locations codes may also be developed such that all or a portion of the location code is comprised of a series of characters that correspond indirectly to, or that can be easily associated with, previously assigned geographic identifiers for a particular geographic location. In other words, rather than using identifiers, all or a portion of a location code may be comprised of characters that are representative of identifiers or that may be associated with identifiers. Characters or a series of characters that correspond indirectly to, or that may be associated with, geographic identifiers may be referred to as “correlated identifiers.” As discussed in more detail below, all or a portion of a telephone number may operate as a correlated identifier. Further, a series of characters assigned to represent or correspond to existing location information may operate as a correlated identifier.

1. Telephone Numbers

While telephone area codes may be considered geographic identifiers, an entire telephone number does not, by itself, give any information as to the particular geographic location in which a number is associated except to indicate an association with the geographic region in which the area code designates. However, since most telephone numbers are associated with a particular geographic location, telephone numbers can operate as correlated identifiers for which all or a portion of the number may be used to generate all or a portion of a location code.

Telephone numbers are generally assigned to individuals and businesses for their exclusive use. A telephone number is generally comprised of a sequence of decimal digits (0-9) that identifies a destination telephone line in a telephone network and that allows a caller to connect to the line when the telephone number is dialed by the calling party or that provides the caller with enough digits to allow a caller, using the necessary prefixes required to connect through the telephone network, e.g., such as a (1) when dialing long distance or (011) when dialing international from the United States, to connect to the line when the telephone number with required prefixes is dialed. The length of each telephone number varies depending upon the number of end points within the public switched telephone network that a call must pass through to reach the destination telephone line in a telephone network. For example, a local telephone number is shorter than a long distance or international telephone number because the call is not required to pass through as many end points in the public switched telephone network. Thus, the same telephone number may be represented by several different series of decimal digits depending upon where the call is originating from and where the destination telephone line is located.

Telephone numbers can be easily associated with a particular geographic location by looking up the mailing address information associated with the owner of the telephone number. While all or part of a location code may be generated by using all or part of a telephone number, for the reasons set forth below, the use of telephone numbers as correlated location code identifiers may not be preferred. Further, to avoid confusion between location codes and telephone numbers, location codes should not be comprised exclusively of any telephone number associated with the geographic location to which the location code is associated. In other words, if location codes, were derived in all or in part from telephone numbers associated with the geographic locations to which the location codes relate, the location codes should either (i) be comprised of only part of a telephone number associated with the geographic location or (ii) include an entire telephone number plus other characters which preclude the location code from operating as a telephone number associated with the geographic location to which the location code relates.

In the past, it may have been safe to assume that one would receive accurate address information for a particular party by acquiring the address information associated with that party's telephone number. However, with the increasing popularity of cellular telephones and the continually reassignment of the telephone numbers to new owners, using telephone numbers may not yield accurate information about the geographic location of the owner of a specific telephone number. Telephone numbers are associated with billing addresses, which are not always the same as the residential or business address of the holder or owner of a telephone number. Thus, the associated address information may not always be the geographic location that a user desires. Further, because individual and business telephone numbers change so frequently, the address information associated with a given telephone number in a particular database may be stale or unlisted.

While telephone numbers may be used to obtain location information, the use of telephone numbers may not be as desirable as other information that is directly associated with a property address. This is not, however, to say that a format similar to that of a telephone number may not be desirable for use as a location code since the public has come to remember and recognize the construction of certain series of characters to represent telephone numbers. For example, a location code may be generated to appear as follows 2-212-555-1234, or may appear to look exactly like a telephone albeit not associated with the geographic location for which it represents. Further, it may be desirable to use at least a portion of a telephone number, such as the area code or number prefix, as part of a location code. Further, because area codes are familiar geographic identifiers, using them as part of a location code could be desirable. Area codes may be easier for some to remember and would provide an immediate sense of the approximate location of the geographic location for those familiar with the area covered by a particular area code.

Where only a portion of a location code is comprised of all or part a telephone number, the remaining portion of the location code may be comprised of characters derived from any of the various methods describe in this application.

2. Representative Identifiers

Location codes may also be comprised entirely or at least partially of characters assigned to represent geographic identifiers for particular locations. For example, each unique street name could be represented by a unique series of characters, such that a street address could be entirely represented by a series of numbers where the first set in the series is the house number and the second set in the series is a correlated identifier representative of the street name. Similarly, correlated identifiers could be used to represent the city, county, state, country or other bounded or designated geographic area in which a location resides. For example, unique characters may be assigned to represent different cities, counties, states, country or other geographic areas and may be used as all or part of a location code.

By assigning unique character identifiers to represented different geographic zones, location codes can be constructed, at least partially, of these zone identifiers. Any area, such as the world, country, state, county, city, or any other current or future defined zone can be characterized as a predetermined geographic zone and can be divided into smaller zones. These zones can be geographically based, equal segments, density based, randomly generated or divided by any method for segmenting the area.

Typically, geographically based zones are divided by boundaries already assigned to a region. For example, the world can be divided into countries, each country can be divided into states or provinces, and in turn states can be divided into counties, which can be divided into cities. Equal segment division divides an area into equal segments or zones. Further, each zone may be divided into sub zones and so on. Density based division divides an area into separate zones having sizes that are inversely related to the density of entities requiring location code assignment. An area may also be divided into random segments or zones.

Regardless of how zones are determined, each zone may be given a representative identifier and used to construct location codes. For example, location codes can be configured as follows: (Zone-L1) (Zone-L2) . . . (Zone-Ln) ID, where Zone-L1 identifies the zone assignment for the largest sub-divided area; Zone-L2 identifies a sub-division within Zone-L1; Zone-Ln (Zone Level-n) identifies a sub-division within Zone-(n−1); and ID identifies points at a particular location code within Zone-n.

The above described division methods may be mixed and matched at various levels to create a location code. It should also be noted that there is no requirement to precede the higher level zone with the lower level zones or having the ID be at the end of the sequence. For example a location code can be constructed as: (Zone-L1) ID (Zone-L3) (Zone-L2) or (Zone-L3) (Zone-L1) (Zone-L2) ID.

As with all the different methods for generating location codes, location codes may generated from a combination of representative identifiers and characters derived from any of the various methods describe in this application that would make the location code easier to enter into the navigation system than a conventional street address.

D. Combination of Location Code Types

As stated above, location codes may be generated using a combination of any of the methods described above for deriving location codes that can be associated with a particular geographic location within a given zone. For example, location codes may be derived all or in part from random identifiers, geographic identifiers, correlated identifiers or any combination of the foregoing. Further, mechanisms can be established to address identical numbers used by different numbering systems or for the use of identical numbers in different zones or areas.

Additionally, in one example of one implementation a single method for generating location codes may be utilized to generate every location code within a particular geographic zone. Alternatively, more than one method may be simultaneously utilized to generate location codes. For example, it may be desirable to use a different method to generate location codes for businesses than the method used to generate location codes for residential address. Further, not all locations may be associated with a desirable particular location identifier for use in generating location codes. Separate methods may be desirable to generate location codes for locations having such association from those that do not. It may also be desirable to use different methods for generating location codes associated with different types or categories or classes of locations so that the generated location codes may function to identify a particular location attribute.

### II. Associated Geographic Locations

As set forth in Section I above, location codes may be generated using a number of different methods for associating a location code with a given geographic location. While using location codes rather than conventional street address will make the input of designation information simpler, using location codes rather than convention street addresses will also provide greater capabilities to navigation systems by removing restrictions placed on the operation of the systems through the use of conventional street addresses as destination identifiers.

As explained below, location codes may be assigned to geographic locations that do not have conventional street addresses. By using location codes to generate routing information, rather than conventional street addresses, navigation systems may provide routing information to users for designations that do not have conventional street addresses. Additionally, most navigation system do not provide for a mechanism to input conventional street addresses that include suite, floor or unit numbers. By using location codes, each entity utilizing the same conventional street address, distinguished from one another only by floor, unit, suite or other designation, can be uniquely identified by a navigation system by utilizing location codes. Further, one location code can be associated with a group of locations to allow a user to select which location in a given group for which he/she would like to obtain routing information.

A. Geographic Locations Absent Conventional Street Addresses

Many points of interest do not have conventional street address assignments. Similar to the manner in which a location code is assigned to a geographic location having a conventional street address, location codes may be assigned to locations that are not traditionally associated with a conventional street address. For example, location codes could be assigned to street addresses, town centers, parking lots, transportation stations, parks, beaches, street intersections, parcel numbers, coordinates, automatic teller machines, drop boxes, kiosks, bus stops, city markets, recycling centers, gas stations, restaurants, real estates, shops, businesses, stores, undeveloped real estate and points of interest and etc.

Different methods may also be used to generate location codes for locations having conventional street address assignments from those that do not have street address associations. In this manner, if all or part of a location code is generated either directly or indirectly though the use of the conventional street address assignment for a particular location or from other geographic identifier that is not associated with every location, those locations absent such associate may be assigned location codes that are generated using a different methodology.

B. Multiple Locations at a Street Address (Suite, Floor, Apartment Number)

In one example of one implementation, by using location codes, different suites, floors, or other sub-designations associated with a conventional street address may be assigned their own unique location code. For example, a multi-unit building may have one location assigned to it, while each individual unit may have a separate location code assigned to it. Similarly, different units, such as apartments, lot numbers, parcel numbers, suites or other unit designations, entrances, parking lots, etc may be given separate location codes.

C. Group Location Codes

In yet another example of one implementation, a single location code may be also be assigned for use in connection with a group of locations. In this manner, when the user enters the group location code her/she will be provided with the list of locations associated with that location code. Optionally, the list may be displayed in order of closest location to the user. The user can then select the desired location from the list. For example, a business with multiple locations may desire to have a location code that is associated with all the locations of its business. By having a group location code for a business, a user is always able to find the nearest location of the business.

Group location codes can used for a variety of application other than to display the nearest locations of a particular business. Group location codes could be assigned to identify the nearest location for a particular type of business or service, for example, to locate the nearest gas station, restaurant, ATM, hospital, without regarding to association with a particular company. Certain types of businesses may also want to use group location codes to provide locations of particular interest. For example, real estate agents may want to use a group location code to associate with the location of all their current listings. All properties listed by a certain agent or company in a certain area can be indexed under one location code. When that location code is input to the system, the list of all corresponding location codes with their addresses and other attributes may be presented to the user. Other uses and application for group location codes exist apart from the examples given above. Accordingly, the use of group location codes is not limited to these example implementations.

### III. Location Code Identifiers

Although not necessary, it may be desirable to restrict or limit the number of characters that may be used for a location code. Additionally, it may be desirable to restrict, limit or require the types of characters used in a location code. Such limitations, requirements and restrictions may be placed on the generation of location codes for a wide variety of reasons, include, but not limited to, providing uniformity, familiarity and distinguishing characteristics of location codes or to classify certain types of locations by a particular attribute or characteristic. For purposes of this application, the term class includes entities with at least one common characteristic or attributes. For example, structures that are considered to be houses may belong to one class. Further, one-story houses may belong to a separate class. One story houses that have swimming pools may belong to yet another class. Here, sub-classes are also defined as a class in that certain classes fall completely within other class designations.

For example, the number format of a location code may follow that of a previously known numbering system to help users remember the location code. Additionally, using different characters or a different number of characters in location codes may help distinguish locations codes from other types of identifiers or may assist users determine to what type or class of entity a particular location code relates.

Although not necessary, the number of characters in a given location code may be fixed or fixed for a given type of entity or class. For example, all location codes could consist of a fixed numbers of characters, or the number of characters for residential locations could be fixed with a first fixed number of characters, whereas the number of characters for other types of locations, such as commercial locations, could consist of a second number of fixed characters. Similarly, locations for emergency services could comprise a third number of characters. In this example, other categories or classes of locations may be used in addition to, or other than, residential, commercial or emergency service locations, and may each use a different fixed number of location code characters.

Having a fixed number of characters for certain types or classes of locations may help minimize mistakes with location codes and assist with the recognition of location codes, similar to the way certain types of telephone numbers can be distinguished (e.g., local numbers, long distance numbers, information numbers, and emergency numbers). Location codes with less number of digits can be assigned to entities, which need to be recalled easily such as emergency services, important addresses etc. In this manner, a user will know and expect a certain number of digits when conveying or coming across a location code for that type of entity.

Additionally, although not necessary, it may be easier to remember location codes having number assignments, similar to the numbering assignments for telephone carriers. If a similar numbering assignment is used for location codes, it may make it easier to both remember and convey location codes. For example, a US telephone numbers consists of 10 digits and is written and conveyed in NXX-NXX-XXXX sequence, where X is any number between zero and nine and N is any number between two and nine (zero is reserved for operator assistance for local numbers). Further, by using a similar numbering system for location codes, it is possible to uniquely identify up to ten billion locations with a location code consisting of a ten-digit number. In a given area code boundary, up to ten million locations can be uniquely identified using the remaining seven-digits after the area code. Further, it may be desirable to increase the number of possible locations while at the same time keep the familiar telephone number sequences by added prefixes or suffixes to the numbering format.

For example, in the US and Canada, telephone numbers outside the current area code are dialed as 1-NXX-NXX-XXXX. Zero is reserved for the operator. It is possible to use prefix other than “zero” and “one” for the location code, allowing for the use of any prefix numbering two through nine. For example a location code could be X-XXX-XXX-XXXX (e.g. 3-818-555-5555). By using this method, all of the advantages outlined above are obtained while increasing the total number of uniquely identifiable locations to 100 billion within the total coverage area and 100 million within each area code. Prefixes may be restricted to two to nine to distinguish a location code from a telephone number and/or to distinguish one type of location code from another. If desirable, unique country code prefixes may be added to the ten-digit series of numbers that may or may not exactly correspond to the current country code designations of the telephone carriers.

Further, symbols can be used to identify and distinguish location codes from telephone numbers or other identifying series of numbers. For example # or * may be added as a prefix to the location code. Further, by adding a symbol or other distinguishing character to the location code, both telephone number and location code number can be used together seamlessly, since using different prefixes would allow the two to be distinguished.

Alternatively, a new unique number of characters can be used to distinguish location codes from other types of easily identifiable series of characters. For example, location codes could be eight digits in length, to distinguish location codes from seven or ten-digit telephone numbers and from five and nine digit zip codes.

Upon examining this document, one skilled in the art will recognize that other alternative combinations are possible that utilize a similar method for deriving locations code as those used to derive telephone numbers and also that include the use of alternative characters not used by the telephone carriers to assign telephone numbers, including but not limited to the use of “zeros” and “ones” as the initial digit in a seven-digit number, mixing other character types with the numbers, such as * or #, or by using a number of digits different than those used by other known identifiers.

### IV. Reserved Location Codes

In another example of one implementation, outside of the traditional means for generating location codes, as set forth in Section I above, it may be desirable to remove certain series of characters from the pool of available location codes that can be generated to reserve those series for special purposes. For example, certain entities may desire to utilize location codes that are easy to remember or that are representative of, or can be translated to represent, a certain aspect or attribute of their business. For example, the location code for a florist may desire to use the following location code (#304-435-6937), which may be translated into (#304-4Flower), which is a deterministic translation based on alphanumeric characters on telephone keypad.

### V. Multiple Location Code Assignments

Further, at certain times and under certain circumstances, secondary or additional location codes may be permanently or temporarily assigned to given locations. If, for example, an area code is included as part of a location code and the area code changes, the effected location may, for a limited time, have two location codes assigned to it, one with the old area code and one with the new one. Another example is an entity which, in addition to its direct location code, may have a location code assigned to it that is associated with, for example, all its business locations or that is obtained merely because the secondary location code is easier to remember. This type of location code may be referred to as a “group location code.” In this regard, by using a group location code, a user may obtain information related to all the businesses associated with a particular group code. Information provided regarding a given location code may be restricted to businesses associated with a group location code residing in a certain, predefined area. In this manner, the user may be provided with information in the form of a look-up table or map for all associated businesses within a desired location or radius from the user. From there, the user may select for which particular associated business it desires to obtain information. Alternatively, the system may, by default or by a setting selection, automatically find the nearest business associated with group location code provided by the user.

Temporary location codes may also be assigned to an entity that already utilized another location code. In this regard, a location may desire to obtain a temporary location code for use in connection with specific events, e.g., for use in connection with advertising a particular convention at a convention center, hotel or etc. This may be done for sake of associating Metadata for a certain event with a particular location code. The foregoing examples represent only a few of many reasons for assigning multiple or temporary location codes.

### VI. Private Location Codes

In certain circumstances, it may be desirable to have location codes that may only be accessible through the use of a security code. For example, when using group location codes, it may be desirable to restrict access to locations associated with a given group. As set forth above, a real estate agent may desire to utilize a group location code to which the agent can associate all of his/her listing. Depending upon the information that may be provided with the listing locations, the agent may desire to restrict access to the information associated with the group location code to the agent's clients or to other agents.

For private events at undisclosed or unpublished locations, it may also be desirable to require the use of a security code with the location code. The location code may not be associated with any particular geographic location without having the associated security code. Further, should individuals or business desire to control the public accessibility of their address or telephone number, they could require the use of a security code in conjunction with their location code. For example, if a location code uses all or part of an unlisted telephone number or is associated with an unpublished address, the proprietor of the location associated with the particular location code may not desire to have any information associated with the location code publicly accessible. In this regard, the proprietor of the location code may require the use of a security code to access any information associated with the location code. Thus, only if the proprietor provides a user the security code will a user be able to associate an unlisted number with an entity or person or determine the location associated with a particular telephone number.

Security codes associated with location codes may be changed as desired in the same manner as passwords are changed for many different types of application. In one example of an implementation, only those having personal identification codes, e.g., private pins, may be allowed to change the security codes associated with a given location. For example, security codes may be changed via telephone, via the web, via mail or via a navigation system by providing the related pin or personal identification code, the old security code and the new security code desired. Pins and/or personal identification codes may be changed in the same manner. If the location code uses all or part of a telephone number, proprietors of location codes may obtain their personal identification numbers by calling from the telephone number associated with the location code.

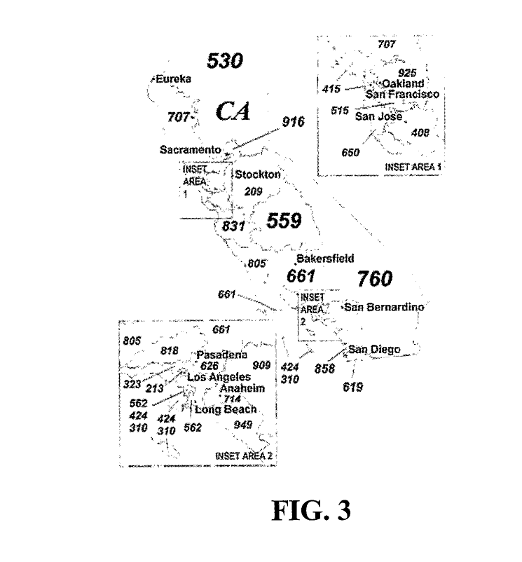

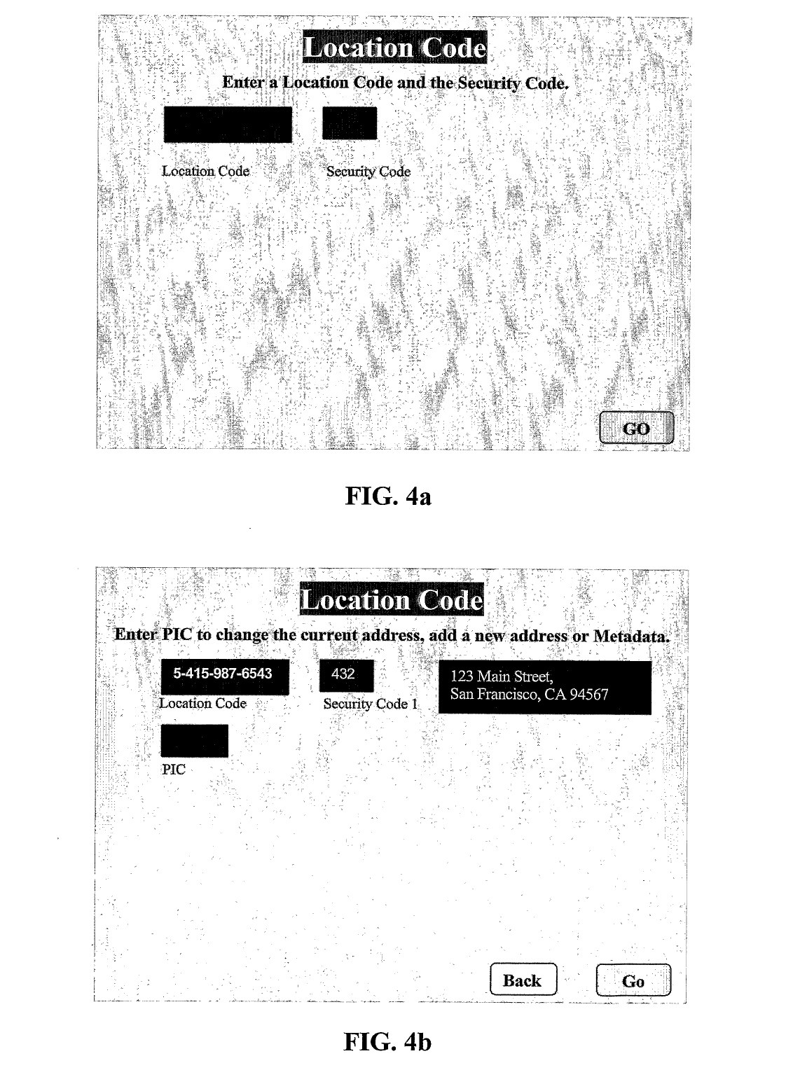

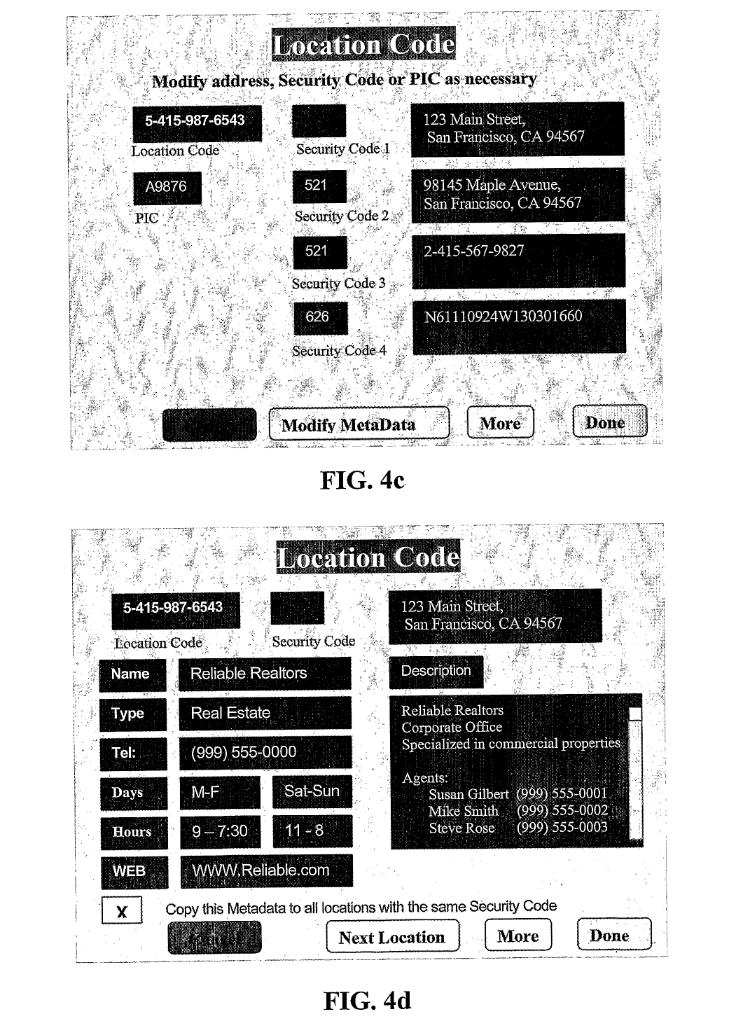

FIG. 4a illustrates an example of one implementation of an input screen that demonstrates the use of a security code to obtain location information associated with a particular location code. As illustrated in FIG. 4a, the user may be required to enter both a location code and a security code to access information related to the geographic location associated with the location code. This input screen may be used for the entry of all location codes. If no security code is required, none would be entered. Alternatively, the system may first ask the user for the location code and then, if a security code is required, prompt the user separately for the security code.

FIG. 4b illustrates an example of one implementation of an input screen that may be provided to prevent a user to modify or add data associated with a location code unless a Personal Identification Code (PIC) is entered By periodically changing the security code, the user can help to control the use of the location code and maintain the security of the address associated with their location code. In this manner, user that may have previously used a location code associated with a security code will not be able to use a navigation system to find the location associated with the code unless they have the newly issued or changed security code. As illustrated in FIG. 4b, the user may be required to enter both the security code and a private personal identification code (PIC) that is only known to the owner of geographic location associated with the location code to change the security code and other associated data including address(es) and metadata. Although this example illustrates changing the security codes through the navigation system, the security code may also be changed via telephone, via the web, via mail, etc. PICS may be changed in the same manner.

Also, as illustrated in FIG. 4c, the user may change the address associated with a particular location code or may associate additional addresses with a particular location code. FIG. 4c illustrates an example of one implementation of an input screen that may allow a user to change the address associated with a particular location code or may allow a user to associate additional addresses with a particular location code. As seen in FIG. 4c, a user having the appropriate security code and personal identification code (PIC) may change the address associated with the location code or may associate additional address with the code from which the user may select. This type of application may be desirable, for example, for use with location codes assigned to real estate agents so that the agent can add and change address associated with a particular location code to display new listings and to remove sold listings from the locations that are acquired by the use of the agent's group location code with a navigation system.

In particular, as shown in FIG. 4c, a group location code can be created by associating additional geographic locations with a particular location code. In FIG. 4c, four additional geographic locations are associated with the location code 5-415-987-6543. The information may be changed through the use of a PIC. Further, the user may be provided with an option of associating a security code with each location associated with the location code. In this manner, location information that is not associated with a security code will be publicly available and locations associated with a security code may only be obtained through the use of the security code associated with the location. Thus, since the first listing in FIG. 4c is not associated with a security code that location will always appear with the entry of the location code. Since the second and third entries are associated with the security code 521, these locations will appear only if the location code and security code 521 are both entered by the user. In that case, the first three entries illustrated on FIG. 4c will be displayed. If, however, the security code 626 is entered with the location code, the first and fourth listing illustrated on FIG. 4c will be displayed.

The system may provide for the addition of more locations than illustrated or than are able to be displayed on the screen by, for example, providing a “more” button or icon for selection, as illustrated on FIG. 4c or by providing a scroll bar on the screen. Further, the system may accept the listing of locations in a variety of formats, such as street address, location code, coordinates, and/or etc.

In this example, 5-415-987-6543 (521) becomes a group location code. In example of a realtor, the group location code with security code 521 can be list of properties to be shown to a group of customers with a certain requirements. In the case of a hotel, for example, that hosts different events; each security code can represent a different event. In case of individuals, the location code can be associated with a variety of locations having some relationship to the individual, such as home or place of work. If desirable, each location code may be associated with a different security code to distinguish between the locations without the necessity of associating a different location code to each destination. Optionally, metadata may be associated with the location code and/or each location associated with the location code.

FIG. 4d illustrates one example of one implementation of how metadata can be associated with a location code and how it may be accessed and modified. In this example, the metadata information may be accessed by selecting an icon or button, such as the one illustrated in FIG. 4c marked “Modify Metadata.” This information may only be accessible upon the entry of the PIC (FIG. 4c). Thus, unless the PIC is entered with the location code, a user will not be able to access and/or modify the associated metadata.

As shown in FIG. 4d, each location associated with a given group location code may have its own independent metadata that may be tailored to provide information particular to the type of purpose of the group location code. FIG. 4d, illustrates the metadata that may be associated with the first listing in FIG. 4c. In this example, the following fields are provided: name, type, telephone, days of operation, hours of operation, website and a detailed description. The system may allow the same metadata to be associated with all the locations associated with the same security code by, for example, placing an X in the box, as illustrated in FIG. 4d. If selected, the same data will be copied to all of the locations with the same security code. The system may provide for additional metadata fields, such as fax, email, image files, or etc by, for example, providing a “more” button or icon for selection, as illustrated on FIG. 4d. Further, the system may allow for the editing of the metadata associated with other locations in the list of locations associated with the location code by providing, for example, an icon or button, such as the “Next Location” button illustrated in FIG. 4d to bring-up the metadata for the next location in the list. Metadata in the above examples (4a, 4b,4c,4d) may be accessed and modified over a network such as internet using an interface such as a browser.

### VII. Associating Data to Location Codes

In addition to geographic location information, a location code may also have other data, such as metadata, associated with it. For purposes of this application, “data” shall mean information, segments of information or the raw material of information. Data may further include useful, irrelevant and/or redundant information or raw material. Data may take various forms, including, but not limited to, numbers, letters, symbols, text, graphics, images, audio and/or video and may comprise a single fact or a collection of facts, raw facts, statistical data, metadata, binary digits, measurements, concepts, instructions, animation, databases, links, programs, computer files, records, and etc. Data commonly used in connection with a navigation system may take the form of a location code, geographic identifying information (e.g., coordinate information, all or part of a zip code, post code, a telephone number, a parcel number, or other similar data that can be used to directly or indirectly identify at least one associated geographic location), metadata, event data, commands, database information, computer files, computer programs, such as scheduling and/or contact management programs, and security or rights management information, among other things.

As used in this application, “metadata” is any data about data. For example, metadata may include, but not be limited to, information in the form of binary, text, characters, graphics, images, pictures, audio, video, animation, files, files created by different programs, organized or unorganized data, information, databases, links, programs, attributes or any other format for communicating information.

There are many different ways that data may be associated with a location code and provided to a user. One example of such association techniques is using information or web technology. This includes but not limited to using HTML, XML, PDF, application programs, various multimedia players, databases, programming languages such as Flash, Java, Java script, C, C++, C# or proprietary association techniques etc. As web and information technology becomes more advanced with additional capabilities, these and other data association techniques may be used to enhance the user experience. A person familiar with the state-of-the-art may easily integrate such advancements for association of data with location code. Integration of such advancements is expected and is intended by spirit of this invention.

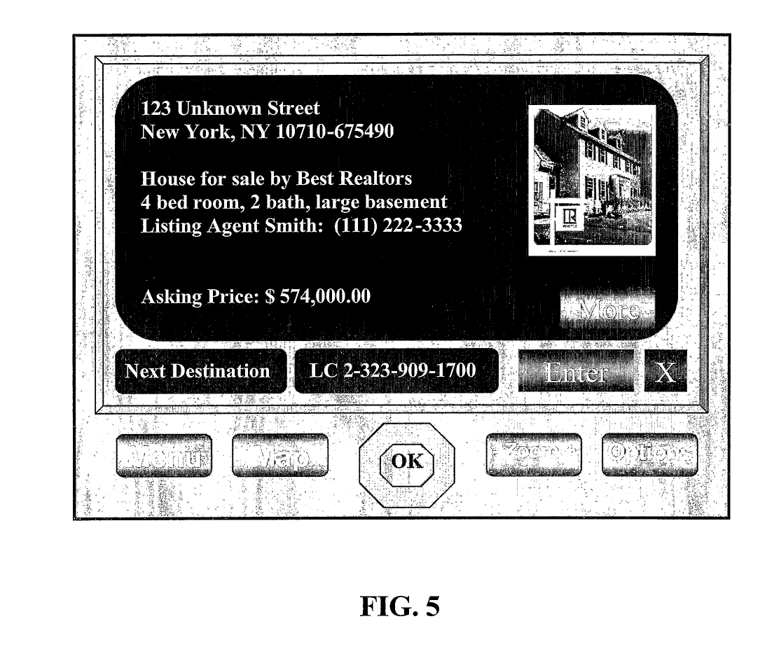

FIG. 5 illustrates one example of one implementation of how such metadata may be displayed to a user in connection with the operation of a navigation system. In particular, FIG. 5 illustrates how attributes, taking the form of Metadata, may be utilized when a location code is associated with a house or other piece of real property that is for rent or sale. In this case, the metadata may include the agent, telephone number, specification of the property, a photo and the fact that there is more data available if desired. It should be noted again that this data might be available locally or downloaded in real-time right after the user inputs the location code and presses “Enter”.

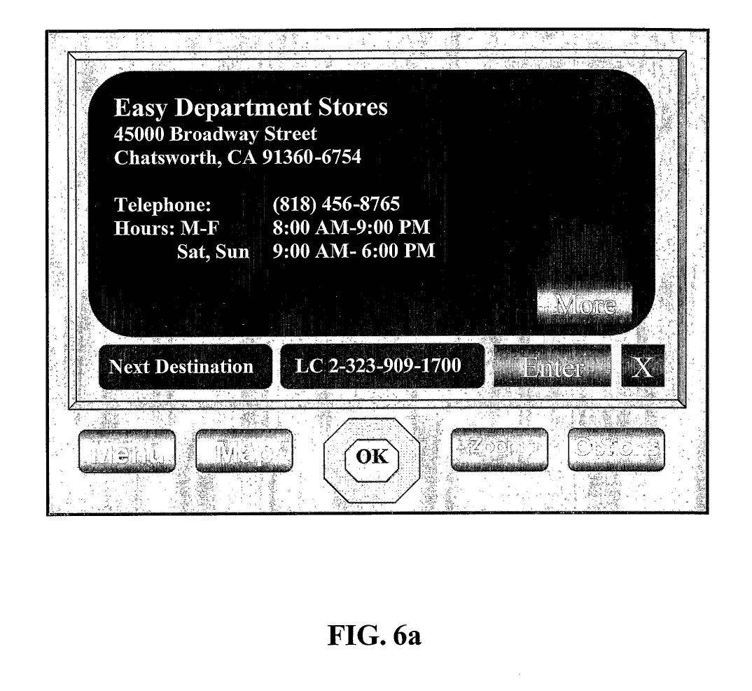

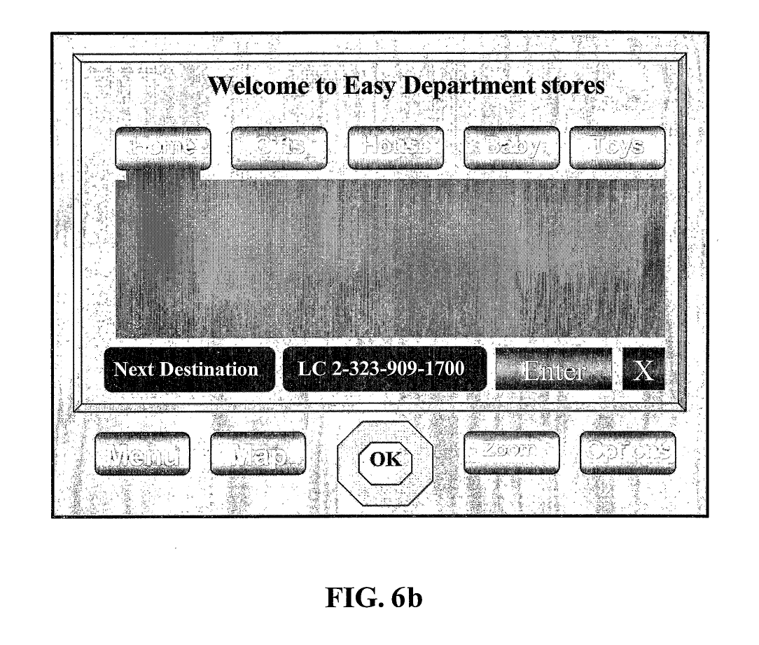

FIG. 6a illustrates another example of one implementation of how metadata may be displayed to a user in connection with the operation of a navigation system. In this example, the location code is associated with the geographic location of a department store. The displayed metadata includes the name, address, telephone number and hours of operation of the department store.

FIG. 6b illustrates another example of one implementation of how metadata may be associated with a location code for commercial property, such as a department store. In this example, even more detail information about the department store and its different attributes may be displayed by the navigation system using a website. This more detailed information may be obtained by requesting “more” information from a more generalized output screen relying specific information about the department store to the user, such as the output displayed in FIG. 6a.

### VIII. Examples of Implementations of Location Code Types

As described above, location codes may be generated from a variety of methods which may be used alone or in combination with one another. Examples of several implementations of location code generation using the methods described above may be found below. The examples below only represent a small sample of different methods that may be used to generate location codes. Accordingly, the examples are being offered for illustrate purposes only and in no way intended to limit the manner in which location codes may be generated. These combinations and other implementations will become apparent to individuals skilled in the art upon examination of the provided implementations. All such additional implementations shall be included within the scope of the invention and limited only by the accompanying claims.

Although any number of methods may be used to generate location codes, it may be desirable, although not necessary, to limiting the type of characters used in construction of a location code to numbers to make it easier to input via a variety of input devices such as ordinary telephone keypad. In case the input device is a touch screen, it would be easier for a user to use a numeric pad rather than alphanumeric pad especially on a small screen. Certainly, entering a number is much simpler than entering foreign characters. For an individual to convey a numeric number may also be much simpler and less prone to mistakes than conveying a code that includes letters and symbols. Further, two individuals speaking a different language would only to be able to communicate numbers zero trough nine to convey a location code. Fixing the length of the location codes of a given class of entities in a given geographic area also may help with creation of location codes. In this manner, the location codes would be easier to convey and less prone to miscommunication due partly to the fact that both sides expect a certain number of digits and the digits can be grouped in a familiar predetermined clusters separated by non-active characters such as dashes. Limiting the length of the location codes to a relatively small number of digits while making sure that enough location codes will be available for entities in a given geographical area in the foreseeable future will further help with creating location codes which are easier to enter, easier to remember, easier to convey and a system which is universal and robust.

To give a user a general sense of the location of the entity associated with a location code, several digits within each code could be set aside for identifying different geographic zones. Using preexisting geographic zones already familiar to the public such as telephone area code may further help with remembering the code, conveying the code and giving a general idea of the location of the associated entity. However, there are drawbacks when using telephone area codes as part of the location code due to the fact that globally, area codes are changed, split or added to regularly. When area codes are used, a more user friendly numbering system may be created if the numbers of digits in the most used location codes match the number of digits in a telephone number. Putting all of the above concepts together may render a location code numbering system that in the United States may be constructed as follows:

N-NXX-XXX-XXXX

Where N is a number between two and nine and X is a number between zero and nine. Prefix zero is used for accessing the operator. The geographic zone “NXX” may match the area code “NXX”. The prefix “N” distinguishes a location code from a telephone number that starts with a “1” and also multiplies the number of possible location codes by eight. Using a prefix “N” may further reduce the possibility of running out of location codes. Different numbers at the prefix “N” also could be used to specify subclasses. For example all street addresses that include multiple unites may start with prefix “3”.

If desired “#” and “*” which are available in all telephone keypads may also be used to distinguish location codes from telephone numbers. Of course in addition to area code, country codes can also be used and added to the location code. The location codes can be used within each country.

Newly assigned zone code numbers rather than use of area code may also be considered for use as part of location codes. This may create a more stable numbering system that is independent of the telephone system; however, the number system would initially be unfamiliar to the public.

Location codes may be illustrated as separate by dashes or other characters that represent grouping. These dashes are being used for illustrative purposes only. Location codes may, or may not, utilize dashes or other symbols to designate grouping. Many different conventions, other than that illustrated in this application, may be developed or used to designate or distinguish location codes or to create other alternative group designations.

Further, data portioning of a location code can be performed in a variety of ways and formats. For example, location code data structure can be as simple as a text file containing the address or a text file containing different fields, e.g., name, address or intersection, road coordinate, off-road coordinate, type, hours of operation, telephone, email, web site, links etc. In addition, location code data structure may be presented by using any language, including, but not limited to, HTML, XML, C, C++, Java, Java script, flash, SQL etc or any other database structure or language or structured information and may be comprised from any series of characters, as set forth below.

A. Using Part of a Telephone Number

In this example, part of a telephone number is used to construct the corresponding location codes. Take for example the following telephone number:
(123) 555-5555
   that, through a reverse database look-up, is determined to correspond to the following address:
435 Main Street
City, State Zip

Using the telephone information for a specified street address, a location code could be generated that uses the area code from the telephone number and a series of other randomly generated numbers, other identifiers, other correlated identifiers or a combination of any of the foregoing. In one example of one implementation, a location code for the geographic location corresponding to the street address associated with the telephone number may appear as follows, which is comprised of the area code and seven additionally randomly assigned numbers:
Location Code: 123-777-7777

Alternatively, a location code may be generated by using both the area code and telephone prefix. In implementation, the location code can be generated by using the area code, the telephone prefix and other randomly generated numbers, other identifiers, other correlated identifiers or a combination of any of the foregoing. Thus, a location code for the geographic location corresponding to the street address associated with the telephone number, may appear as the following, which is comprised of the area code, the telephone number prefix and four additionally randomly assigned numbers:
Location Code: 123-555-7777

Rather than starting with a particular telephone number, the location code could be generated from the particular address. Using the known address, the telephone information for the particular address could then be obtained through database look-up, such that the starting point for generating the location code is the street address rather than the telephone number. Due to the problems discussed above with using telephone numbers, it may be more desirable to start with a particular address and determine the telephone number associated with the addresses if using both the telephone number and the street address to generate the location code. This is especially true if all that is being used from the telephone number to generate the location code is the area code. Even if the telephone number is incorrect, it is likely that the area code of the telephone number is accurate. However, since cellular telephone numbers may be associated with addresses located in areas having different area codes than that of the cellular telephone, this may not always be true. Thus, when only using the area code associated with a given street address, it may be desirable to determine the area code for the given geographic location using an area code database rather then a telephone directory database.

For example, the Numbering Plan Area (“NPA”) database depicts area code boundaries across the United States. Companies like Geographic Data Technology provide Area Code database, which is continually updated to keep track of ongoing changes in area codes. For example, FIG. 3 depicts current area codes in California. Using the NPA database and cross referencing it with the addresses in each individual area code, it is possible determine the area code within which a given address falls. From this, the area codes for a given address may be determined for use in generating location codes for a given geographic location.

As previously discussed, location codes may be generated by using the area code, and other randomly generated numbers, other identifiers, other correlated identifiers or a combination of any of the foregoing. In areas which have overlapping area codes, either area code may be used as the prefix. The other randomly generated numbers can be assigned such that locations that are physically close in proximity to one another have numerically close numbers. This can be accomplished by dividing the area bounded by the area code into smaller areas. For example, an area may be divided into ten smaller areas such that each smaller area is assigned a number 0-9 corresponding to the most significant digit of location code right after the area code. In turn each subdivided area may be subsequently divided into smaller areas and assigned numeric identifiers. The size of subdivisions at each step may or may not be equal. The areas with higher densities may be smaller.

The area code for an area changes when the demand for new lines exceeds the number of available telephone lines. When a telephone company decides to change the numbering structure of telephone numbers, the location code could either stay the same, be modified to follow similar structure or multiple location codes may be assigned.

B. Using Correlated Identifiers with Pre-Existing Geographic Identifiers

In yet another example of one implementation, part of a telephone number and part of another geographic identifier, such as the house number, zip code, or etc., may be used to construct the corresponding location codes. Take for example the following telephone number:
(123) 555-5555
   associated with the following address:
45000 Main Street
City, State Zip

Using the telephone information for the specified street address, a location code could be generated that uses the area code from the telephone number, the house number from the street address and a series of other randomly generated numbers, other identifiers, other correlated identifiers or a combination of any of the foregoing. Thus, a location code for the geographic location using the area code and house number may appear as the following, which is comprised of the area code, five numbers representative of the house number and four additionally randomly assigned numbers that, for example, could represent a number assigned to represent the corresponding street name of the street address:
Location Code: 123-45000-7654

In the case where the house number for the street address is fewer digits than 5 digits, zeros may be added to maintain the number of digits in the location code. Take, for example, the following telephone number:
(123) 555-5555
   associated with the following address:
721 Main Street
City, State Zip

Then, the location code for the geographic location using the area code and house number may appear as the following, which is comprised of the area code, five numbers representative of the house number and four additionally randomly assigned numbers:
Location Code: 123-00721-7654

In the above examples, the first three characters represent the area code, the next five characters represent the house number for the street address and the last four digits may represent a number assigned to represent the street. Thus, in this implementation example of one implementation, Main Street is represented by the numeric value 7654.

One advantage of using a location code derived from the area code, the house number and number representative of the street number is that the area code and house number are known identifiers that may make the location code easier to remember than randomly generated identifiers. Essentially, those inhabiting the geographic location for a given location code may only need to remember the last 4 digits of the location code; however, the user needs to remember the entire twelve digit location code.

Alternatively, the location code can be derived from the area code, the five digit zip code and random numbers associated with the street address of the geographic location. Take, for example, the following telephone number:
(123) 555-5555
   associated with the following address:
45000 Main Street
City, State 90210

Then, the location code for the geographic location using the area code, the zip code and five numbers representative of the street address may appear as followings:
Location Code: 123-90210-76543

Alternatively, the location code may comprise only the zip code and the series of random numbers representative of the street address, in which case the location code may appear as follows:
Location Code: 90210-76543

As demonstrated below, it is also possible to generate location codes through the use of zip codes alone.

C. Use of Zip Codes

In another example of one implementation, for locations in the U.S., zip codes may be used as all or part of a location code. By way of example, given the following address:
45000 Main Street, Suite 1235
City, State 90210

the associated 19 digit zip code can be determined and used as the location code for the above location. As such, the location code may appear similar to the following, which is representative of a 19 digit zip code that may be associated with the given address:
Location Code: 90210-987654-32109876
Similarly, the associated 11 digit zip code (ZIP+6) may be used as the location code; in this case, however, the suite number of the above address would not be included. A location code generated from the 11 digit zip code may appear as follows:
Location Code: 90210-987654

Alternatively, as a compromise between number of digits and having an exact address, the suite number can be added to the end of the 11 digit ZIP+6 number. In this case, the location code would appear similar to the following:
Location Code: 90210-987654-1235

In this case most of the location codes will consist of the II digit zip code (ZIP+6) except locations with multi-unit structures. Thus, even if the #90210-987654 is entered without the suite number, the navigation system will be directed to the building. The advantage of having the suite number at the end of the number is ease of use. For example, when creating a directory in a cell phone, in addition to name and telephone numbers, the address can be entered as one sequence of numbers. There is no need to add the suite number as a separate entry. Since some suite or unit numbers include letters in addition to, or in the place of numbers, it may be desirable to translate the suite or unit designation into numbers and/or symbols for easy of entry on the keypad. Various methods may be used to translate letters to numbers and symbols.

D. Use of Property Identification Numbers

In yet another example of one implementation, all or a portion of a location code may be generated from property identification numbers, such as the property identifier assigned to a particular piece of real estate for tax purposes. By way of example, given the following address,
45000 Main Street, Suite 1235
City, State 90210
   the property identifier for tax purposes could be determine and use for the location code. In this regard, the location code for this property may appear as follows, which is representative of the property identifier for this address:
Location Code: 123-4567-890-123

Property identifiers for real estate tax purposes represent only one type of known property identifier. Any unique series of characters utilized by any person or entity may be used as a basis for generating all or part of a location code.

E. Use of Location Coordinates

In yet another example of one implementation, all or a portion of a location code may be generated from coordinate designations of a national or global coordinate system. One popular coordinate system of which is the global coordinate system that represents position in terms degrees, followed by minutes and then seconds for both latitude and longitude, e.g., N61° 11′ 0.924″ W130° 30′1.660″. For a geographic location designated by this example coordinate designation, the location code could be generated as follows, which is representative of its coordinate designation:
Location Code: N061110924W130301660

Although not necessary, filler characters may be added to make the sequence equal-length. For example, as illustrated above, a zero or other character may be added before the “61” to represent that the coordinate degrees may include up to three characters. To ease the entry of this location code into a numeric key pad, the letters may be replaced by numbers or symbols. For example, N(north)=6, S(south)=7, W(West)=9, E(East)=3, which are the corresponding numbers to N, S, W and E respectively on a key pad. Other numbers, characters or symbols may be used to replace N, S, E and W to make it simpler to input to a limited keyboard. Using the example replacement N (north)=6, S (south)=7, W (West)=9, E (East)=3, the above location code could also be recited as follows:
Location Code: 60611109249130301660

Another example of a known coordinate system that may be used as a basis for generating location code is the Universal Transverse Mercator (“UTM”) system. The UTM system represents position in the following format type: 10 S 0559741 4282182, in which 10 S identifies a particular geographic zone. Using the UTM system for designating position as a basis for deriving location code, a location code could be represented as follows:
Location Code: 10S-0559741-4282182

Again, to ease the entry of a location code using this format into a numeric key pad, the letters may be replaced by numbers or symbols. Unlike the global coordinate system, the UTM system utilizes all the letters of the alphabet. By way of example only, a system may be used for translating the letters into numbers so that a purely a numeric location code character sequence could be derived. One method for translating the letters to numbers may be to replace letters A through Z by numbers 1 through 26, respectively. In this manner, the location code 10S-0559741-4282182 would be translated into the following code for use:
Location Code: 1019-0559741-4282182

The above examples only represent two known types of coordinate systems that may be used to form part or all of a location code. As suggested above, location codes may be derived directly or indirectly from the geographic coordinate representative of a given location. Although the above examples derive location code using all of the geographic coordinate identifiers, the location code could be derived using only part or the coordinate system or by using all or part of the coordinate system in conjunction with other letters, numbers or symbols.

F. Using Zone Identifiers

As suggest above, location codes may be constructed, at least partially, through the use of character identifiers representative of different geographic zones. These zone identifiers may be previously assigned identifiers or may be constructed by assigning unique character identifiers to predetermined geographic zones. Any area, such as the world, country, state, county, city, or other current or further defined zone can be characterized as a predetermined geographic zone and can be divided into smaller zones. These zones can be geographically based, equal segments, density based, randomly generated or divided by any method for segmenting the area. Each zone may be divided into smaller zones, if desired. Provided below are a few examples of how location codes may be constructed using zone identifiers.

In one example of another implementation, location codes may be generated by dividing the world into countries. Each country can be further divided into states. The states can be further divided into cities. The cities can be further divided into smaller regions and a unique series of characters can be assigned to each separate identifiable geographic location within that region. In this manner, a location code may be represented as follows:
Location Code: USA-CA-LA-5-927-3634

In the above example, the country zone geographic based division (i.e., Zone-L1) is the United States of America. The state geographic based division (i.e., Zone-L2) is California. The city geographic based division (i.e., Zone-L3) is Los Angeles. The “5” and “927” represent smaller zones or regions within the city, here LA, geographic based division (i.e., Zone-L4=5 and Zone-L5=927 may represent density based divisions). The character series “3634” is representative of a unique identifiable location within the zone defined by the character series “927.”

While the above example uses commonly known abbreviations to represent certain zone, these abbreviations may be represented by numbers or other characters assigned to represent the zone. For example, the United States of America may be represented by the number 100, California may be represented by the number 47 and Los Angeles, Calif. may be represented by the number 89. Thus, the above location code may also be represented by a series a numbers. Using these example zone assignments for the USA, LA and CA, the location code would appear as follows:
Location Code: 100-47-89-5-927-3634

Zone divisions other than, or in addition to country, state and city, may be utilized to generate location codes. For example, county zone restrictions may be used. Using the above example, a county zone identifier may also be provided. For example, if Los Angeles County is represented by the number 55, a location code that includes a county zone may appear as follows:
Location Code: 100-47-55-89-5-927-3634

Location codes generated using the zone restrictions described above may operate as global location codes. In this regard, in one example, when a navigation system is restricted to provide location, routing or mapping information only within a certain zone, such as within a state, the first two zone identifiers of the global location code may be omitted. For example, if the navigation system is restricted to searching for information only in California, the above location code may be entered into the navigation system as follows, omitting the first two zone identifiers representative of country and state:
Location Code: 55-89-5-927-3634

In this example, when the navigation is restricted to searching in a specified zone, the system will assume that the entered code is preceded by the zone identifiers for the country and state to which the system is restricted to searching. Using the above example, when a system is restricted to searching only in California, the system assumes that any location code entered into the system is preceded by 100-47, which, in this example, are the assigned identifiers for the USA and California.

Further, it is not necessary that each country be subdivided by state or other commonly recognized zone. Each country may be subdivided into smaller zones based upon density, equal segments, randomly generated divisions or by any other method for segmenting an area. Each subdivision used to generate location codes may use the same method for subdividing the zone (e.g., all the zones are density based zones) or may use different methods for dividing all or a portion of the zones. By way of example, a location code may divide the world into countries (i.e. Zone-L1). Each country may be divided into density based zones (i.e. Zone-L2). Each density based zone may be divided into equal smaller zones (i.e. Zone-L3) such that each segment within Zone-L2 is approximate of equal size. Entities within Zone-L3 may then be assigned a series of characters to uniquely identify each entity within Zone-L3. The assignment of this series of characters can be randomly generated, may follow a certain pattern, for example by assigning numerically close numbers to locations in close physical proximity, or may be represented or correlated to a geographic identifier.

Zone based location codes may further be derived by continuing to subdivide each zone, such that each subdivided area is divided to smaller areas. For example, such subdivision may continue to divide zones until each street is assigned a number and each house or entity located on a street is given a separate identifier. In this manner, individual entity located on a given street may even be subdivided, for example, to include suite numbers.

As evidenced above by the various implementations, location codes may be generated in a variety of manners using zone restrictions. Generation of location codes using zone restrictions should not be limited to the above examples. Further, location codes may be generated either entirely or only in a part from zone restrictions. It should not be inferred from the above examples that location codes using zone restrictions must be constructed entirely through zone identifiers.

G. Location Code Using Limited Alphanumeric Characters or Pseudo Alphabetic Characters

While the above examples may favor the use of numbers in the generation of location codes, it is not necessary that location codes be generated entirely of numbers. Location codes may be generated from using characters, letters, symbols or numbers, or any combination thereof. Location codes may be constructed using characters, letters, symbols, numbers or any combination thereof that relatively easy to enter into a navigation system. By way of example, the number of characters used in a location code may be limited to ease entry of the location code into a navigation system. Alternatively, the field of available characters for use in generating location codes may also be restricted. For example, the location code can be limited to using only the numbers (e.g., 0-9), a couple of symbols (e.g., #,*) and/or a subset of letter (e.g., A, B, C, D). The following are a few examples of location codes that can be derived using a combination of numbers, symbols and/or letters, as proposed to be restricted by this example:
Location Code: #A921-B8765
Location Code: 2C990*AB12

In this example of one implementation, even though the set of characters that may be used to generate the location codes is restricted, it is evident that a number of possible unique location codes may be generated even from a restricted subset of characters. In this example, no restriction has been placed on the ordering or arrangement of the characters. Such restrictions may however be used to generate location codes. Further, it is not necessary that the location codes be generated using letter, numbers and systems. Rather, the location codes may be generated using only two different types of characters. Subjective, objective or a combination of subjective and objective based restrictions on the number of characters in the series comprising a location code may also be placed on the generation of location codes. Thus, combinations and/or restrictions other than those provided by way of example above may be placed on the generation of location codes.

Location codes can further be generated by interchanging or translating certain characters in a series with characters designated to represent the character for which is replacing. For purposes of this application, these interchangeable or representative characters shall be referred to pseudo alphabetic characters. In this manner, in one example implementation, the term pseudo alphabetic can be defined as alphabetic characters that deterministically translate to a number or symbol on a keyboard (e.g. on a regular telephone keyboard pseudo alphabetic characters A, B, C deterministically translate to number “2”). Pseudo alphabetic character may also be defined when two or more characters are always interchangeable (e.g. two letters A and B share the same key and A0009123 is equivalent to B0009123). Using pseudo alphabetic characters, geographic identifiers or other series of characters can be modified for use as location codes.

### IX. Location Code Applications

Location codes may be used in connection with any application requiring the unique designation of geographic locations. Such applications include, but are not limited to, navigation systems in the form of mapping and routing software programs. These navigation systems are often incorporated into or used in connection with the operation of cars and other objects capable of moving across land or through air or water. Navigation systems may also be integrated into cell phones, personal digital assistants (“PDA”) and other devices. Such devices may be designed for the sole purpose of functioning as a navigation system or may incorporate the navigation system as an additional feature of the device. Further, navigation systems may be provided to users on-line, typically in the form of mapping programs, or as standalone mapping or routing software programs designed for use on a personal computer or other processing device.

Navigation system may operate as a stand-alone system or may communicate over a network to other computers to obtain information in “real time” or off-line, to receive database updates or to shift processing or calculation of desired routing information to a system having capacity to perform such functions. When receiving or transmitting information over a network, one computer or device in the system, typically the one that interfaces with the user, may be referred to as a “client” and the other device in communication with the client shall be referred to as a “server” or “base station.” The client may be in communication with the server over various types of networks, such as the Internet, a mobile network, a local area network, a private network, a wireless network or other networks or interfaces for transmitting, receiving and/or sharing information.

By providing a navigation system capable of communicating over a network to a server or other similar system, the operation of the navigation system may be enhanced. By way of example, by having access to real time data, a navigation system may be able to receive information regarding current traffic conditions which can be beneficial for calculating the route between point A and point B with the best traffic conditions.

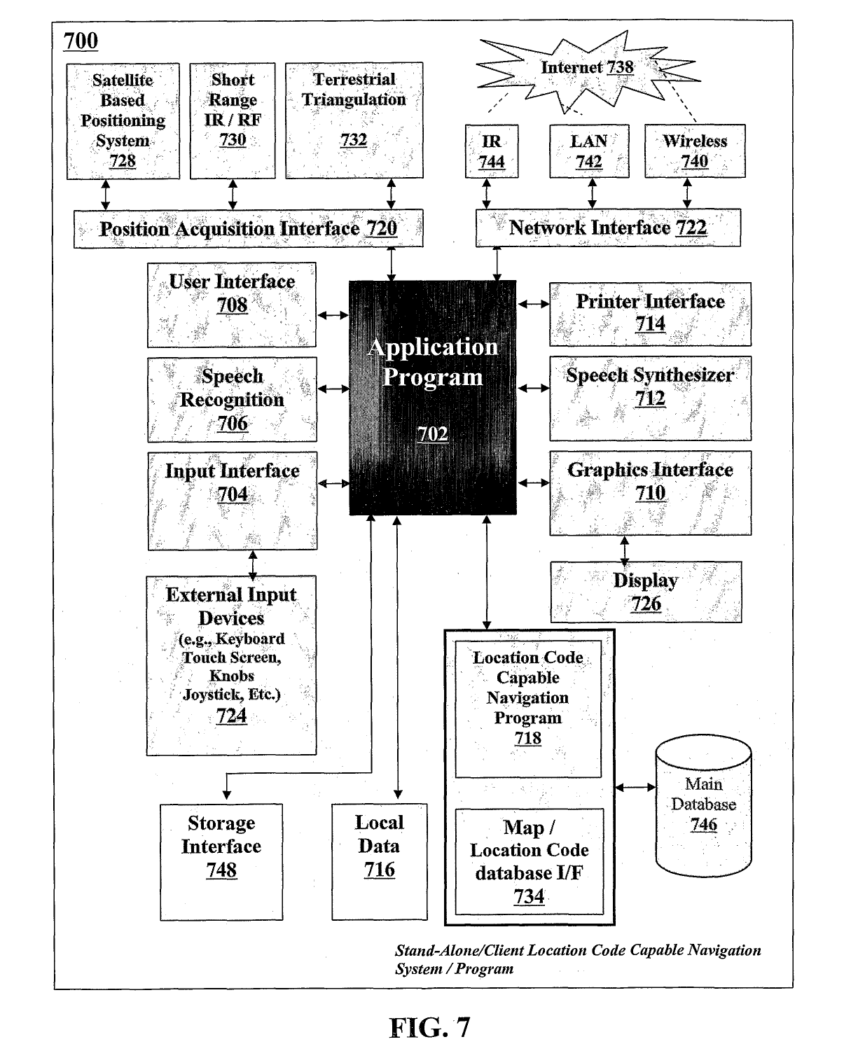

FIG. 7 illustrates one example of one implementation of a location code capable navigation system 700 that may operate as a stand-alone system or may act as a client and interfacing with a server over a network. As illustrated by FIG. 7, the navigation system may include the following modules: (i) Application Program Module 702; (ii) Input Interface Module 704; (iii) Speech Recognition Module 706; (iv) User Interface Module 708; (v) Graphics Interface Module 710; (vi) Speech Synthesizer Module 712; (vii) Printer Interface Module 714; (viii) Local Data Module 716 (ix) Navigation Program 718; (x) Position Acquisition Interface Module 720; and (xi) Network Interface Module 722. As will be explained further below, these modules may be designed to be in communication, directly or indirectly, with any of the following, among others: (i) external input device 724, (ii) display 726, (iii) satellite based positioning system 728, (iv) short range IR/RF 730, (v) terrestrial triangulation 732; (vi) Infrared (“IR”) transceiver 744; (vii) local area network (“LAN”) 742, (viii) wireless network 740, (ix) Internet 738 or wide area network, (x) map/location code database interface 734 and/or (xi) main database 746 which can be in a form including but not limited to electronic, optical, solid-state, networked, tangible etc and (xii) storage interface module 748.

As illustrated in FIG. 7, the Application Program Module 702 is responsible for coordinating and controlling the transfer of information between the various modules, for processing the data received from the modules and for performing other system administration functions. Further, the Application Program Module 702 may be responsible for interfacing with an underlying operating system and required drivers or may itself function as an operating system for the navigation system.

The Input Interface Module 704 senses and relays information about external input devices 724 keyboard, touch screen, knobs, joystick, touch pads, etc to the Application Program Module 702. The input interface module may interface with any device that enables the user to input data. The Application Program Module 702 interprets this information and passes the result to the User Interface Module 708 and/or Graphics Interface Module 710 which renders the display 726. The User Interface Module 708 interacts with the user and communicates and controls the system through the Application Program Module 702.

The Speech Recognition Module 706 recognizes the user's vocal commands, data input, questions, etc and passes this information in a structured manner to the Application Program Module 702. The Application Program Module 702 in turn processes this information and passes it to the User Interface Module 708 or the Graphics Interface 710. Similarly, the Speech Synthesizer Module 712 turns text to speech and generates various sounds. The Printer Interface Module 714 allows for printing of information provided or displayed by the navigation system 700. Although not shown, they system may communicate with the user tactilely through touch.

The Local Data Module 716 is responsible for managing local data information including but not limited to contact information, favorite places, history, points of interest. Contact information created or stored elsewhere such as on a personal computer, personal digital assistant, cell phone or other device can be downloaded and/or synchronized into local data module 716. This information, when it includes location codes for specific contact, can be used by the User Interface Module 708 and Navigation Program Module 718 to display and/or calculate routing information based upon location codes. Examples of popular contact management software that may be used in connection with the navigation system include, but are not limited to, Microsoft Outlook. Storage interface module 748 may interface with any data retrieval system such as optical disc reader, memory reader or any other medium capable of retaining data or any device capable of obtaining and storing data. This interface may be used to update program and data including that of the database.

The Position Acquisition Interface Module (“PAIM”) 720 is responsible for locating the approximate position of the user. When the navigation system requires the user to enter both the origination and destinations information, the PAIM 720 is not required. There are numerous techniques to determine the location or position of the navigation system, absent user input, all of which, for purposes of this application, shall be referred to as a GPS function. For example, the PAIM 720 may interface with any of the following satellite based positioning systems 728 to determine approximate position of the user or mobile navigation system:
U.S. Global Positioning System (NAVSTAR)
Russian GLONASS
European Union Calileo
Japan GPS augmentation system (QZSS)

Alternatively, short range RF/IR transmitters 730 may also be used to determine position of the navigation system. The short range RF/IR transmitters transmit code received by the navigation system that indicates the position of the transmitter. By receiving several signals of this type, the navigation system may determine the approximate location of the receiver. Terrestrial based triangulation techniques 732 such as the one used to locate cell phones using time of arrival from/to two or more base stations may also be used to determine location of the mobile device or user.

The Location Code Capable Navigation Program 718 is in charge of navigating as well as interfacing/updating/synchronizing a map/location code database 734 as well as communication with the server via the Network Interface 722, when available. This interface may enable the system to receive data from a remote system, send data to a remote system, exchange data with a remote system etc. The Location Code Capable Navigation Program 718 may receive commands from the Application Program Module 702. The Location Code Capable Navigation Program 718 and map/location code database I/F 734 may be available locally, as illustrated in FIG. 7. When available locally, all the navigation functions may be performed without the necessity of interfacing with a server, except as necessary and desirable to obtain updates, if a network interface in available. Thus, geographic identifiers or other data associated with a location code may be obtained by the Location Code Capable Navigation Program 718 from the Main Database 746 via the Map/Location Database I/F 734. Any results calculated or processed by the Location Code Capable Navigation Program 718 may be forwarded to the Application Program Module 702 for display to the user. Where the Location Code Capable Navigation Program 718 is not available locally, the request/command for navigation information may be forwarded to the server for processing via the Network Interface 722, which may provide access to the Internet 738 or to a remote server via a wireless network 740, a local area network, wide area network, modem or other wired network communication method 742 or an IR Transceiver 744.

Depending upon the application, not all of the modules displayed in FIG. 7 and described above will be necessary, required or available for implementation into a navigation system in a commercially reasonable manner. For example, in general, in-car navigation systems do not include Printer Interface Modules 714. This is not, however, to say that a Printer Interface Module 714 can not be included in an in-car navigation system. As further described above, the navigation system 700 may operate in a stand-alone mode, in which case it may not include networking capabilities, or if networking capabilities exist, it may only be used to update the local database 734.

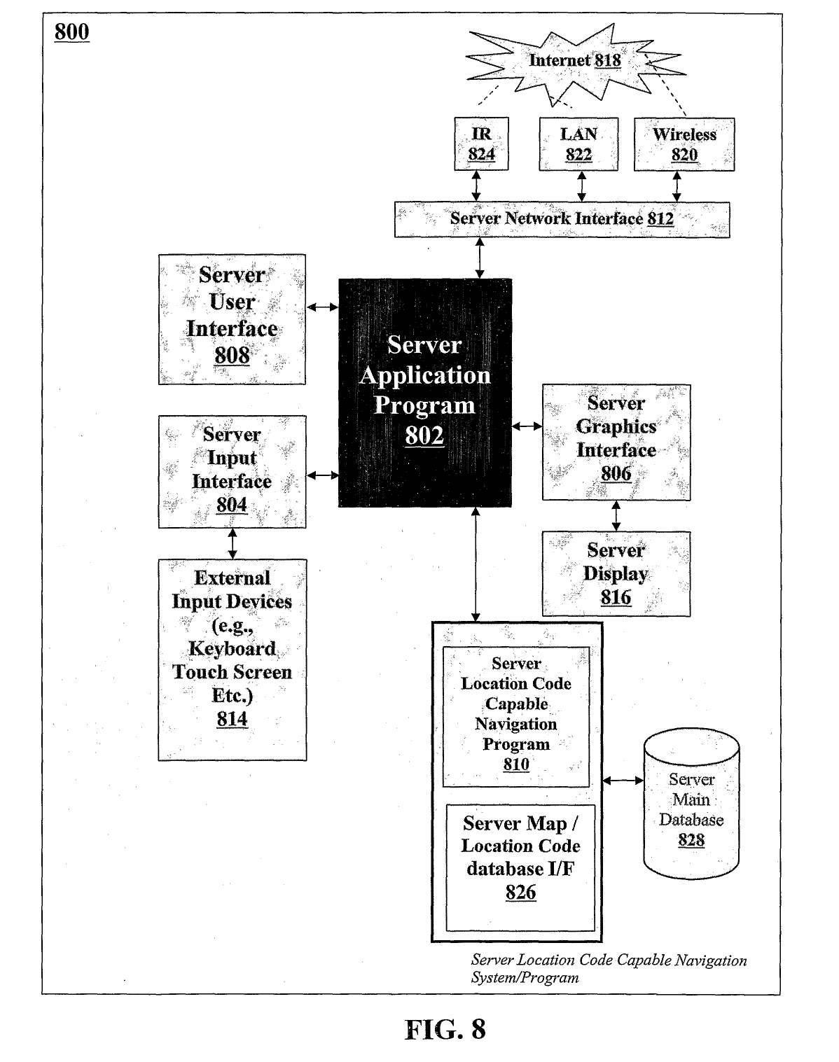

FIG. 8 illustrates one example of one implementation of a server 800 capable of interfacing with a client 700 over a network to provide a location code capable navigation system. In this example, the server 800, like the client 700, may include the following modules: (i) Server Application Program Module 802; (ii) Server Input Interface Module 804; (iii) Server Graphics Interface Module 806; (iv) Server User Interface Module 808; (v) Server Location Code Capable Navigation Program 810; and (vi) Server Network Interface 812. As will be explained further below, these modules may be designed to be in communication, directly or indirectly, with any of the following, among others: (i) external input device 814, (ii) display 816, (iii) Infrared (“IR”) transceiver 824; (vii) local area network (“LAN”) 822, (viii) wireless network 820, (ix) Internet 818 or wide area network, (x) map/location code database interface 826 and/or (xi) main application database 826.

The Server Application Program Module 802 is responsible for coordinating and controlling the transfer of information between the various modules, for processing the data received from the modules and for performing other system administration functions. Further, the Server Application Program Module 802 may be responsible for interfacing with an underlying operating system and required drivers or may itself function as an operating system for the server side of the navigation system.

The Server Input Interface Module 804 senses and relays information about external input devices 814, such as keyboard, touch screen, knobs, joystick, touch pads, etc to the Server Application Program Module 804. Server Application Program Module 702 interprets this information and passes the result to the User Interface Module 808. Server Graphics Interface Module 806 renders the display 816.

The Server User Interface Module 808 interacts with the user and communicates and controls the system through the Server Application Module 802. The Server Local Code Capable Navigation Program 810 is in charge of providing navigation and remote application support to the clients as well as interfacing/updating/synchronizing the data in the map/location code database 826 local to the client. The Server Location Code Capable Navigation Program 810 receives commands from the Server Application Program Module 802, interfaces with the map/location code database 826, as necessary, to process the request. After execution of the command, the result is returned to the Server Application Program Module 802. The Server Application Program Module 802 in turn sends the result to the corresponding client or uses the information internally, as necessary.

A server 800 of the type described may communicate with one or with many clients simultaneously via the Network Interface Module 812, which, like the client 700, which may provide access to the Internet 818 or to a remote client via a wireless network 820, a local area network, wide area network, modem or other wired network communication method 822 or an IR Transceiver 824.

Further, the Server Location Code Capable Navigation Program 810 can run navigation and application programs, such as routing programs, on behalf of clients 700. If the information gathered from the Server Navigation Program 810 is too large for the client 700 to handle, the server 800 may transfer the data to the client 700 in smaller data segments of a size manageable by the client 700.

Regardless of whether the operation of the navigation system is performed entirely by a single device or computer or by the interface of a client/server, the operation may be transparent to the user. While using a client/server may increase functionality of the navigation system by providing “real time” data, the general basic functions of providing routing information may be present in either or both systems. FIG. 7 and FIG. 8 collectively illustrate one example of one implementation of a location code capable client and server navigation system. Those skilled in the art will recognize that it may not be desirable or necessary to design a system having all of the system components illustrated in FIGS. 7 and 8. Many alternative implementations of location code capable navigation system, including, but not limited to, standalone/client and server designs are possible and are within the scope of this invention. Accordingly, the invention is not to be restricted by the described implementations. Rather, any client 700 and/or server 800 systems that are capable of interfacing with one another to provide a location code capable navigation system may be utilized. Such systems may excludes certain components, includes additional components, combines two or more illustrated components into one component or replace certain components with others. Any operation described as being performed by a single system may be performed by multiple systems. A location code capable client/server navigation need not consist of only one client and one server, several system may together comprise the client. Likewise, several system may together comprise the server.

Further, a location code capable client/server navigation may be designed such that the client may allow the server to access any of the client modules, including, but not limited to, the main database 746, the position acquisition interface 720, the user interface 708, the external input devices 724, the display 726, the navigation program 718 and/or the map/location code database I/F 734. Similarly, the server may allow the client to access any of the server modules, including, but not limited to, the server application program 802, the server database 828, the input interface 804, the server display 816, the server graphics interface 806 and/or the external input devices 814. Provided below are several examples of how a location code capable navigation client/server system may exchange information and process data. The operation of the location code capable navigation client/server system is not limited to the provided examples. Any operation of function of a location code capable navigation system, whether or not described in this application, may be performed entirely by the client, entirely by the server or both the server and the client depending upon system design.

Examples of a few basic functions that may be performed by a navigation system using location codes are as follows: (i) identifying location code with particular geographic location using a cross-reference database; (ii) identifying location code with a particular geographic location using algorithm; (iii) translating GPS coordinate into a location code; (iv) finding nearest location for a group of locations associated with a single location code; (v) identifying location codes having suite designations with geographic location using cross-reference database; (vi) calculating routing information based upon entry of location codes for originating and destination locations; (vii) calculating routing information based upon entry of location codes for destination locations and (viii) providing and modifying metadata associated with the location codes.

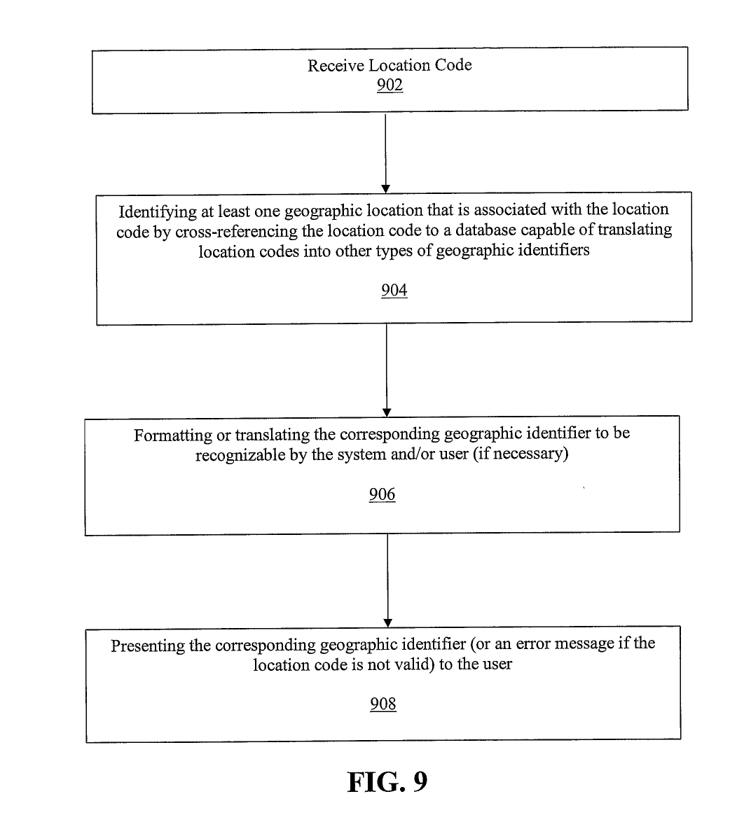

FIG. 9 illustrates a flow diagram of one example of one implementation of how a navigation system may identify a location code with particular geographic location using a cross-reference database. As seen in FIG. 9, the system receives the location code 902 which is in the form of a series of characters that is associated with at least one unique geographic location. For purposes of this application, a “geographic location” or a “unique geographic location” shall mean any identifiable location or structure, whether identifiable as real estate, commercial property, residential property, points of interest, houses, businesses, particular types of structures, coordinates or otherwise. Next, the system identifies at least one geographic location that is associated with the location code 904 by cross-referencing the location code to a database capable of translating location codes into other types of geographic identifiers, such as street address and/or GPS coordinates or other data associated with the geographic locations that is identifiable by the navigation system and/or the user as associated with the geographic locations. In this example, the cross-reference database is a compiled database that associates each location code with an address and/or geographic coordinate and allows for the association of the information through a simple look-up process. As will be further illustrated below, more than one geographic identifier may be associated with a single location code.

Once the corresponding geographic identifiers to the location code are obtained from the database, the system may need to formatting or translating the corresponding geographic identifier to be recognizable by the system and/or user 906. For example, if the cross-reference database provides the system with corresponding global coordinates to the location code. The system will need to cross-reference those coordinates to a street address for presentation to the user. Alternatively, if the database provides a street address as a corresponding geographic identifier, the system may need to translate that into global coordinates before it can calculate routing information for the user. In this manner, the information taken from the cross-reference database may need to be further formatted to perform the desired function or command that the navigation system is being asked to perform. For example, if the command is simply to provide the user with the address that correspondences to the location code. The system formats the corresponding geographic identifier in the form of a street address 906, if necessary, and then presents the address to the user 908, as requested. Alternatively, if no cross-reference to the location code can be found, the system may notify the user that the location code is invalid.

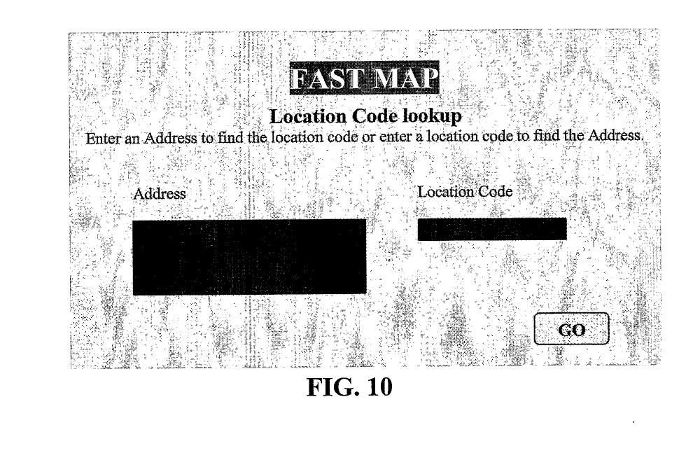

Similarly, the navigation system may also look-up the location code associated with a particular address or geographic location and return the corresponding address to the user. FIG. 10 illustrates an example of one implementation of an input screen that may be used in connection with a navigation system to allow a user to either enter a desired street address and obtain its location code or enter a location code and obtain its street address. Depending upon the entry information, the system may then cross-reference the input information using a look-up database, as described, above and return the corresponding location code or street address, as applicable, to the user. In the event that no corresponding information is found, the system may so notify the user and request the entry of alternative information as further described in connection with FIG. 37 below.

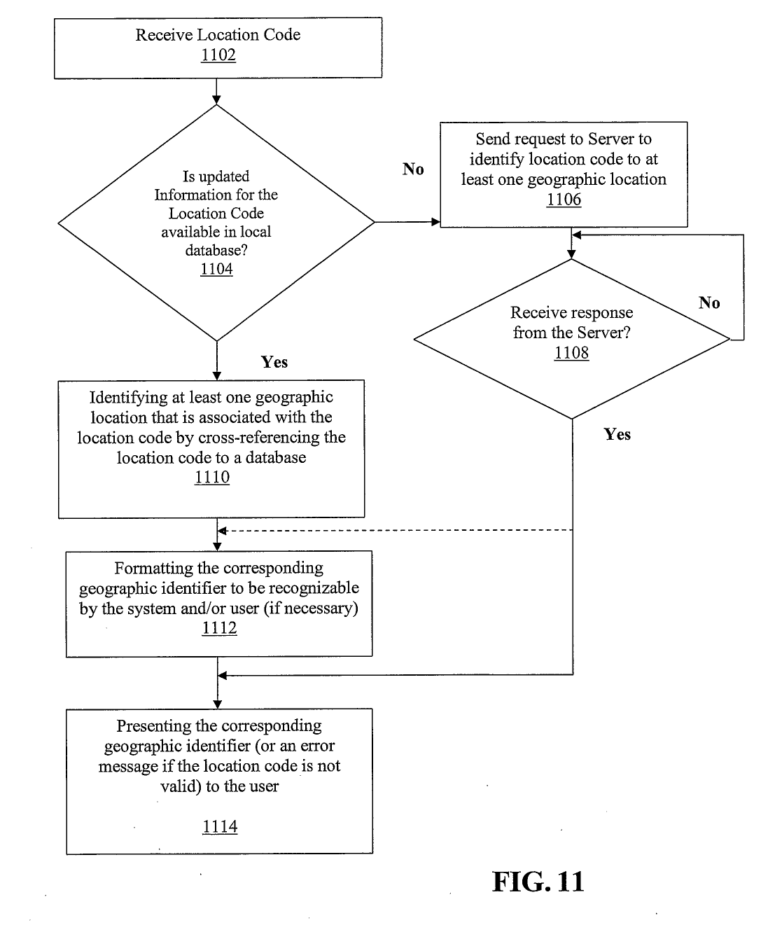

Similarly, FIG. 11 illustrates a flow diagram of another example of an implementation of how location codes may be translated into street addresses or coordinates using a cross-reference database via client/server navigation system. The client first receives the location code 1102. In this example, the client has a local database. Thus, the client may determine whether the information in the database is current with respect to the received location code or whether it contains the necessary information regarding the received location code 1104. If the information is not available locally, or is not updated, the client can pass the request to the server 1106. Alternatively, although not shown, the client can request that the server update the local database before it processes the request of associating the location code with its geographic location.

If the location code received by the user is passed to the server 1106, the server may perform the look-up function, in the same manner described above in FIG. 9, and returns the corresponding geographic identifier(s) back to the client 1108. The corresponding geographic identifier(s) can then be formatted to be recognizable by the system and/or user, as necessary, 1112. The formatted geographic identifier(s) can then be returned to the user 1114. As previously discussed, location codes may be assigned to private or publicly accessible structures, kiosks, drop boxes, etc that do not generally have a postal address assignments. In this manner, the location codes for those geographic locations may be associated, via a cross-reference database with only GPS coordinates, or may be cross-referenced with other additional identifiers to assist the user with verifying that they used the correct location code for the desired location. For example, when the geographic identifier does not have a street address, the nearest intersecting streets, the known name of the location, the shopping area in which it is located, or other similar identifying information may be provided to the user as a geographic identifier to assist the user with verifying that they are obtaining the desired information. Alternatively, if no corresponding geographic identifier can be found, the system may notify the user that the location code is invalid.

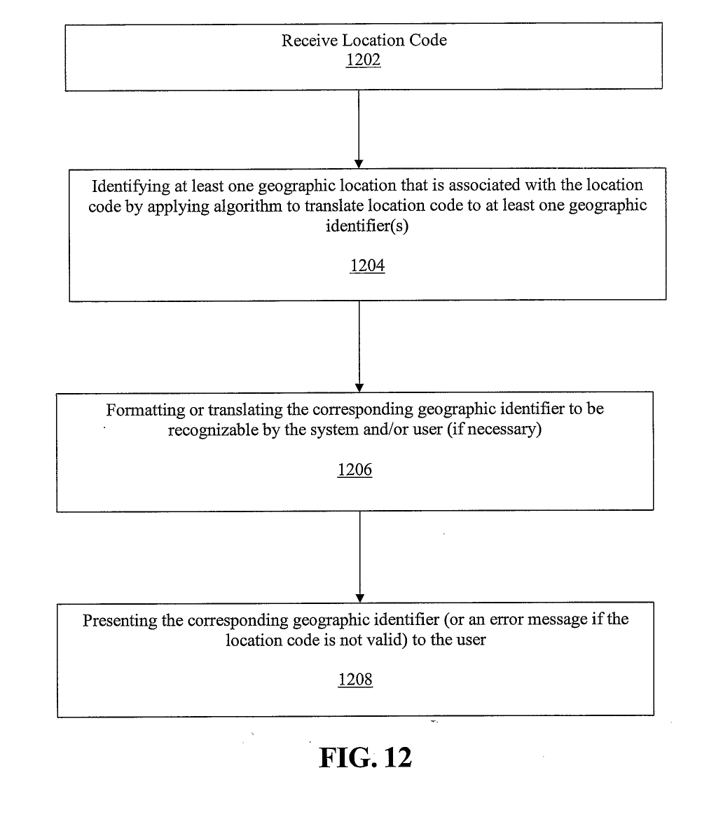

FIG. 12 illustrates a flow diagram of another example of an implementation of how a navigation system may identify a location code with particular geographic location by applying an algorithm. As seen in FIG. 12, the system receives the location code 1202 which is in the form of a series of characters that is associated with at least one unique geographic location. Next, the system identifies at least one geographic location that is associated with the location code 1204 by applying an algorithm to translate location code to at least one geographic identifier(s), such as street address and/or GPS coordinates. For example, if a location code is derived by translating or converting geographically identifying data to correlated identifiers, the method for translating or converting the data need to be applied to convert location codes to street addresses or geographic coordinates and to similarly convert street addresses or geographic coordinates to location codes.

Once the corresponding geographic identifiers to the location code are obtained, the system may need to formatting or translating the corresponding geographic identifier to be recognizable by the system and/or user 1206. For example, if the system obtains corresponding global coordinates to the location code. The system may need to cross-reference those coordinates to a street address for presentation to the user. Alternatively, if the system obtains street address as a corresponding geographic identifier, the system may need to translate that into global coordinates before it can calculate routing information for the user. In this manner, the information may need to be further formatted to perform the desired function or command that the navigation system is being asked to perform. For example, as illustrated in step 1208, if the command is simply a look-up command to provide the user with the address that correspondences to the location code. The system formats the corresponding geographic identifier in the form of a street address 1206, if necessary, and then presents the address to the user 1208, as requested. Alternatively, if no corresponding geographic identifier can be found, the system may notify the user that the location code is invalid.

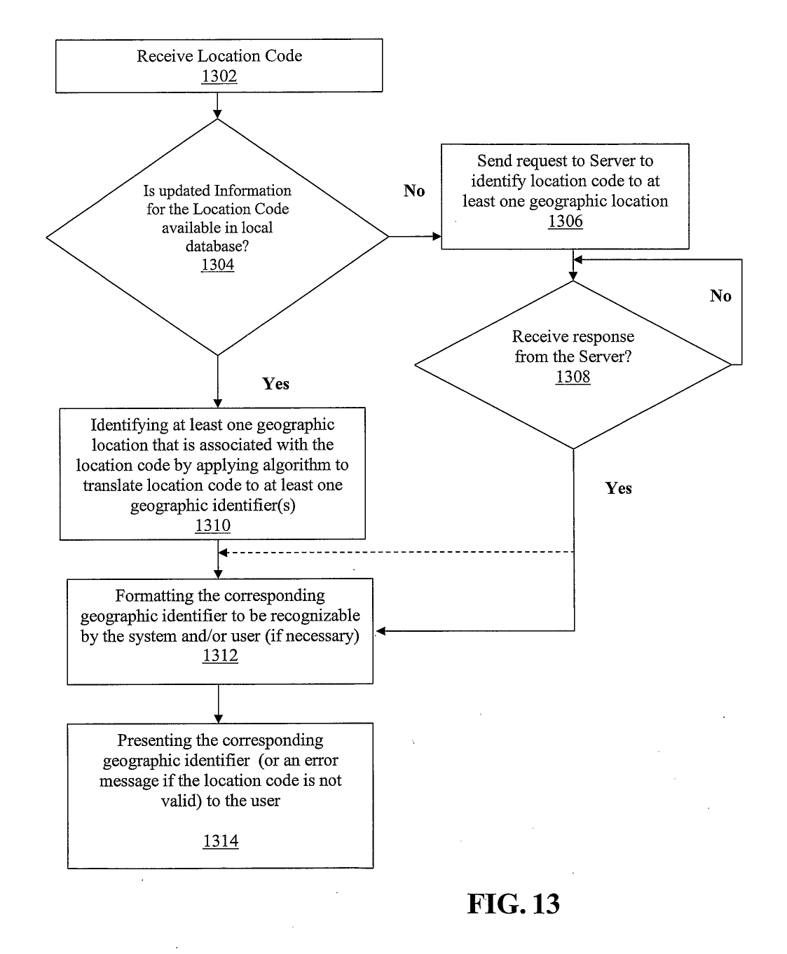

Similarly, FIG. 13 illustrates a flow diagram of another example of an implementation of how location codes may be translated into geographic identifiers using algorithms via client/server navigation system. Rather than have the algorithms applied locally, these databases and algorithms for converting the location code information to addresses and/or geographic coordinates may be accessible over a network for transferring data, such as the Internet, a mobile network, a local area network, a private network, a wireless network or other networks for transmitting and sharing information, as described above and as illustrated in FIGS. 7 & 8.

The client first receives the location code 1302. In this example, the client has a local database. Thus, the client first determines whether the information in the database used to apply the algorithm is current with respect to the received location code or whether it contains the necessary information regarding the received location code 1304. If the information is available locally, the client can apply the algorithm to translate the location code to at least one geographic identifier 1310, format the geographic identifier to be recognizable by the system and/or user, as necessary, 1312. The formatted geographic identifier(s) can then be returned to the user 1314.

If the information is not available locally, or is not updated, the client can pass the request to the server 1306. Alternatively, although not shown, the client can request that the server to update the local database before it processes the request of associating the location code with its geographic location. If the location code received by the user is passed to the server 1306, the server may apply the algorithm, in the same manner described above in FIG. 12, and return the corresponding geographic identifier(s) back to the client 1308. The corresponding geographic identifier(s) can then be formatted to be recognizable by the system and/or user, as necessary, 1312. The formatted geographic identifier(s) can then be returned to the user 1314. Alternatively, if no corresponding geographic identifier can be found, the system may notify the user that the location code is invalid.

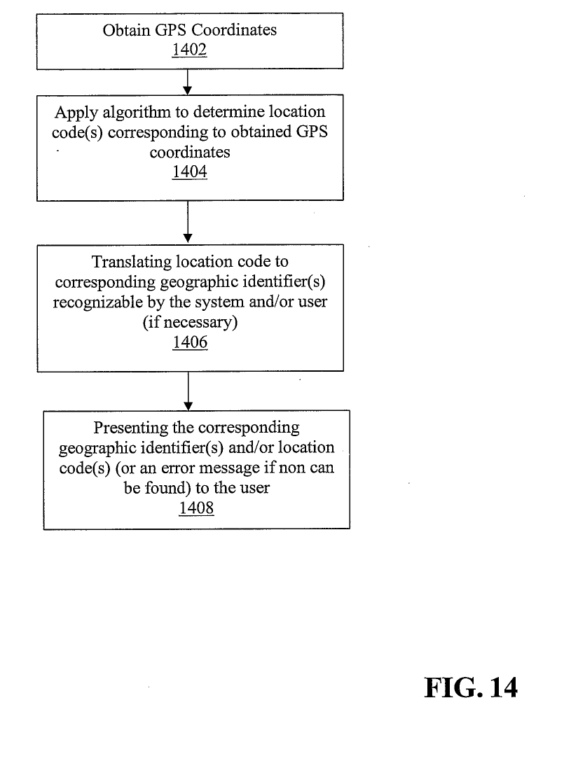

FIG. 14 illustrates a flow diagram of another example of an implementation of how GPS coordinates may be translated into location codes as well as their corresponding geographic identifier, which includes but is not limited to, street addresses, town centers, parking lots, transportation stations, parks, beaches, street intersections, parcel numbers, coordinates, automatic teller machines, drop boxes, kiosks, bus stops, city markets, recycling centers, gas stations, restaurants, real estates, shops, businesses, stores, undeveloped real estate and points of interest, etc using algorithms. In this manner, a GPS in a navigation system may determine the GPS coordinates for the position of the system and the navigation system will be required to determine which location codes near the GPS coordinate is most likely to represent the location code that corresponds to the GPS reading.

As seen in FIG. 14, the system first determines the GPS coordinates of the desired location 1402. Next, the system applies an algorithm 1404 to identify at least one location code that is associated with GPS coordinates. In one example, the applied algorithm may use the GPS coordinate as the center of a circle and search for location codes within a certain radius about the GPS coordinate. If no location code is found within the preset radius, the area of inclusion is increased until at least one candidate is found. As illustrated in FIG. 14, once the algorithm determines the corresponding location code or a number of possible location codes that correspond to the GPS coordinate, the location code(s) information is formatted 1406 (if necessary) before presented to the user 1408. For example, if the system cannot determine which of a number of location codes is associated with GPS coordinate, the system may translate and/or convert the location codes into street addresses, or other geographic identifiers, and ask the user to select which of the particular geographic locations they would like to receiving the associated location code. Alternatively, if no corresponding geographic identifier or location can be found, the system may notify the user.

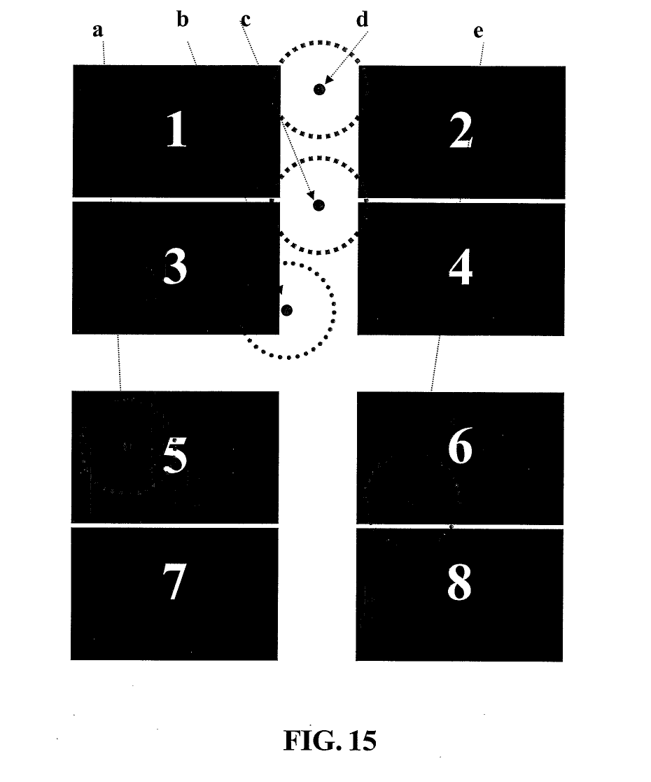

FIG. 15 illustrates one example of one implementation of the application of one sample algorithm that can be applied by the navigation system to identify a location code(s) corresponding to a GPS coordinate. FIG. 15 illustrates a cross-street of eight properties each with distinct location codes. Some commercially available position systems, such as GPS, may have a wide tolerance. Thus, the exact physical location of the device may not be ascertained due to tolerance of the system. However, it can be established through the application of an algorithm that if the GPS coordinates fall inside a circle centered, for example, on point “a” with diameter of the total tolerance, the corresponding location code is the location code for the property #5. If the GPS coordinates is identified as “b”, the reverse location code lock-up algorithm will identify the coordinate as the location code for property #3. Although “b” does not fall completely inside property #3, the area around “b” does not encompass any other entity possessing a location code. If point “c” is the GPS coordinate, the name and address of properties #1, 2, 3 & 4 may be provided to the user to select from. Similarly, if point “d” is the GPS coordinate, the name and address of properties #1 & 2 may be provided to the user to select from. If the coordinate is identified as point “e”, the name and address of properties #6 & 8 may be provided to the user to select from.

Any entity with a location code falling inside the circle may be considered. For example an ATM, which does not have a specific address by itself, will be identified as a separate location code if it falls inside the circle. In case no entity with a location code falls inside the circle, the reverse location lookup algorithm may increase the diameter of the circle till at least one location code is intersected. It is also possible to provide the user with means to expand the search area. Direction of travel can also be used to identify the more probable nearby address.

Additionally, if the street address is a multi-unit structure, the location code that the navigation system originally returns may just belong to the whole structure. To get the location code for a particular unit, the navigation system may prompt the user to enter the desired unit number or may provide a mechanism to the use to alert the navigation system that structure identified by the location code has sub-designations. In which case, the user may be allowed to enter the sub-designation. Upon entry of the sub-designation, the navigation system can use a cross-reference database and/or algorithm to return the exact location code for the sub-unit. Alternatively, the system may return two location codes; one location code that is associated with the sub-unit and one location code that is associated with the geographic location represented by the property containing the sub-unit.

Alternatively, a less computationally intensive reverse location code lookup algorithm may be used that concentrates on detecting if a particular coordinate representing an entity that falls inside the search area. In this example, an entity such as a property is identified by one or series of coordinates (e.g. the front entrance and back entrance coordinates). Finding the distance between the current GPS coordinate to the assigned coordinates of entities with location code in the area and finding the closest ones is simple and does not require extensive computational power.

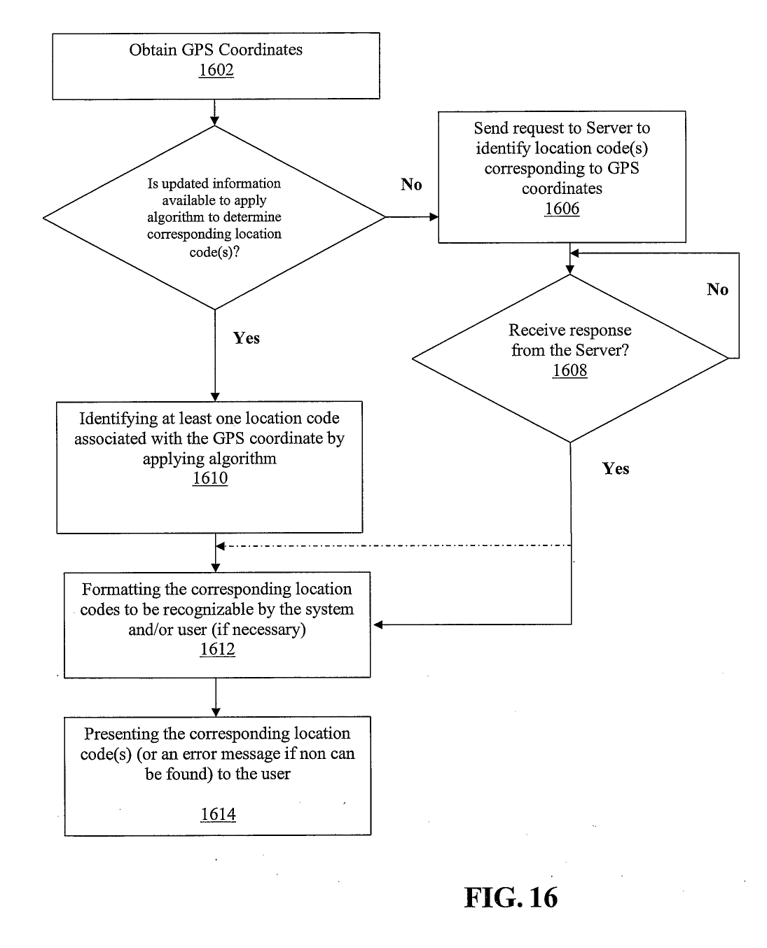

Similarly, FIG. 16 illustrates a flow diagram of an example of an implementation of the application of a reverse location look-up program described above to translate a GPS coordinate into a location code or street address using a client/server navigation system. In this example, the GPS coordinates or street address are obtained by the client 1602. When a local database exists, the client determines whether the information in the local database is current with respect to the received GPS coordinate to determine the corresponding location code 1604. If the information is not available locally, or is not updated, the client can pass the request to the server 1606. The server applies the algorithm or reverse look-up program, as described in FIGS. 14 & 15, and returns the corresponding location code(s) back to the client 1608. As before, the information can be returned in a format recognizable by the user or the client can format the returned information to be recognizable by the user. Alternatively, if no corresponding location code found, the system may notify the user of the error.

If updated information is available locally, the client can apply the algorithm to determine the corresponding location code 1610. Once the algorithm determines the corresponding location code to the GPS coordinate or a number of possible location codes, via client side or server side, the location code information is formatted 1612 (if necessary) and then presented to the user 1614. Alternatively, although not shown, the client can request that the server update the local database before it processes the request of associating the GPS coordinate with a location code.

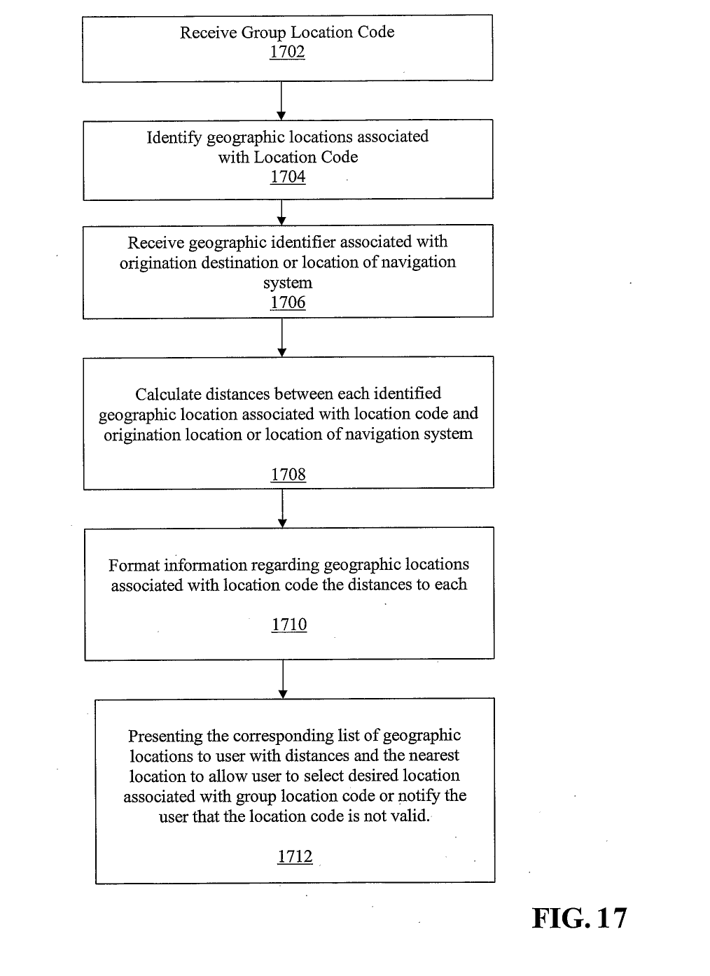

FIG. 17 illustrates a flow diagram of an example of an implementation for finding the nearest location for a group of locations associated with a single group location code. In this example, the navigation system receives a group location code 1702. The system then identifies the group of geographic locations associated with the group location code 1704. This group may be identified through a look-up program associated with a cross-reference database, as discussed above. To determine which of the geographic locations are closest to the navigation system or starting location, the navigation system must receive information regarding the origination designation 1706. The information can be provided through user input or through the use of a GPS unit, if available. It is not necessary that the system identify the group of geographic location associated with the group location code 1704 before it identifies the starting location 1706. One can occur before the other, or they can occur simultaneously.

Once the starting location and all the geographic locations in the group associated with the location code are identified, the system can calculate the distance between the starting location and each geographic location associated with the group location code 1708. One or more of the closest locations associated with the group location code to the starting point, may be formatted for presentation to the user along with their respective distances from the starting position (as necessary) 1710. These locations may then be presented to the user 1712 for review. The user then can select one location and obtain routing information to the location, if desired. Alternatively, if no information can be found that relates to the group location code, the system can notify the user that the group location code is invalid.

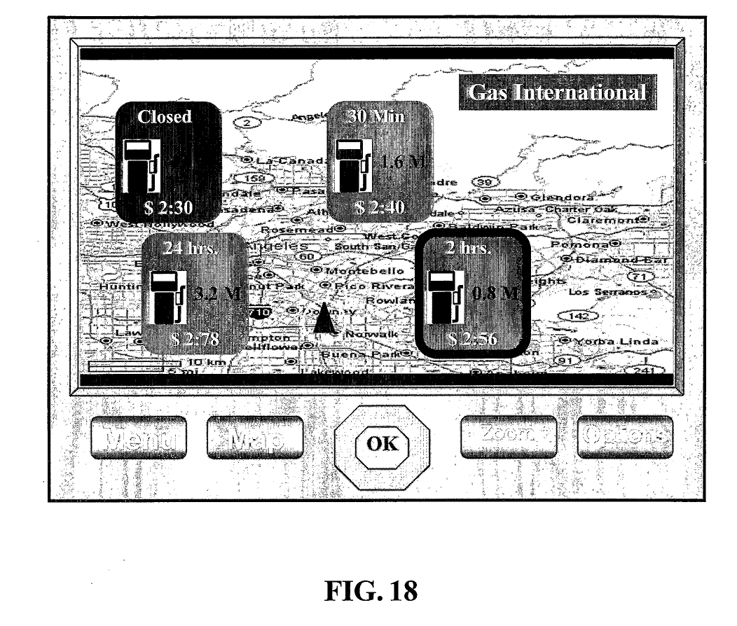

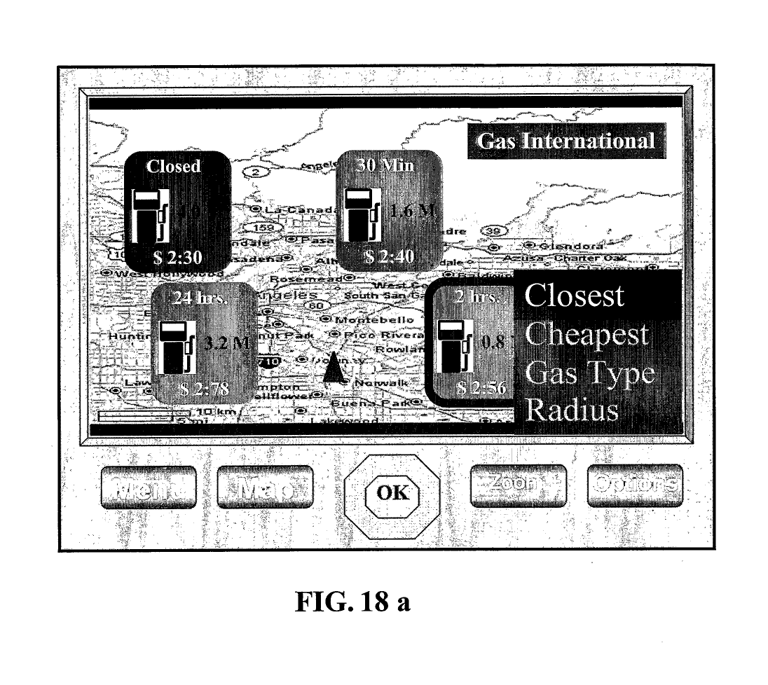

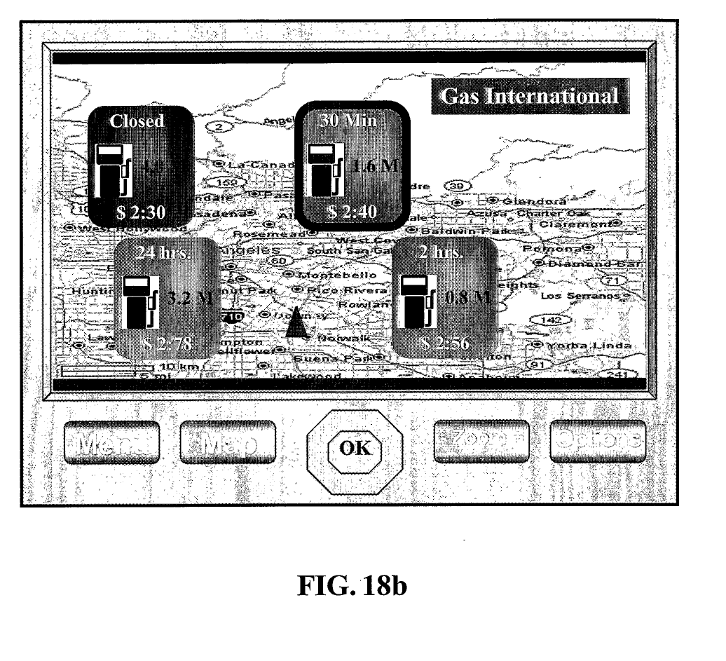

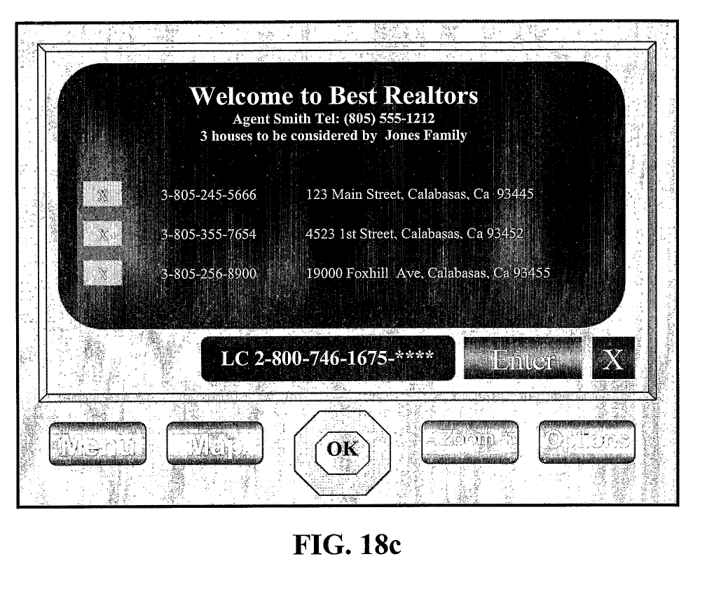

FIG. 18 is an example of one implementation of an output screen that may be presented in response to the entry of a group location code. In this example, the system receives a group location code that corresponds to various gas station locations for a particular named station, i.e., Gas International. As a result, the navigation system identifies all nearby gas station locations associated with the particular named station identified by a group location code. The user may then select for which of the identified gas station locations her or she desires to have routing information calculated by, for example, double-clicking, touching or similarly selecting the icon representative of the desired gas station location. The navigation system can then calculated routing information to that location and present the routing information to the user. In this example, the gas station identified to be nearest to the requesting navigation system is highlighted circled.

As illustrated in FIG. 18, metadata may also be displayed for each gas station that identifies certain attributes of each gas station, such as hours of operation, gas prices and etc. Alternatively, as shown in this example, metadata associated with the group location code may retrieved, processed and presented to the user by the navigation system in the form of processed data. In particular, the operation hours of each gas station may be included as part of the group location code metadata. Then, the navigation system, by comparing the current date and time to the operation hours of each station, can determine if a particular station is closed or open and, if open, for what period of time it will remain open. This process data is depicted on the top part of each station symbol. The current position of the navigation system may then be used to determine the traveling distance between the navigation system and all the identified station. The closest station which is 0.8 miles far will be open for another 2 hours is highlighted. If “Ok” button is pressed, a route will be calculated to the highlighted station and the user will be guided to it. Current price of gas is depicted on the bottom of each symbol. The same metadata can be processed and presented differently by different navigation systems based on their capabilities, design, programming, metadata processing features etc. For example, a navigation system that does not have access to the current date and time may simply present the operation hours of each station or ignore it all together. In another example, a navigation system without using its graphics capabilities may present the same data in text-form. In this example, the metadata may be processed before being presented to the user. The metadata is processed based on the current location, the current date, the current time and a set of stored instructions and/or criteria.

FIG. 18a shows an example of one implementation of an output screen that allows the users to change the criteria upon which the gas stations in the group are displayed and/or highlighted for the user. In this example, the system receives a group location code that corresponds to a group of gas stations of a particular company. As a result, the navigation system identifies all nearby branches of the gas station locations associated with the particular gas company identified by the group location code. This is one example of how a criteria such as proximity to a location may be used to select data from the original data set, which in this case is all the locations associated with a location code. In this example, the nearest gas station is outlined. As illustrated in FIG. 18a, the user may have the option of asking the system to identify stations based upon different criteria. For example, the user may ask the system to identify, within a particular radius, the nearest gas station or the gas station having the cheapest gas of a particular gas type. By way of example, as shown in FIG. 18a, this may be accomplished by pressing the “Option” button and reconfiguring the criteria. If the “Option” button is pressed, a menu that includes “Closest”, “Cheapest”, “Gas type”, Radius” may be presented to the user as illustrated in FIG. 18a.

FIG. 18b shows an example of one implementation of an output screen that highlights a particular gas station in a group of identified gas stations that match selected criteria. For example, as illustrated in FIG. 18b, if the “Cheapest” option is selected, the system may highlight, from the group of identified gas stations, the gas station having the cheapest type of a particular grade of gas within a given radius that is still open. In this example, user input is used to instruct the system how to process the metadata associated with the group locations. The “Gas type” option enables the user to select what grade of gas prices should be displayed and used in the calculation and processing of metadata. Alternatively, the prices for all grades of gas may be displayed. The “Radius” option allows the user to change the area of search. The area of search determines which stations are going to be considered when determining, for example, the cheapest gas price. The “Gas type” as well as “Radius” are both examples of how stored user instructions and/or criteria can be used in controlling metadata processing and identification of locations associated with group location codes.

FIGS. 18c shows another example of an implementation of an output screen that may be presented in response to the entry of a group location code. In this example, in addition to the group location code, shown in FIG. 18c as 2-800-746-1675, a 4-digit security code is required to be entered to the system to access the group location code information. In this example, the group location code belongs to a real estate agent at Best Realtors and has been created specifically for use by a customer. In this example, three houses are linked or associated with the group location code to match the criteria of the customer. At this point, if the “Enter” is pressed, the system may, by considering the current location, route the shortest course to visit all the houses. Alternatively, when an individual location code is touched, the system may display detailed information about it and route a direct course. These individual location codes with associated metadata may be secondary location codes assigned to the houses while they are in the market. The user may also to have the option of de-selecting a member of the group by simply touching the toggle box market “X” beside the individual location code. At this point, if the “Enter” is pressed, the de-selected member(s) of the group are ignored and the system may, by considering the current location, route the shortest course to visit the remaining houses. The system may also have a feature to deselect a member when it has been visited using the information provided by GPS.

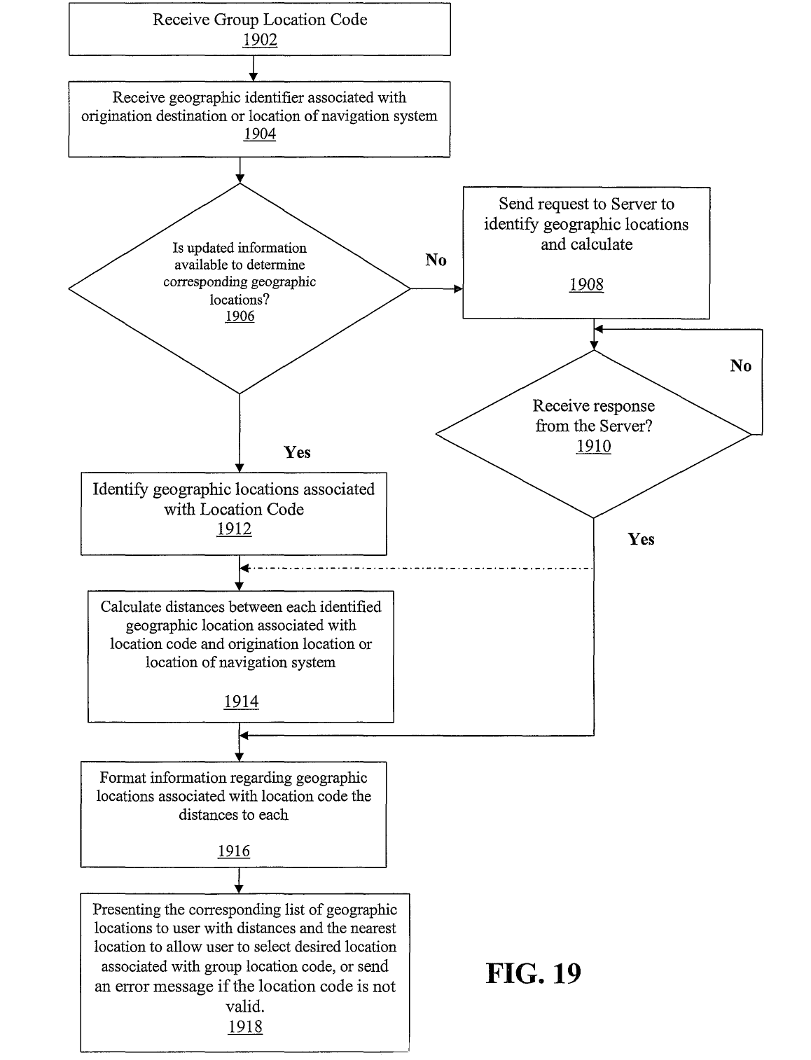

FIG. 19 illustrates a flow diagram of one example of an implementation for finding nearest location for a group of locations associated with a single location code using a client/server navigation system. In this example, the navigation system receives a group location code 1902. To determine which of the geographic locations are closest to the navigation system or starting location, the navigation system may use obtained information regarding the origination or starting designation 1904. Information regarding the starting location can be provided through user input for example in form of a location code or a geographic identifier such as a street address or through the use of a GPS unit, if available.

When a local database exists, the client determines whether the information in the local database is current with respect to the received group location code 1906. If the information is not available locally, or is not updated, the client can pass the request to the server 1908. The server then identifies the group of geographic locations associated with the group location code, as described in connection with FIG. 17. The server can return the identifying information back to the client to calculate the distances between the starting location and the associated group of locations, or the server can calculate the distances and return the information to the client 1910. As before, the information can be returned in a format recognizable by the user or the client can format the returned information to be recognizable by the user 1916.

If updated information is available locally, the client can identify the starting location and all the geographic locations in the group associated with the location code 1912. The client can calculate the distance between the starting location and each geographic location associated with the group location code 1914. One or more of the closest locations associated with the group location code to the starting point, may be formatted for presentation to the user along with their respective distances from the starting position (as necessary) 1916. These locations may then be presented to the user 1918 for review. The user then can select one location and obtain routing information to the location, if desired. Alternatively, although not shown, the client can request that the server update the local database before it processes the request of associating the group location code with the nearest locations in the group. Alternatively, if no information can be found that relates to the location code, the system can notify the user that the location code is invalid.

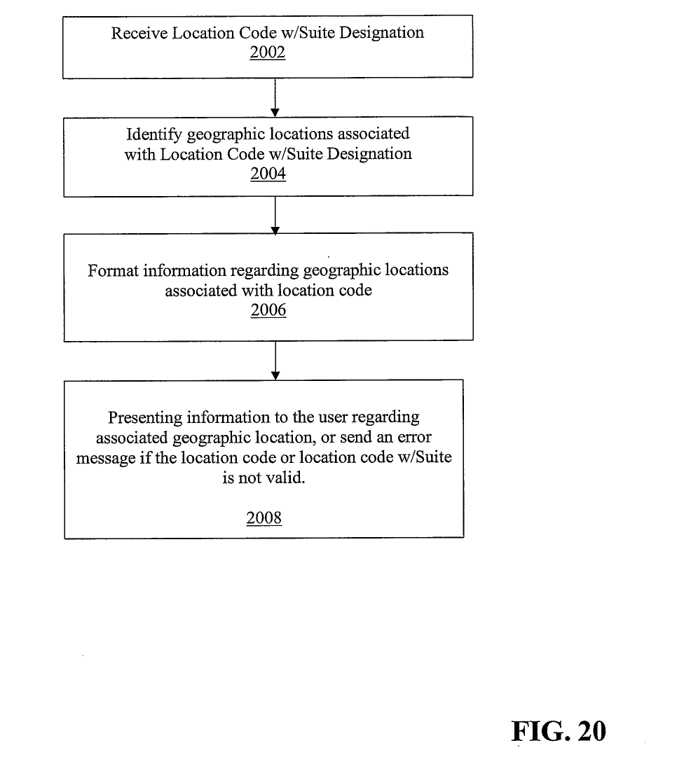

FIG. 20 illustrates a flow diagram of an example of an implementation for identifying location codes having suite designations with geographic location using cross-reference databases. As seen in FIG. 20, the system receives the location code that includes a suite designation 2002. Next, the system identifies at least one geographic location that is associated with the location code 2004 by cross-referencing the location code to a database capable of translating location codes into other types of geographic identifiers. In this example, the cross-reference database is a compiled database that associates each location code with an address and/or geographic coordinate and allows for the association of the information through a simple look-up process.

Once the corresponding geographic identifiers to the location code are obtained from the database, the system may need to formatting or translating the corresponding geographic identifier to be recognizable by the system and/or user 2006. For example, if the cross-reference database provides the system with corresponding global coordinates to the location code. The system will need to cross-reference those coordinates to a street address for presentation to the user. Alternatively, if the database provides a street address as a corresponding geographic identifier, the system may need to translate that into global coordinates before it can calculate routing information for the user. In this manner, the information taken from the cross-reference database may need to be further formatted to perform the desired function or command that the navigation system is being asked to perform. For example, if the command is simply to provide the user with the address that correspondences to the location code. The system formats the corresponding geographic identifier in the form of a street address 2006, if necessary, and then presents the address to the user 2008, as requested. Alternatively, if no information can be found that relates to the location code or to the location code having a sub designation, the system can notify the user that the location code is invalid.

In this example, the system may return two addresses for use in calculating or providing routing information: (i) the address for the whole unit and (ii) the address for the sub-unit. It may be that the actual destination for the sub-unit is located off-road, in that the destination does not have a conventional street address, or is designated by a different suites, floors, or other sub-designations for a single postal address. In this manner, the location code could have a “Road Coordinate” and an “Off-Road Coordinate”. The Road Coordinate could be used to route the user to the destination as far as the road system allows. The Off-Road Coordinate could be used to route the use to the actual destination from the point where the road system ends or directly to the destination from the starting position, when no road system exist to between the two destinations. For Off-Road Coordinate routing, the user may get to the desired destination by traveling off-road, e.g., by walking, using off-road vehicles, public transportation, etc. Such Off-Road Coordinate systems could also be useful for navigating large public parks or other large areas heavily traveled by foot or other means of transportation.

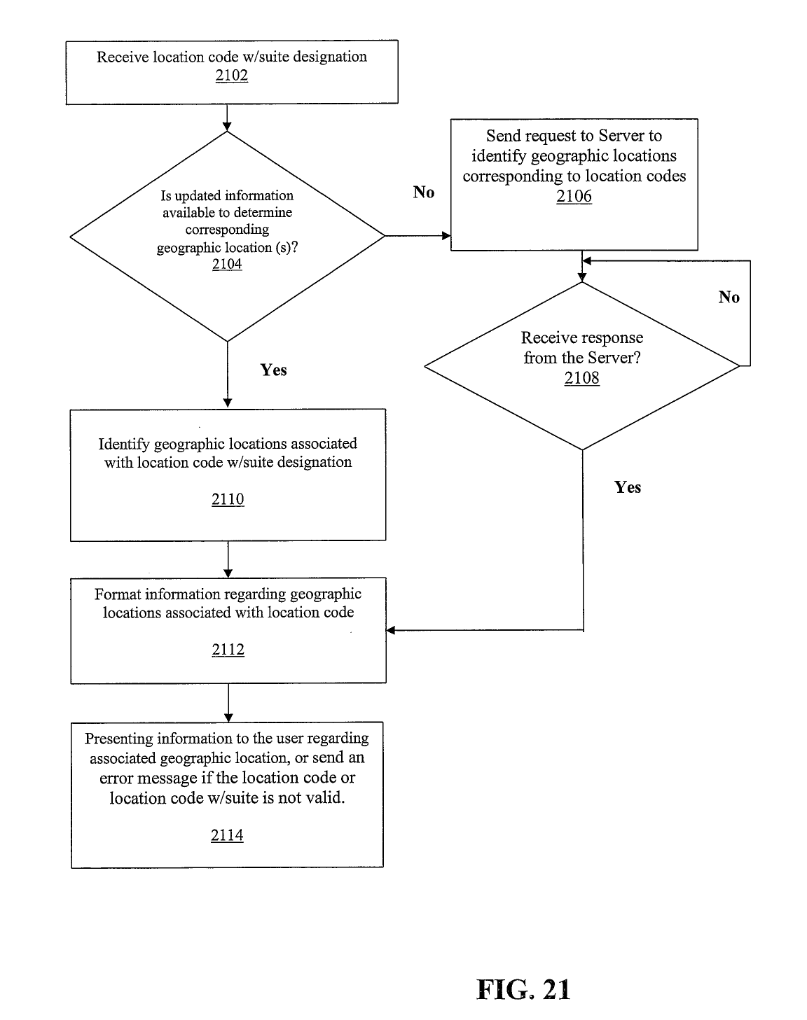

FIG. 21 illustrates a flow diagram of another example of an implementation for identifying location codes having suite designations with geographic location using cross-reference database using client/server navigation system. The client first receives the location code 2102. When the client has a local database, as in this example, the client may determines whether the information in the database is current with respect to the received location code or whether it contains the necessary information regarding the received location code 2104. If the information is not available locally, or is not updated, the client can pass the request to the server 2106. Alternatively, although not shown, the client can request that the server update the local database before it processes the request of associating the location code with its geographic location.

If the location code received by the user is passed to the server 2106, the server may perform the look-up function, in the same manner described above in FIG. 20, and returns the corresponding geographic identifier(s) back to the client 2108. The corresponding geographic identifier(s) can then be formatted to be recognizable by the system and/or user, as necessary, 2112. The formatted geographic identifier(s) can then be returned to the user 2114. If the information is available locally, the client can perform the look-up function 2110, format the geographic identifier(s) 2112 and present the associated geographic location to the user 2114. Alternatively, if no information can be found that relates to the location code or to the location code having a sub designation, the system can notify the user that the location code is invalid.

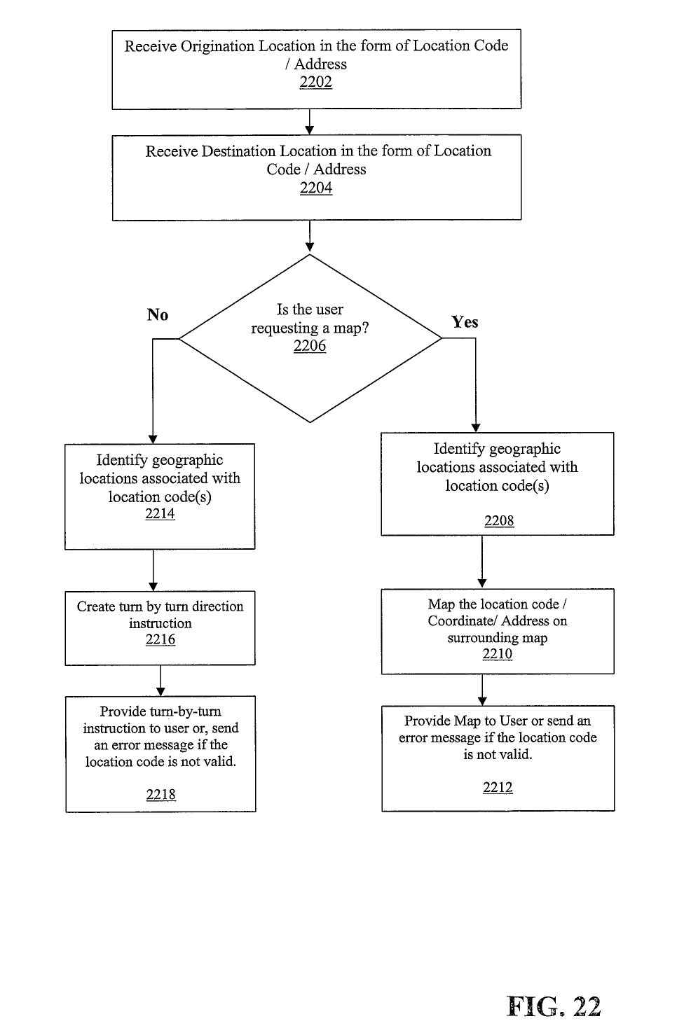

FIG. 22 illustrates a flow diagram of one example of an implementation for calculating routing information based upon entry of location codes or addresses for originating and destination locations. In this example, a GPS unit is likely not available to the navigation system. Thus, the system requires the input of the origination location 2202 and the destination location 2204. Either or both the origination location 2202 or the destination location 2204 may be entered in the form of a location code.

As further illustrated in FIG. 22, the navigation system may provide the user with the option of obtaining routing information in the form of a map, turn-by-turn instructions, or both 2206. Regardless of which option the user chooses, the system first identifies the corresponding geographic location for the locations codes or address, as necessary for the system to calculate routing information 2208 and 2214. Based upon this information, if the user desires a map, the system then calculates the mapping information 2210 and provides the routing information to the user 2212. If the user desires turn-by-turn instructions, the system calculates the turn-by-turn instructions 2216 and then provides the instructions 2218 to the users. Alternatively, if no information can be found that relates to the location code, the system can notify the user that the location code is invalid.

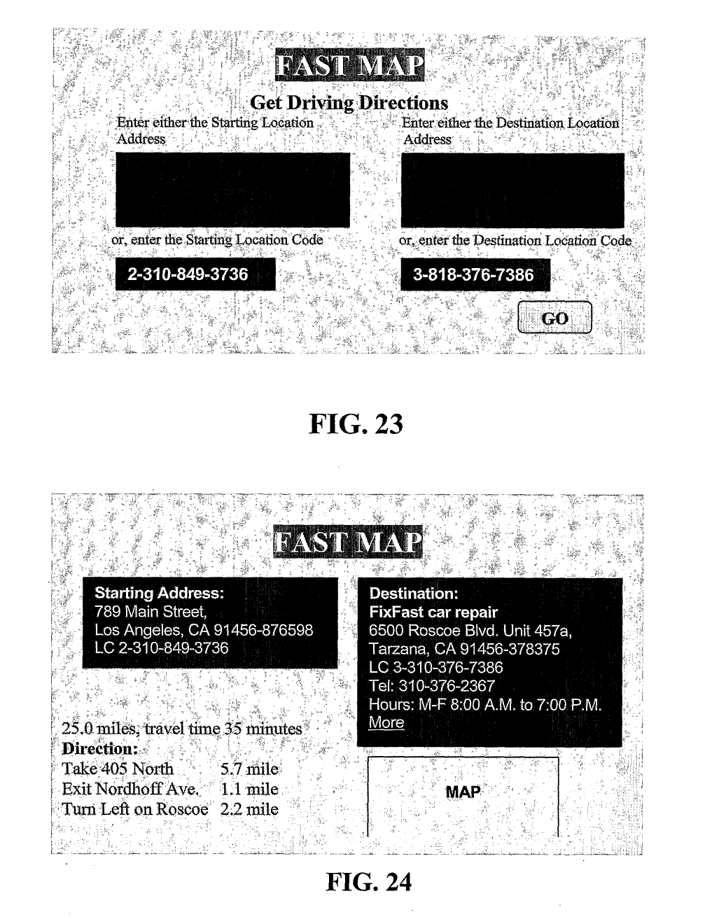

FIG. 23 illustrates another example of an implementation of an input screen that may be providing in accordance with this example for the input of location codes for both origination and destination locations. As illustrated by FIG. 23, the system can provide for the option of inputting the street addresses or the location codes for the starting location and the destination locations.

FIG. 24 illustrates another example of an implementation of an output screen that may be provided in accordance with this example that displays both a map and turn-by-turn instructions calculated based upon the information provided by the user regarding origination and destination locations. As seen in FIG. 24, both the map and turn-by-turn instructions may be provided to the user. Additional routing information formats may also be provided.

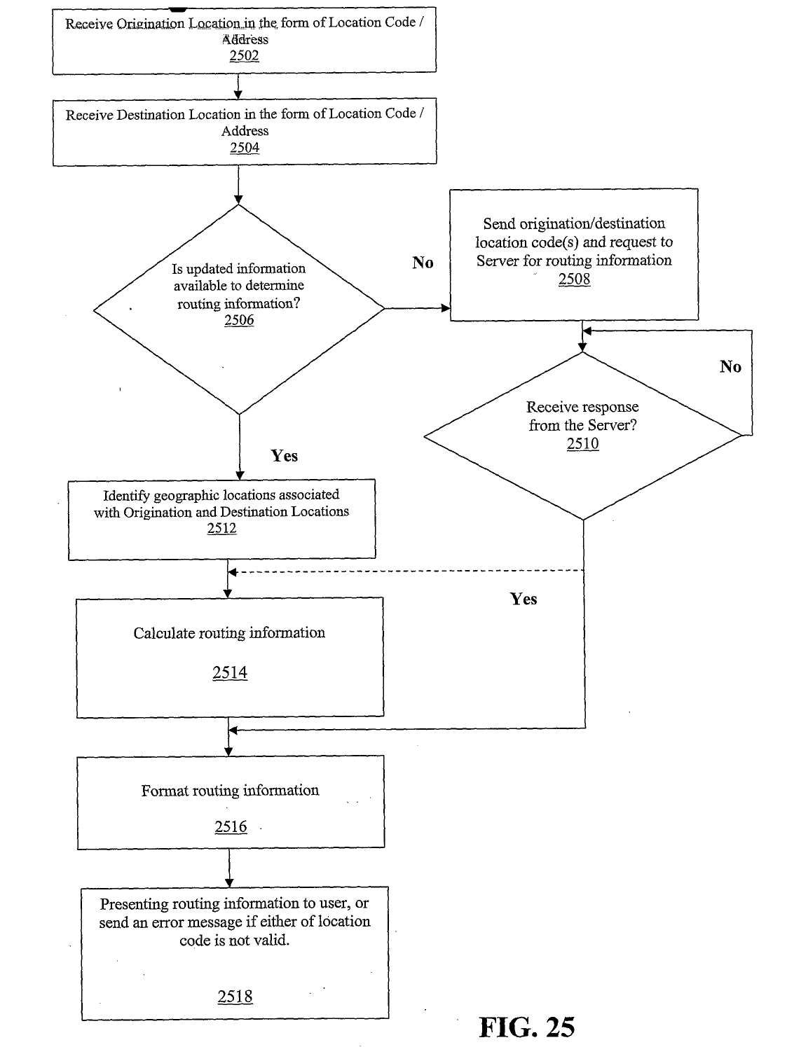

FIG. 25 illustrates a flow diagram of an example of an implementation for calculating routing information based upon entry of location codes for originating and destination locations using a client/server application. As before, a GPS unit may not be available to the navigation system. Thus, the system requires the input of the origination location 2502 and the destination location 2504. Either or both the origination location 2502 or the destination location 2504 may be entered in the form of a location code, geographic identifier such as street address etc. When the client has a local database, the client may determine whether the information in the database is current with respect to the received location code or whether it contains the necessary information regarding the received location code 2506. If the information is not available locally, or is not updated, the client can pass the request to the server 2508. Alternatively, although not shown, the client can request that the server update the local database before it processes the request of associating the location code with its geographic location.

If the location code received by the user is passed to the server 2508, the server may perform the look-up function, in the same manner described above in FIG. 22, and returns the either the corresponding geographic identifier(s) back to the client 2510. Using this information, the client can then calculating the desired routing information 2514 in a format necessary for the user 2516 and present the information to the user 2518. Alternatively, the routing information can be passed to the client from the server 2510, formatted as necessary 2516 and presented to the user 2518. If the information is available locally, the client can perform the look-up function 2512, calculate the routing information 2514, format the information 2516 and present the routing information to the user 2518. Alternatively, although not illustrated, the client can identify the geographic locations associated with the origination and destination locations and pass that information to the server. In this case, the server would simply calculate the routing information and return the routing information to the user. Alternatively, if no information can be found that relates to either location code, the system can notify the user that either or both of the location codes are invalid.

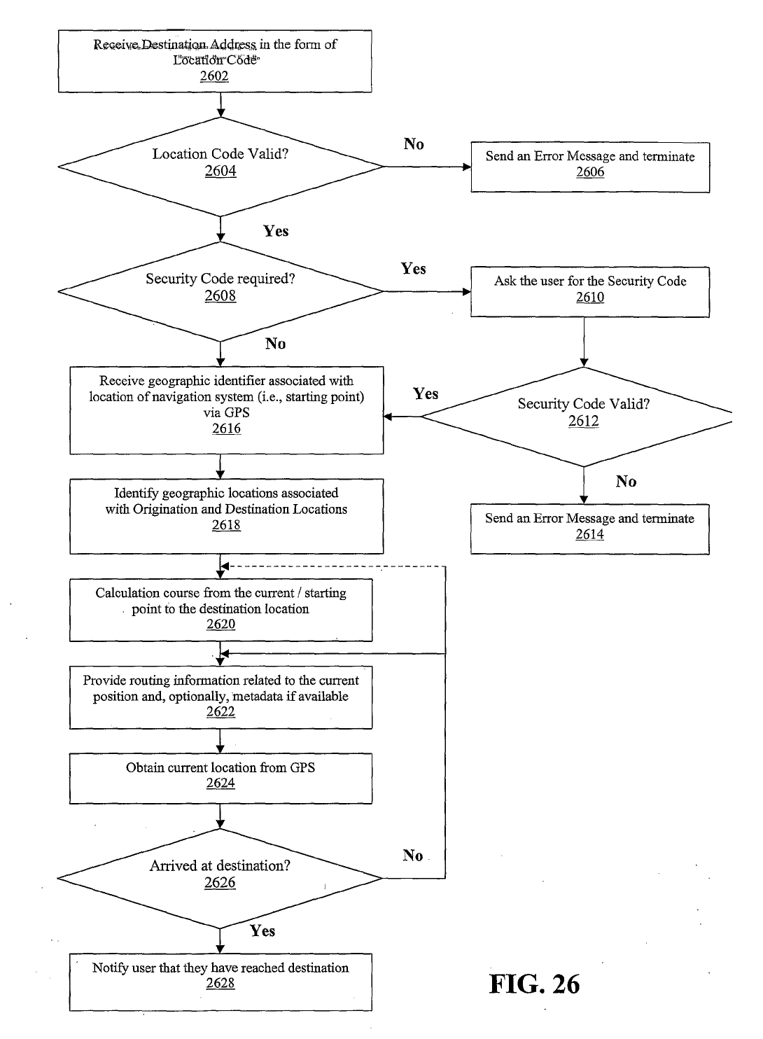

FIG. 26 illustrates a flow diagram of an example of an implementation for calculating routing information based upon entry of location codes for destination locations. In this example, the system includes a GPS from which the starting location may be obtained 2616. Thus, the system is only provided with a destination address in the form of a location code 2602. In this example, the system first determines if it has received a valid location code 2604 by determining whether information is available for the entered location code. If no information is available, the system notifies the user that the location code entered is invalid 2606. In this example, the system also checks to determine if a security code is required to receive the information associated with the location code 2608. If a security code is required, the systems then asks for the security code 2610 and determines if the entered code is valid 2612. If the security code entered is invalid, the system sends and error message and optionally terminates the program 2614. If the security code is correct, the system then identifies the geographic locations associated with the navigation system 2616, identifies the geographic location associated with the entered location code 2618 and calculates the routing information 2620. If the location code points to a subdivision such as a suite number or unit number, the routing information may include instructions on how to get to that particular subdivision. Based upon these calculations, the routing information is formatted and provided to the user 2622. Optionally, if metadata is associated with the destination location code, metadata may be provided to the user either with the routing information or when the system first identifies the corresponding geographic location 2618, if user verification is sought. This information may be updated if the system is capable of tracking the path of the user along the desired route. In this regard, the system is able to continually monitor the current location of the system via GPS 2624, determine whether the system has reached its destination 2626, and if not, calculate or update the routing information based upon the current location of the system and provide that information to the user 2622. This cycle is continued until the system reaches the destination location, at which time the system notifies the user that it has reached its destination 2628.

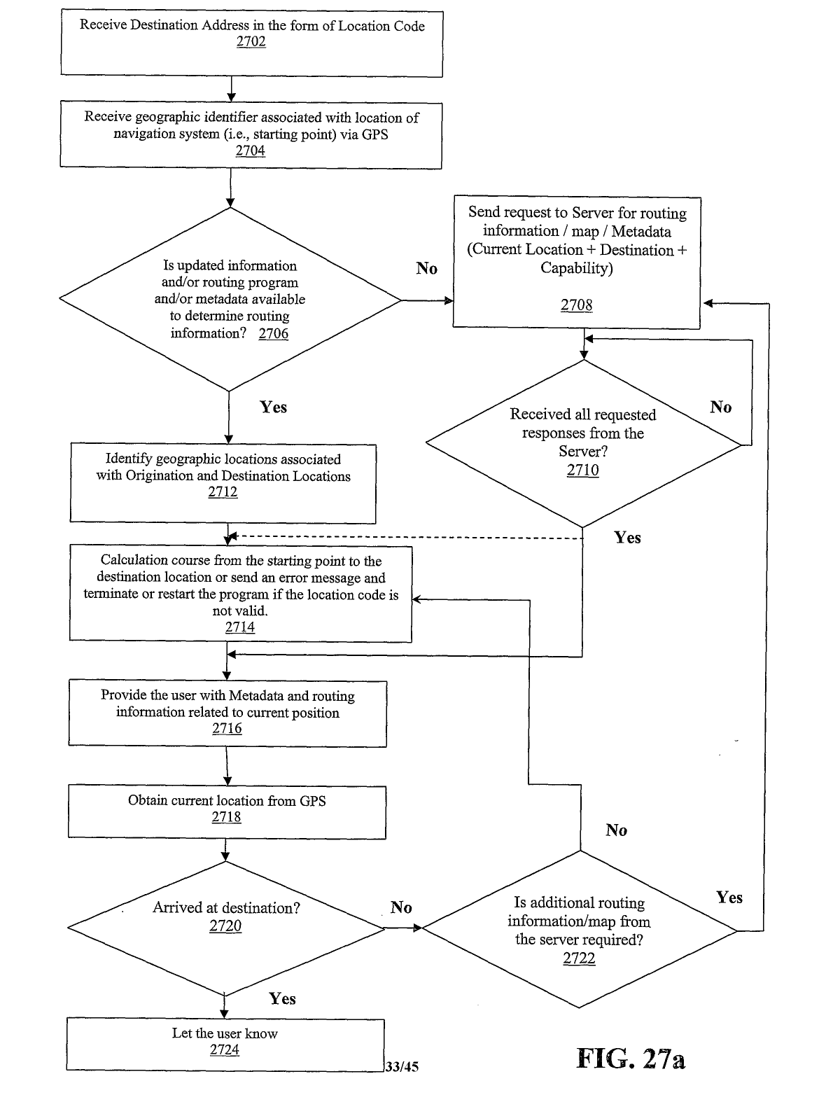

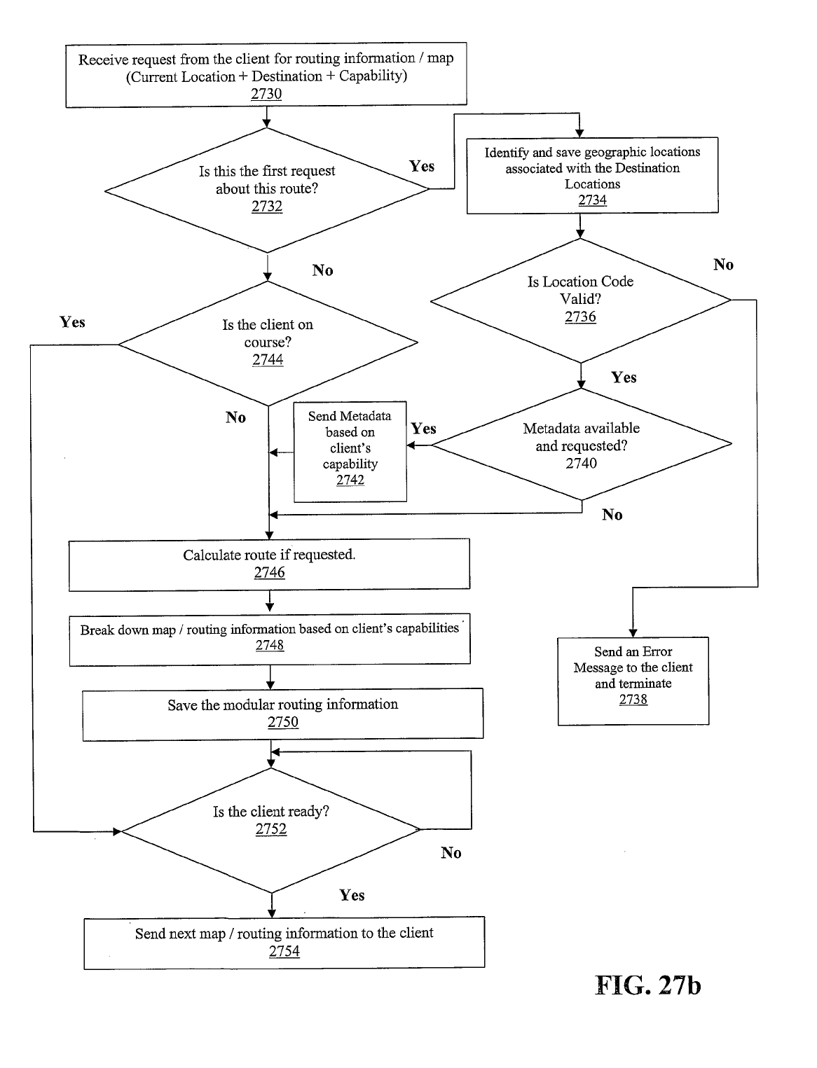

FIGS. 27a and 27b illustrate one example of one implementation of a client/server location code capable navigation system. FIG. 27a is a flow diagram that illustrates one example of how a client may calculate routing information based upon entry of location codes for destination locations using a client/server application. As before, in this example, the system includes a GPS from which the starting location may be obtained 2704. Thus, the system is only provided with a destination address in the form of a location code 2702. When the client has a local database, the client may determine whether the information in the database is current with respect to the received location code or whether it contains the necessary information regarding the received location code 2706. If the information is not available locally, or is not updated, the client can pass the request to the server 2708. Alternatively, although not shown, the client can request that the server update the local database before it processes the request of associating the location code with its geographic location or the database can be updated upon occurrence of a predetermined event or at predetermined times.

If the location code received by the user is passed to the server 2708, the server may perform the look-up function, as illustrated in FIG. 27b below, and returns the corresponding geographic identifier(s) back to the client 2710 and all associated information, such as Metadata. Using this information, the client can then calculating the desired routing information 2714 in a format necessary for the user 2716 and present the information to the user 2718 along with any other related data, such as Metadata. Alternatively, the routing information can be passed to the client from the server 2710, formatted as necessary 2716 and presented to the user 2718. If the information is available locally, the client can perform the look-up function 2712, calculate the routing information 2714, format the information and present the routing information to the user 2716. Alternatively, although not illustrated, the client can identify the geographic locations associated with the origination and destination locations and pass that information to the server. In this case, the server would simply calculate the routing information and return the routing information to the user.

In either case, the routing information provided to the user may be updated if the system is capable of tracking the path of the user along the desired route. In this regard, the system is able to continually monitor the current location of the system via GPS 2718, determine whether the system has reached its destination 2720, and if not, determine whether further information is need from the server to recalculate the course 2722. If no further information is required from the server, the system can obtain current GPS information 2718 and based upon the current location of the system, recalculate the routing information based upon the current location of the system 2714 and provide that information to the user 2716. This cycle is continued until the system reaches the destination location, at which time the system notifies the user that he/she has reached the desired destination. If further information is needed from the server, the client may also interface with the server to assist with providing updated routing information to the user in the same manner as it assisted with providing the initial routing information to the client. Further information may be needed from the server to update the routing information if, for example, the user device lacks the memory for storing all the routing information or processing capabilities required to provide the user with directions from the origination location to the destination. Communication between the client and server can establish whether the client is capable of receiving all the routing information or needs to be “spoon feed” the information in separate data transmissions.

FIG. 27b is a flow diagram that illustrates one example of how a server may calculate routing information based upon entry of location codes for destination locations in a client/server application. FIG. 27b is an example flow diagram of one example of an implementation of the logic or process performed by a server when it receives a request from a client, as illustrated in FIG. 27a, for routing information 2730 or other information related to a location code. In this example, upon receipt of a request from the client, the server first determines whether this is a first of subsequent request from the client for routing information 2732. In other words, the system must determine if the request is to calculate, recalculate or provide the client with the next set of information to assist with completing the routing request. If routing information is being requested for the first time for a given route, the system first identifies the geographic location(s) associated with the provided location codes 2734. If no information can be obtain, then the system determines that the received codes are invalid 2736 and notifies the user 2738. If the location code(s) are valid, the system may then check to determine whether metadata is available for the location codes or associated geographic locations 2740. If the metadata is obtained, both metadata and the location information are provided to the client. The metadata may be immediately forwarded to the client or stored to be communicated to the client with the routing information 2742 based upon client capabilities.

Using the information acquired about the location codes, the server can then calculate the routing information 2746 using information provided by the client regarding its current position, storage capacity and routing request 2730. If the client is not able to store all the routing information, the server can break the information down into a series of sequential maps or routing data based upon the client's capabilities 2748. The routing information is then saved by the server 2750. If the client is ready to receive the information 2752, the routing information is sent to the client 2754 in whole or in part, depending upon the capacity of the client.

If the request being made by the client is a second or subsequent request 2732, the server will then determine if the client is still on course 2744. If so, the server will provide the client with the next map or routing information in the sequence 2754 upon verifying that the client is ready to receive the information 2752. If the client is not on course, the server will recalculate the route 2746, segment the newly calculated route, if required, 2748, save the new routing information 2750 and send the information to the client 2754 when the client is ready 2752.

As illustrated by the above example functions that may be performed by a navigation system, navigation systems may be designed to accept location codes, instead of, or in addition to, other methods for identify origination and/or designation locations. If a location code is provided to the navigation system as a method of designating a specific geographic location, the system can translate the location code into a format necessary for the system to calculate routing information or for associating information with a particular location code, such as a street address or coordinate system. Translating location codes into formats required by the navigation system to calculate routing information can be done by using a cross-reference database that matches the location code to its corresponding address or geographic coordinates or through various algorithms.

In operation, when using location codes in navigation systems to calculate routing information, the system would convert any location code information into the corresponding street address or geographic coordinate or other identifier(s) used by the navigation system to calculate routing information. When a navigation system uses GPS and only requires the entry of destination information, the navigation system, if provided with a location code as a destination, would be required to convert the destination location code into data of a format used by the system to calculate routing information. The GPS could continue to provide origination information to the navigation system in the format required by the system to calculation routing information without modification.

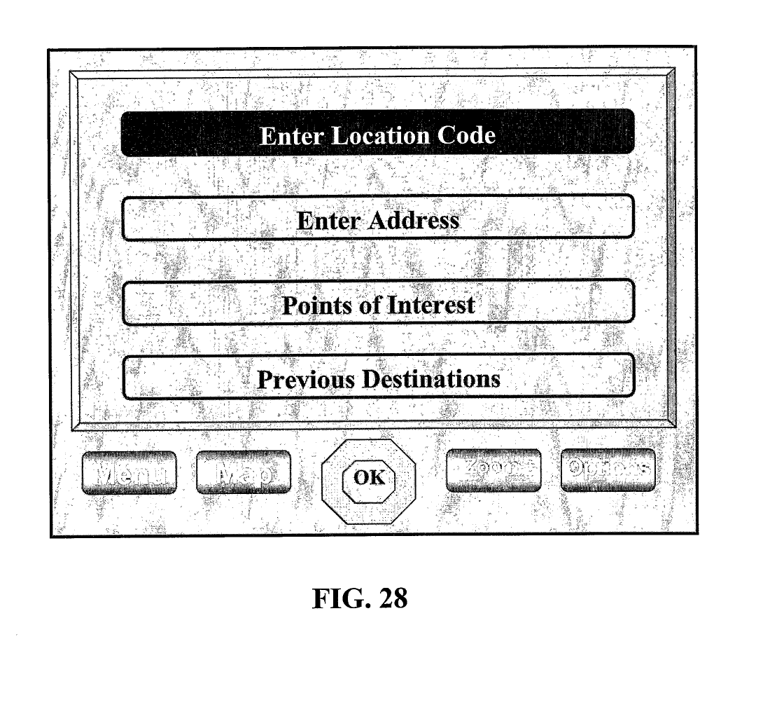

FIGS. 28-31 illustrate one example of an implementation of how location codes may be utilized in a car navigation system. FIG. 28 illustrates an example of a screen that may be used to select the method for inputting destination location. In this example, the user interface includes four push buttons (MENU, MAP, ZOOM, and OPTIONS), one “Mouse key” and an “OK” function in the middle. The ZOOM key can be pressed on either side to increase or decrease the scale. The mouse key can be pressed in four directions—up, down, left and right. In addition to the hard keys, the screen may have touch capabilities, which can be used for inputting functions. Optionally, speech recognition may also be provided as a feature of the navigation system in which case speech may be used and an alternative means for entering information into the navigation system.

As illustrated by FIG. 28, the navigation system offers the user the option of utilizing location codes for the input format of the designation. As illustrated in FIG. 28, using location codes may be offered as one alternative means for the entry of destination information. In such system, the user still has the option to input address information. Alternatively, navigation systems may be developed that provide for the exclusive input of location codes.

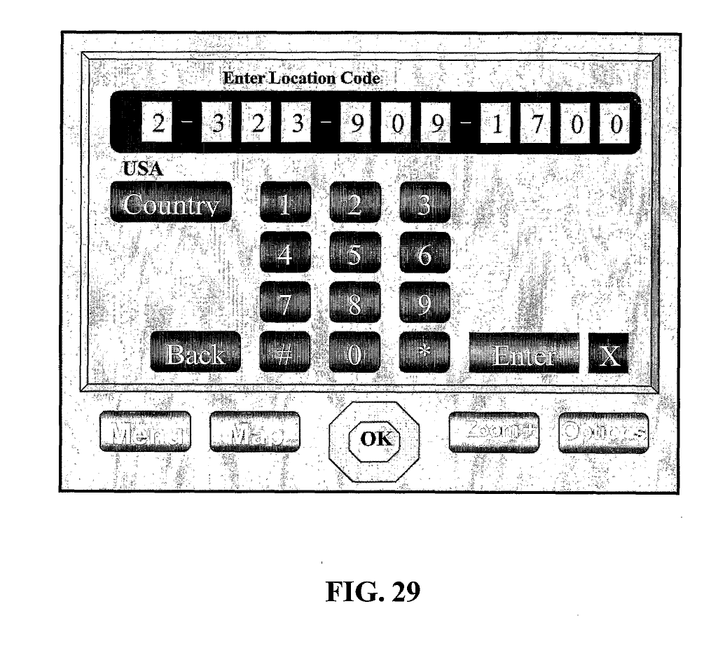

FIG. 29 illustrates an example screen for inputting location code information. This screen would appear if the user selects the option of “Enter Location Code” from the list of options displayed on the screen illustrated in FIG. 28. This selection may be made by using either a touch screen or up and down feature of the mouse and pressing “OK”. As illustrated in FIG. 29, the user is then provided with the ability to enter a location code. In this example, the user may input the location code using the numeric pad on the touch screen and then pressing “Enter”. The “X” button may be used to cancel the operation and the “Back” button may be used as backspace. Optionally, a button may be provided to restrict the field of the search using the location code by country, state, city or other similarly restrictive identifiers. In this example, the database of searching is restricted to the US; however, if the “Country” button is pressed, the user will be presented with a list of countries to selection from to change the zone of searching. Alternatively, although not shown, the user can be given an opportunity to enter a country code.

While the example screen for inputting location code information allows for the input of an eleven character location code. As discussed above, location codes may be construed from any number of characters in a series and is not intended to be limited by this illustration. Once the location code is entered into the system, the system cross-references the location code from its database, looks up the corresponding address and presents the corresponding street address to the user for verification. Alternatively, as discussed above, an algorithm may be used to convert the location code to its corresponding street address.

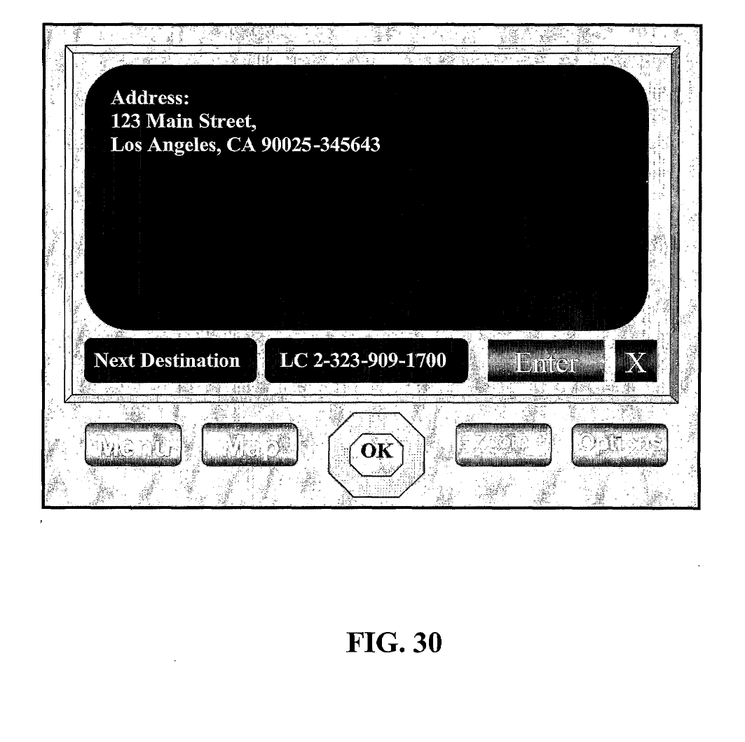

FIG. 30 illustrates an example screen display presenting the street address to the user that system determined to correspond to the provided location code. In this implementation, the user is given the opportunity to verify that the location code entered corresponds to the desired street address of the destination location. Once the user confirms that the displayed address corresponds to the destination location, the user selects or presses the “Enter” or “OK” button. At that time, the system plots a route between the user's current location, which is this example is determined by GPS, and the desired destination. Alternatively, if the “Next Destination” button is pressed, the user will directed back to the previous screen and be asked to input another location code or an additional location code in the case of multi-destination navigation system functions.

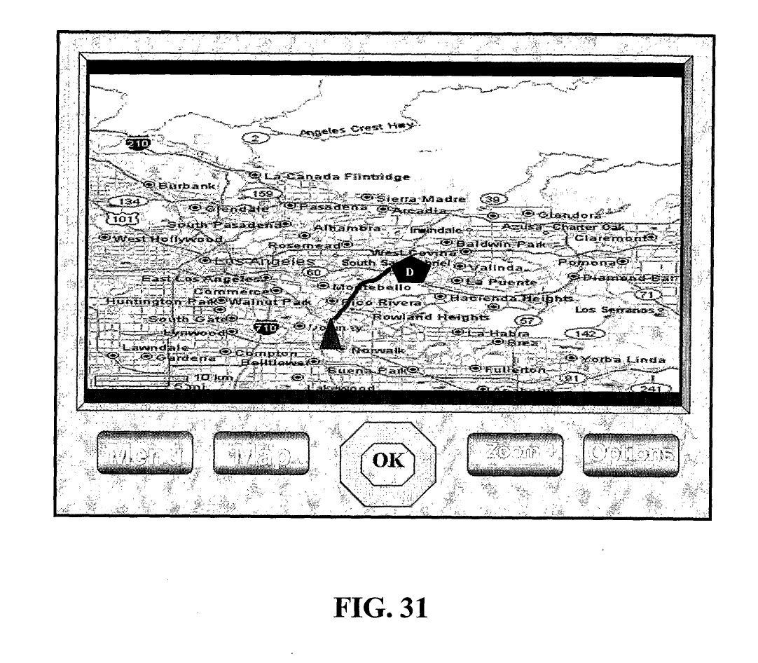

FIG. 31 illustrates an example display of routing information derived from the initial input of a location code for the destination. The displayed route will be used to direct the user to the desired destination. Optionally, the system by provide various means for calculating the route, by calculating, for example, the shortest route, the route using free-ways, the route avoiding free-ways, or the route that is determined to avoid the greatest areas of traffic as determined by real time traffic conditions provided to the system.

The method described above and illustrated in FIGS. 28-31 may be employed in any mobile or other device containing a navigation system having GPS capabilities. Similarly, when used in connection with navigation systems that do not have GPS capabilities, the method of calculation remains the same except it further requires the entry of the origination location code and the conversion of the origination location code to its corresponding street address, both steps of which may be performed in the same manner as they are for inputting the destination location code and converting it to its corresponding street address. The user may then be given the opportunity to verify the accuracy of the street addresses determined to correspond to location codes provided for the origination and destination locations. Once the user verifies the accuracy of the corresponding street addresses, as determined by the system, the system calculates the desired routing or mapping information and provides the calculated information to the user in the form of a map, text directions, or other format for providing directions and routing information to a user.

Additionally, in some applications, a navigation program and/or corresponding database module for use with the navigation program may not exist. For example, when used in connection with a cell phone, there may be no database resident locally for fulfilling all the requests of the user in which case those requests may be forwarded to the server for processing. The server then provides the cell phone, or other client, the required information or information for display to the user, as illustrated by the previous examples.

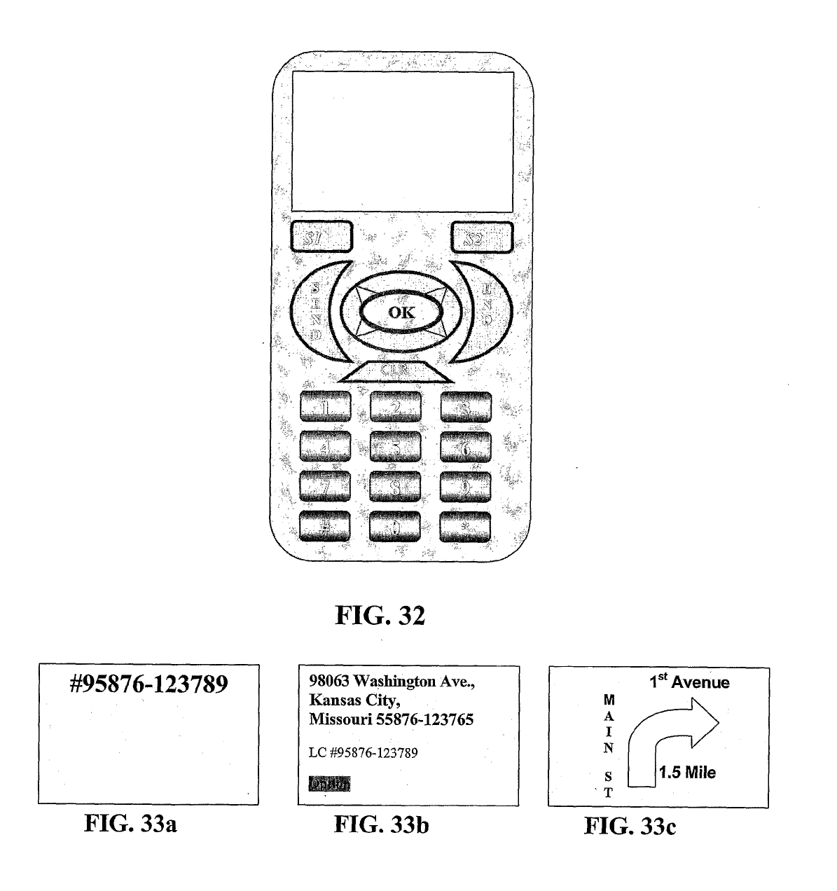

FIGS. 32-37 below illustrate various example of different implementation for the use of a navigation system utilizing location code in connection with cellular telephones. For purposes of illustration only, FIG. 32 is provided which illustrates an example of a user input on a cellular telephone. In this example, the cell phone has a keypad and a screen. The keypad consists of a numeric area, mouse key, SEND, END, CLR, S1 and S2 soft keys. The mouse key can be pressed in four directions (up, down, left and right) and has an action “OK” key in the middle. FIGS. 33a-33c, 34a-34d, 35a-35e, 36a-36c and 37a-37e illustrate few examples of implementation of how location codes can be used in connection with navigation systems used with a cell phone. The cell phone may be equipped with GPS and/or may have the ability to communicate with server, which may be accessible through the web. When a GPS is not present, the user may be required to enter both origination and destination location as described in detail above. Even when GPS is present in the cell phone, it still may be desirable to enter both origination and destination locations in the event that the user is not positioned at the desired origination location. Where the cell phone does not have enough resident memory or processing capabilities to provide full navigation capabilities or where it is not desirable, the cell phone may communication directly with a server via a network or the web (as described above) to obtain and provide routing information to a user.

FIG. 33a illustrates an example input screen that may be displayed on a cell phone for use with navigation applications. In this example, the user may first enter a location code into the cell phone using the keypad representative of the desired destination location. In this case, the pound sign “#” is used to indicate that the number is a location code. Once location code is entered, the user may then press the “SEND” key, which will send the requested location code to the server to perform the desired function relative to the entered location code. The server may then lookup the location code in the database and forwards the corresponding address to the phone which may be then displayed to the user for verification. FIG. 33b illustrates an example of the screen displaying presenting the corresponding address to the user for verification. At this point, the user may then press the “SEND” or “OK” key, or similarly functioning button on the phone to verify the address and send the request for further information back to the server. If the GPS coordinates of the phone are being used as the origination location for generating routing information, the GPS may also be forwarded to the server at this time or with the original request to cross-reference the destination location and for verification of the corresponding address by the user. Otherwise, the origination location may be entered with the destination location and follow the same look-up and verification procedure as the destination location. The server may then plots the routing information and forward appropriate information back to the cell phone. FIG. 33c illustrates the cell phone display of routing information requested by the user. The cell phone may displays either a map or turn-by-turn instruction as well as providing corresponding verbal directions to the user.

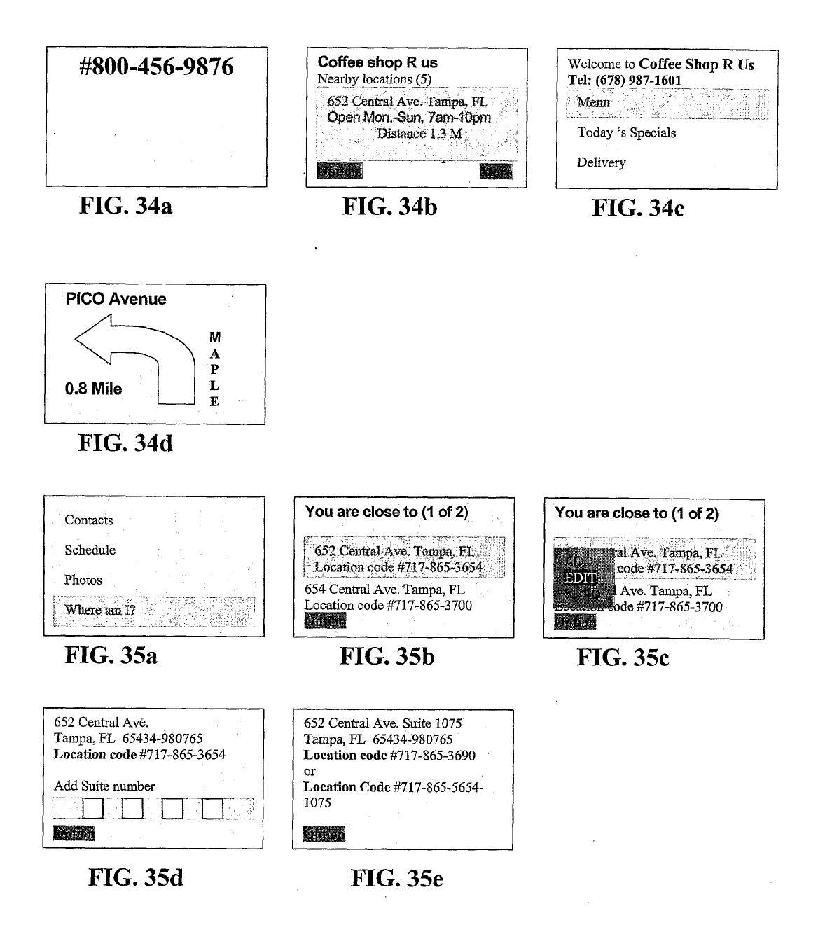

Another example of a function that may be performed by a navigation system using location code in connection with a cell phone may be found in FIGS. 34a-34d. This example illustrates how group location codes may be used in a navigation system with a cell phone. As discussed previously, group location codes may generate information related to one location or a collection of many locations that can be used to find the closest location to the user.

FIG. 34a illustrates a screen display from the entry of a group location code that starts with #800. When the “SEND” button is pressed, the location code, in addition to the GPS coordinates of the cell phone may then be forwarded to the server. The server recognizes the group location code and takes the current location of the cell phone user into account. From there, the server can identify one or more closest location in the set and forward it to the cell phone for display. As illustrated in FIG. 34b, the cell phone may then display the name of the company with a list of closest branches. Metadata, such as operation times of the location may also be presented to the user. The user may go through the list of locations by using the mouse (up/down). The “S2” soft key may indicate that there is more information available. As illustrated in FIG. 34c, when the more button is pressed, the location code may be forwarded to the server and may returns a web address that the phone display for the desired location. It should be noted that using web site as a way to convey the Metadata is just one approach. There are many other ways to provide the Metadata to the user including a server program that interfaces with the client in this case the cell phone. Next, the user may select the desired location form the list of locations by pressing the “SEND” key the cell phone. Once pressed, the desired location is forwarded to the server along with the current GPS location of the cell phone. The server then calculates the routing information and forwards it back to the cell phone for display. As illustrated by FIG. 34d, the cell phone may then display a map, give turn-by-turn instructions and/or provide verbal routing instructions to the user.

Optionally, a cell phone navigation system may find the location code of current position from the cell phone menu. FIG. 35a illustrates one example of one implementation of a screen display that may allow a user to determine there current position. As illustrated in FIG. 35a, the screen may display a option to select “Where am I?” Once this optional function is selected, the user presses “SEND”, the current GPS coordinate along with the “reverse location lookup” command is forwarded to the server. The server uses the coordinate as the center of a circle and looks for location codes within a certain radius, as discussed above. If no location code is found within the preset radius, the area of inclusion is increased till at least one candidate is found. When candidates which are within the radius are found they are forwarded to the cell phone. As seen in FIG. 35b, the cell phone may then display the candidates. The user scrolls through the potential addresses and chooses one. If the street address is a multi-unit structure, the location code that the server returns originally may belong to the whole structure. To get the location code for a particular unit, the user may then be prompted to press the option key “S1” or select the “EDIT” function from a list of options, as illustrated by FIG. 35c. The cell phone display may then allow the user to input the unit number as illustrated by FIG. 35d. Upon pressing “OK,” the location code for the selected multi-unit structure as well as the unit number may be forwarded to the server. The server may then returns the exact address including the suite number plus its location code to the user or the location code that includes the suite number as part of the location code. This information may be displayed by the cell phone as illustrated in FIG. 35e.

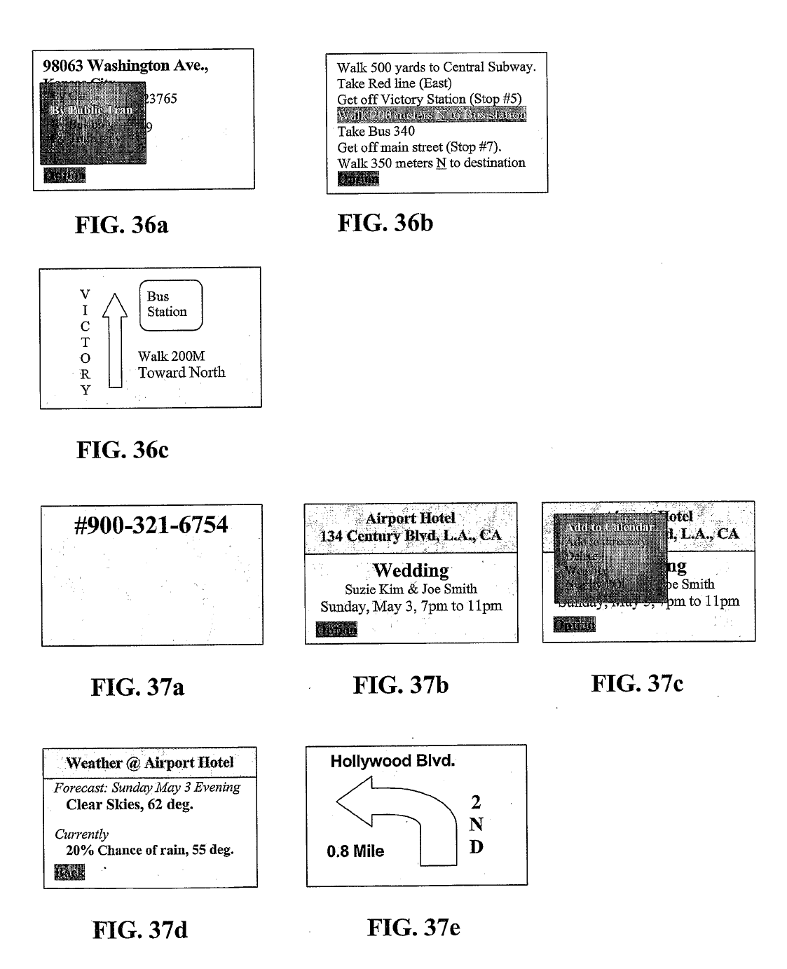

FIGS. 36a-36c illustrate an example of one implementation of the calculation of routing information for off-road travel or travel using alternative transportation. Navigation using alternative transportations is becoming popular and may be particular useful in cities with public transportation system. In this regard, a navigation system, such as a systems used in connection with cell phones, may provide the user with the option to have the navigation system provide routing information via public transportation, for example. FIG. 36 illustrates one example of a navigation screen that may allow the user to select a different means for calculating routing information. If an alternative means, such as public transportation is selected, the system may then provide the user with detailed routing information using the chosen means of transportation. As illustrated in FIG. 36a, the system may provide the user with an option to select routing information using public transportation in general or may provide the user with the option of selecting a particular type of public transportation system, such as train or bus. Although not shown the user may be given option for any other alternative mode of transportation including travel by air, on water, under the water, by ferry etc.

If public transportation is chosen, as illustrated by FIG. 36a, the system may then calculated the routing information using the selected means of transportation and provide those routing directions to the user as illustrated in FIG. 36b. FIG. 36b illustrates an example of detailed routing instructions that may be provided to the user based upon the selected means of transportation.

As illustrated in FIG. 36b, the user may then be provided with the option of selecting to receive more detailed instructions regarding a particular displayed routing direction. For example, more detailed instruction may be obtained by pressing, for example, “Walk 200 meter to the Victory Bus Station” as shown in FIG. 36b. FIG. 36c illustrates an example of a screen that may be displayed to provide the user with more detailed instruction regarding a particular displayed direction in a given set of routing instructions. The instructions shown in FIG. 36c may also be shown automatically when the user exits a particular transportation terminal or a particular means of transportation, such as when the user exits a subway termination and the GPS signal becomes available again. Such a system may also provide verbal routing instructions to the user, which may be helpful when the user is inside a subway where satellite or GPS is not available. In this regard, other types of locator devices such as short range RF or IR can be used to provide routing information to the user. For example, a user may be provided with instructions on how to get from the entrance to the right train platform. This may be useful for tourists and foreigners who are not familiar with the transportation system or can not read the signs because the signs are written in a language foreign to the user. Using short range RF, IR or other methods for finding the current position, the user may be provided with necessary information to be guided to the correct train in a particular station.

FIGS. 37a-37e illustrate one example of one implementation of a location code that is associated with a specific event. FIG. 37a illustrates a screen display from the entry of a location code associated with an event in, for a example, a cell phone navigation system. When the “SEND” or “ENTER” button is pressed, the location code may then be forwarded to the server.

FIG. 37b illustrates one example of particulars of an event associated with the entered location code. As illustrated in FIG. 37b, the address of the associated event as well as the associated metadata is returned by the server and displayed by the navigation system. Here, this is identified as an event with a specific date, start time and end time which are all identified.

FIG. 37c illustrates one example of options that a navigation system may provide to a user for processing of the associated event data. As illustrated in FIG. 37c, if the “OPTION” key is pressed, the system may give the user options of adding this event to their calendar, adding the location code and the name associated with the location code to the directory or delete the event data. If the option of “Add to Calendar” is chosen, this event may be added to the user's calendar marking May 3^{rd} between 7 pm to 11 pm and a scheduled event on the user's calendar. A client/server relationship can be created to notify and change the event in the calendar if it is changed. For example, if the wedding starting time changes to 7:30, everybody that has chosen the option to input to their calendar may be notified of the change and their calendar may be manually or automatically updated. In this example, the location code is associated with a hotel, which may also have a primary location code and a series of additional location codes for different events. Further, event attributes such as date, time and location may be used to processes the metadata. For example, if “Weather” option is chosen, a weather database can be accessed and the conditions for the event date “May 3^{rd}”, the event time “Evening” at the event place “Airport Hotel” as well as the current conditions at the event place may be retrieved and displayed. FIG. 37d illustrates one example of the acquisition of weather data related to event data associated with a location code. This illustrates how event date and event time may be used in processing the data. Further, although not shown, in this example if the “Nearby POI” is selected, the user may be presented with point of interests near the Airport Hotel.

FIG. 37e illustrates one example of routing information generated from a location code associated with an event. As illustrated by FIG. 37e, if the “SEND” button is pressed again or if the hotel destination is selected, the cell phone may display a map, giving turn-by-turn instructions and/or provide verbal routing instructions to the user.

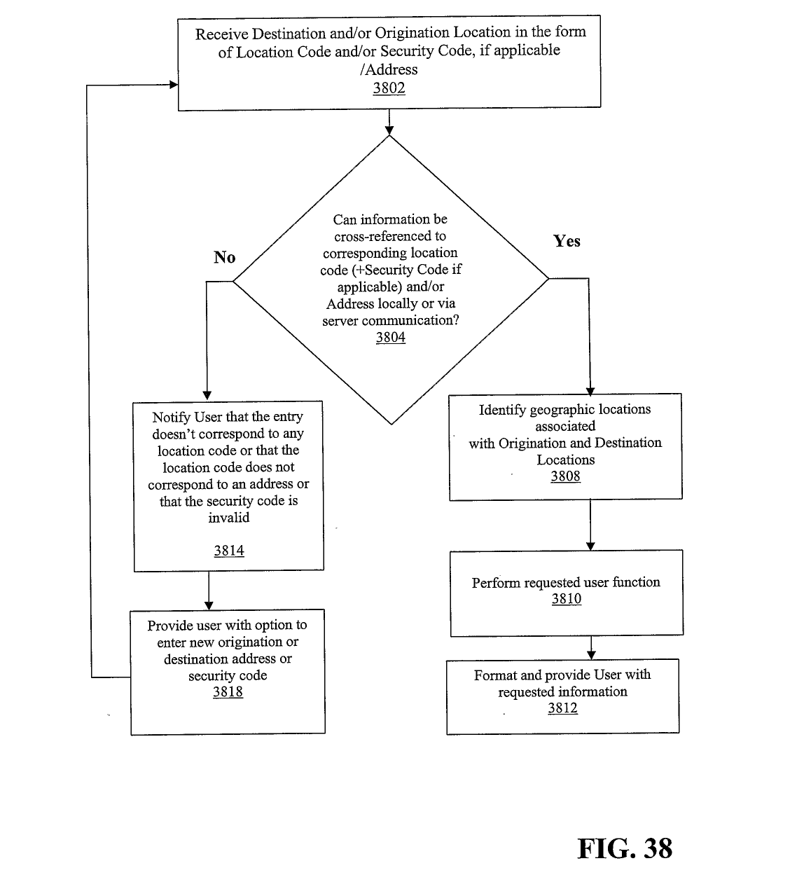

FIG. 38 illustrates a flow diagram of one example implementation that illustrates a navigation system process when a location code is entered that does not match any known geographic identifier, when an address is entered for which no location code corresponds or when a security code is invalid. As seen in FIG. 38, the system receives a destination and/or origination location in the form of location code or address 3802 and optionally, a security code, if required. The system then checks to see if the information received can be cross-referenced to corresponding location code and/or address locally or via server communication (if available) 3804 and if the security code will allow the access to the information, if required, if the date associated with the location code is available.

If the information can be cross-referenced to a corresponding location code, address or other geographic identifier, as applicable, then the system may identify geographic locations associated with origination and/or destination locations 3808 and perform the requested user function 3810. Once the requested function is performed, the system can format the output information and provide the user with requested information 3812.

If the information cannot be cross-referenced to a corresponding location code, address or other geographic identifier, as applicable, or if the system finds the security to be invalid to access the desire information then the system may notify the user that the entry doesn't correspond to any location code, that the entered address does not have any corresponding location code or that the security code is invalid, as applicable 3814. The system may then provide the user with the option to enter a new origination and/or destination location 3818, a new security code or may allow the user to end the request.

The above described function of notifying the user if the system cannot find information that corresponds to the entered information regarding destination and/or origination information or verify the security code may be employed in any navigation system capable of performing any of the functions set forth above or any other common functions performed by a navigation system.

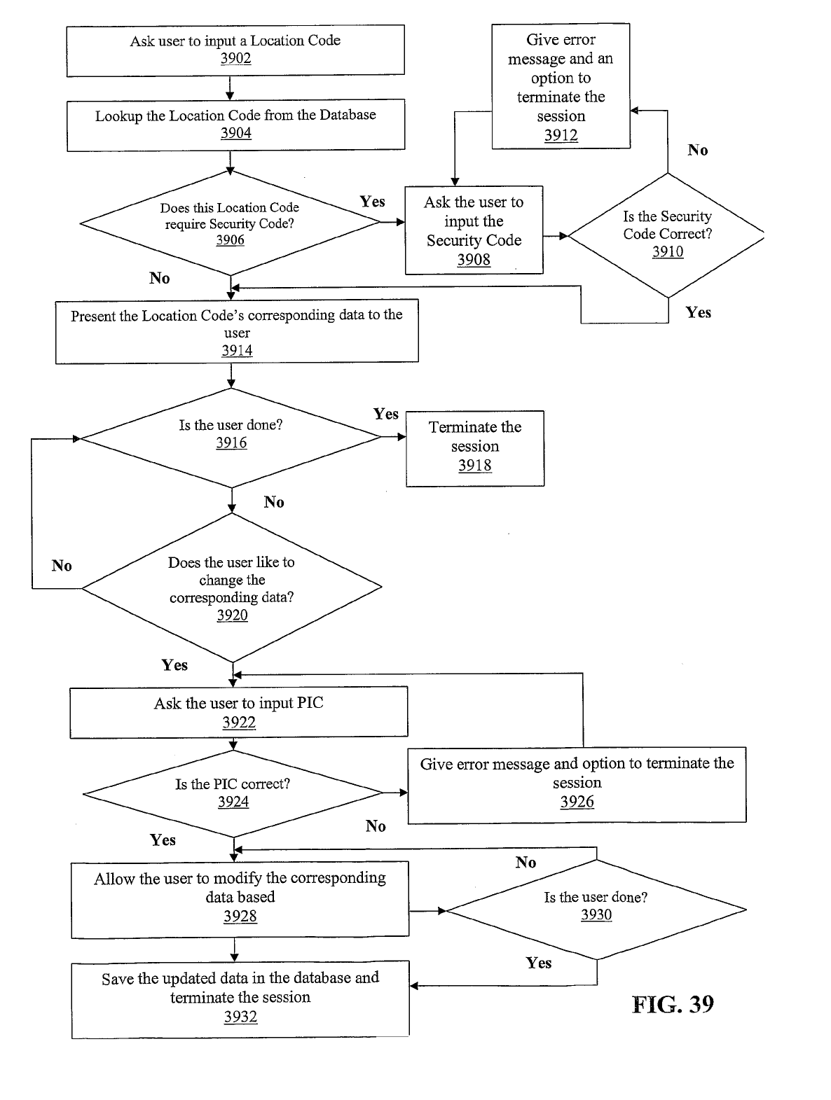

FIG. 39 is a flow diagram that illustrates one example of an implementation of how group location codes may be created using security codes and private identification codes. In this example, the user is first asked to enter a location code 3902. The system then locates the data associated with the location code 3904 and determines whether a security code is required to access all or part of the associated data 3906. If a security code is required, the system asks the user to input a security code 3908. The system then verifies the security code 3910. If the security code is incorrect, the system sends and error message to the user 3912 and either terminates the program or allows the user to enter another security code. If the security code is correct, the data associated with the location code and security code is presented to the user 3914. Alternatively, if the security code is incorrect but publicly available data is associated with the location code, the system can proceed with presenting the public information to the user while at the same time indicating that no data associated with the security code will be provided since the security code entered was invalid.

If the user only desired to view the associated data, the session may be terminated by the user 3918 if the user indicates that he/she has received the desired information or requires no further action 3916. If however, the user desires to edit the displayed information 3920, the user will be asked to input a personal identification code (“PIC”) 3922. The system then verifies the PIC 3924 and sends the user and error message if the PIC is invalid 3926. If the PIC is valid, the system may then allow the data associated with the location code to be modified by the user 3928. Once the user is done 3830, the system will save the data 3932.

Optionally, although not shown, when the associated data is display to the user, the user may request another function to be performed with the displayed information. For example, the user may be given a list of locations associated with the location code, in which case the user can select a location form the list and request routing information. Similarly, if only location is displayed, the user can similarly request routing information to that location.

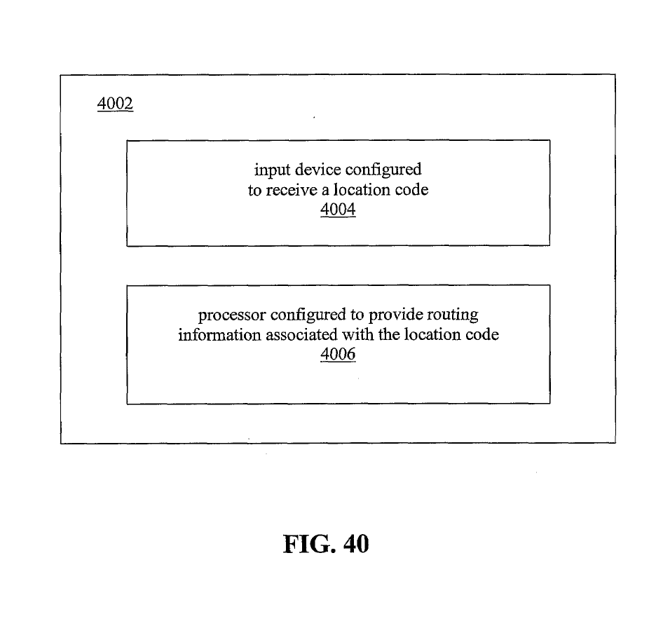

FIG. 40 is a block diagram of one example of an implementation of the navigation system capable of receiving a location code and providing routing information using the location code. As illustrated, the navigation system 4002 may include an input device configured to receive a location code 4004. The input device may be a keyboard, keypad, touch screen, voice activated device or other means for providing information to a navigation system. The navigation system 4002 also includes a processor configured to provide routing information associated with the location code 4006. The processor may be a microprocessor, general purpose processor, combination of processors, DSP, and/or ASIC etc.

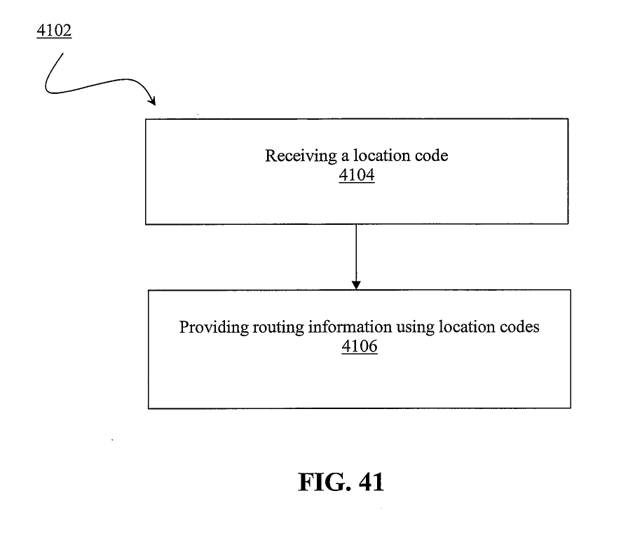

FIG. 41 is a flow diagram of one example of one implementation of a method for generating routing information based upon the receipt of a location code 4102. As illustrated, the method 4102 includes the steps of receiving the location code 4104 and providing routing information using the location code 4106.

Persons skilled in the art will understand and appreciate, that one or more processes, sub-processes, or process steps described in connection with FIGS. 2 through 41 may be performed by hardware and/or software. Additionally, the navigation system may be implemented completely in software that would be executed within a processor or plurality of processor in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal.

In addition to using location codes in navigation systems, location codes may be also be implemented as an address replacement for any application that requires the use or entry of an address. For example, the location code could be used by carriers, such as the postal service or other delivery or transportation service provides in place of the sender or receiver's street address. Location codes may be provided on business cards, provided in look-up databases and used and disseminated in a manner similar to the dissemination of addresses and telephone numbers. Further, the overall functionality of the above described methods and systems may be performed through the use of more than one system or software program capable of interfacing with one another. Each of these various systems or software programs may be considered a separate component or module of a larger system. For example, one component may provide for the receipt of the location code and may process the location code or associate the location code with data requested by or required by another component of the system. For example, one component may receive the location code, associate it with geographic location information and send the associated information to another component in the system in a format recognizable by the receiving component. In this manner, an existing navigation system that is not capable of either receiving or processing location codes may be used in conjunction with a separate system or program that is capable of receiving location code information and associating the information with or translating the information into data recognizable by the existing navigation system. Thus, the scope of this invention is not limited to modifying existing navigation systems to accept and process location codes. Rather, a navigation system as described in this application also includes the use of a know navigation system capable of interfacing with another system or software application that can provide the existing system with the information necessary to generate routing information based upon the receipt of a location code. Thus, as described herein, a navigation system may include a known navigation system used in conjunction with another system or application that allows for the combination of the two systems, components or modules.

It will be apparent to those of ordinary skill in the art that many more implementations are possible within the scope of this invention than those set forth above. Accordingly, the invention is not to be restricted by the described implementations but is intended to encompass any method of deriving alternative geographic identifiers that make it easier for a user to enter into an input device than it is to enter a street address into the device. This can be accomplished in a number of ways that will be evident by those skilled in the art in light of the various implementations offered above. Further, the invention is not to be restricted to the described implementations and uses of a location code capable navigation system, whether implemented in hardware, software or any combination thereof, but is intended to encompass any navigation system or the use thereof that is capable of receiving, recognizing, handling, or processing a location code or having any other location code capability, whether implemented in hardware, software or a combination thereof.

1-56. (canceled)

57. A method for identifying at least a majority of geographic locations having street address assignments within a predetermined geographic zone, the method comprising
methodologically assigning a series of characters having a defined format to each of the at least a majority of street addresses within the predetermined geographic zone for use by a user for entry into a navigation system to obtain routing information,
where at least a portion of the series of characters assigned to each of the at least a majority of street addresses is independent solely of the geographic location of the street address within the geographic zone, and
where each series of characters is constructed of characters that preclude the series of characters from exactly matching any telephone number associated with the street address to which the series of characters is assigned.

58. The method of claim 57 where at least a portion of the characters in the series are geographic identifiers and where the geographic identifiers include at least part of the street address to which the series of characters is assigned.

59. The method of claim 57 where at least a portion of the characters in the series are geographic identifiers and where the geographic identifiers include at least part of the nineteen digit zip code associated with the street address to which series of characters is assigned.

60. The method of claim 57 where at least a portion of the characters in the series are geographic identifiers and where the geographic identifiers include at least part of a property identification number associated with the geographic location to which the series of characters is assigned.

61. The method of claim 57 where at least a portion of the characters in the series are randomly assigned.

62. The method of claim 57 where at least a portion of the characters in the series are geographic identifiers.

63. The method of claim 57 where at least a portion of the characters are correlated identifiers.

64. The method of claim 57 where a majority of all of the series of characters within the predetermined geographic zone have the same number of characters.

65. The method of claim 57 where the majority of the series of characters assigned to one or more geographic locations sharing a predefined common characteristic have the same number of characters.

66. The method of claim 57 where at least one of the characters in the series of characters signifies an attribute associated with the geographic location to which the series of characters is assigned.

67. The method of claim 57 where the number of characters in the series of characters is equivalent to the number of characters in a telephone number.

68. The method of claim 57 where the number of characters in the series of characters is equivalent to the number of characters in a telephone number plus at least one additional character.

69. The method of claim 57 where the series of characters includes a telephone number associated with the geographic location to which the series is assigned and additional characters.

70. A method for identifying a geographic location within a predetermined geographic zone that does not have a street address assignment, the method comprising methodologically assigning a series of characters having a defined format to the geographic location for use by a user for entry into a navigation system to obtain routing information,
where at least a portion of the series of characters assigned is independent solely of the geographic location within the geographic zone, and
where the series of characters is constructed of characters that preclude the series from being representative exclusively of the name of the geographic location or the name of a class in which the geographic location belongs.

71. The method of claim 70 where at least a portion of the characters in the series are randomly assigned.

72. The method of claim 70 where at least a portion of the characters in the series are geographic identifiers.

73. The method of claim 70 where at least a portion of the characters are correlated identifiers.

74. The method of claim 70 where a majority of all of the series of characters within the predetermined geographic zone have the same number of characters.

75. The method of claim 70 where the majority of the series of characters assigned to one or more geographic locations sharing a predefined common characteristic have the same number of characters.

76. The method of claim 70 where at least one of the characters in the series of characters signifies an attribute associated with the geographic location to which the series of characters is assigned.

77. The method of claim 70 where the number of characters in the series of characters is equivalent to the number of characters in a telephone number.

78. The method of claim 70 where the number of characters in the series of characters is equivalent to the number of characters in a telephone number plus at least one additional character.

79. The method of claim 70 where the series of characters includes a telephone number associated with the geographic location to which the series is assigned and additional characters.

80. A method for identifying at least two geographic locations within a predetermined geographic zone, the method comprising methodologically assigning a series of characters having a defined format to represent the at least two geographic locations for use by a user for entry into a navigation system to obtain routing information,
where each series of characters is constructed of characters that preclude the series from being representative exclusively of the name of the geographic location or the name of a class in which the geographic location belongs.

81. The method of claim 80 where at least a portion of the characters in the series are randomly assigned.

82. The method of claim 80 where at least a portion of the characters in the series are geographic identifiers.

83. The method of claim 80 where at least a portion of the characters are correlated identifiers.

84. The method of claim 80 where a majority of all of the series of characters within the predetermined geographic zone have the same number of characters.

85. The method of claim 80 where the majority of the series of characters assigned to one or more geographic locations sharing a predefined common characteristic have the same number of characters.

86. The method of claim 80 where at least one of the characters in the series of characters signifies an attribute associated with the geographic location to which the series of characters is assigned.

87. The method of claim 80 where the number of characters in the series of characters is equivalent to the number of characters in a telephone number.

88. The method of claim 80 where the number of characters in the series of characters is equivalent to the number of characters in a telephone number plus at least one additional character.

89. The method of claim 80 where the series of characters includes a telephone number associated with the geographic location to which the series is assigned and additional characters.

90. The method of claim 80 where the at least two geographic locations share at least one common characteristic.

91. The method of claim 80 where the at least one common characteristic is an association with an entity that can be characterized as belonging to a particular class.

92. A navigation system for generating routing information, the navigation system comprising:
an input device configured to receive a location code generated in accordance with the method of claim 1; and
a processor configured to provide routing information associated with the location code.

93. The navigation system of claim 92 further including a GPS accessible by the system.

94. The navigation system of claim 93 where the UPS provides the system with data necessary to calculate the geographic location of the system.

95. The navigation system of claim 94 where the processor is further configured to provide routing information between the geographic location of the system and a geographic location associated with the location code.

96. The navigation system of claim 92 where the input device is configured to receive more than one location code and the processor is further configured to provide routing information between more than one location codes.

97. The navigation system of claim 92 where the processor is further configured to identify a geographic identifier associated with the location code.

98. The navigation system of claim 97 where the geographic identifier is identified using a database.

99. The navigation system of claim 97 where the geographic identifier is identified using an algorithm.

100. The navigation system of claim 92 where the input device is further configured to receive a street address and where the processor is further configured to use an algorithm to identify a location code associated with the street address.

101. The navigation system of claim 92 where the processor is further configured to provide routing information between the geographic location of the system and a geographic location associated with the location code.

102. The navigation system of claim 92 where the input device is configured to receive a security code associated with the location code and the processor is further configured to provide routing information associated with the location code only after authentication of the associated security code.
